(19) United States
(12) Patent Application Publication
(10) Pub. No.: US 2022/0207598 A1
(43) Pub. Date: Jun. 30, 2022

(54) INFORMATION PROCESSING APPARATUS, METHOD OF INFORMATION PROCESSING, AND INFORMATION PROCESSING SYSTEM

(71) Applicant: Panasonic Intellectual Property Management Co., Ltd., Osaka (JP)

(72) Inventors: Takayasu BABA, TOKYO TO (JP); Takenori MATSUMOTO, TOKYO TO (JP); Kazuhiko YAMAUCHI, OSAKA FU (JP); Tatsuyuki NEGISHI, TOKYO TO (JP); Masashi FUMOTO, KANAGAWA KEN (JP); Chinatsu YONEYAMA, KANAGAWA KEN (JP); Sadako YAMAGATA, KANAGAWA KEN (JP)

(73) Assignee: Panasonic Intellectual Property Management Co., Ltd., Osaka (JP)

(21) Appl. No.: 17/698,497

(22) Filed: Mar. 18, 2022

Related U.S. Application Data
(63) Continuation of application No. PCT/JP2020/032478, filed on Aug. 27, 2020.

(30) Foreign Application Priority Data
Sep. 20, 2019 (JP) 2019-172257
Sep. 20, 2019 (JP) 2019-172263
Sep. 27, 2019 (JP) 2019-176469
Sep. 27, 2019 (JP) 2019-176580

(51) Int. Cl. G06Q 30/06; G06Q 50/30; G06Q 10/02

(52) U.S. Cl. CPC G06Q 30/0645; G06Q 10/02; G06Q 50/30

(57) ABSTRACT

The information processing apparatus is an information processing apparatus in a system lending out vehicle cabins of mobile objects. The information processing apparatus includes a hardware processor functioning as a first output controller, a reception unit, and a second output controller. The first output controller serves to output first information indicating information on the vehicle cabins of the mobile objects in which at least a partial period of a standing period of the mobile objects is capable of being set as a lending period. The reception unit serves to receive an instruction by a user. The second output controller serves to output, on the basis of the instruction by the user, second information indicating that the vehicle cabin to be lent out to the user out of the vehicle cabins included in the first information is lendable.

### CROSS-REFERENCE TO RELATED APPLICATIONS

This application is national stage application of International Application No. PCT/JP2020/032478, filed Aug. 27, 2020, which designates the United States, incorporated herein by reference, and which claims the benefit of priority from Japanese Patent Applications No. 2019-172257, filed Sep. 20, 2019, No. 2019-172263, filed Sep. 20, 2019, No. 2019-176469, filed Sep. 27, 2019, and No. 2019-176580, filed Sep. 27, 2019, the entire contents of which are incorporated herein by reference.

### FIELD

The present disclosure relates to an information processing apparatus, a method of information processing, and an information processing system.

### BACKGROUND

Car-sharing systems in which a plurality of users shares one or more vehicles have been known. Users of a car-sharing system can use vehicles owned by others, such as business entities, by performing the use registration in advance without owning the vehicles by themselves (for example, Japanese Patent Application Laid-open No. 2015-210642 A).

### SUMMARY

An information processing apparatus according to the present disclosure is an information processing apparatus in a system lending out vehicle cabins of mobile objects. The information processing apparatus includes connected to a memory and configured to function as a first output controller, a reception unit, and a second output controller. The first output controller serves to output first information indicating information on the vehicle cabins of the mobile objects in which at least a partial period of a standing period of the mobile objects is capable of being set as a lending period. The reception unit serves to receive an instruction by a user. The second output controller serves to output, on the basis of the instruction by the user, second information indicating that the vehicle cabin to be lent out to the user out of the vehicle cabins included in the first information is lendable.

### BRIEF DESCRIPTION OF THE DRAWINGS

FIG. 1A is a schematic diagram of an information processing system according to a first embodiment;

FIG. 1B is an illustrative diagram of a vehicle cabin according to the first embodiment;

FIG. 2 is a hardware configuration diagram according to the first embodiment;

FIG. 3 is a block diagram of a functional configuration of a lender terminal and a user terminal according to the first embodiment;

FIG. 4 is a block diagram of a functional configuration of an information processing apparatus according to the first embodiment;

FIG. 5A is a diagram of a data structure of vehicle cabin management information according to the first embodiment;

FIG. 5B is a diagram of a data structure of lending management information according to the first embodiment;

FIG. 6 is a schematic diagram of list information according to the first embodiment;

FIG. 7A is a schematic diagram of a screen of lendable information according to the first embodiment;

FIG. 7B is a schematic diagram of the screen of the lendable information according to the first embodiment;

FIG. 8 is a schematic diagram of an input screen for receiving input of a parking lot according to the first embodiment;

FIG. 9 is a sequence diagram of a procedure of registration processing according to the first embodiment;

FIG. 10 is a sequence diagram of a procedure of use starting processing according to the first embodiment;

FIG. 11 is a sequence diagram of a procedure of update processing for use history information and lending ending processing according to the first embodiment;

FIG. 12 is a flowchart of a procedure of the use starting processing according to the first embodiment;

FIG. 13 is a block diagram of a functional configuration of an information processing apparatus according to a second embodiment:

FIG. 14A is a diagram of a data structure of vehicle cabin management information according to the second embodiment;

FIG. 14B is a diagram of a data structure of use condition/equipment correspondence information according to the second embodiment;

FIG. 14C is a diagram of a data structure of equipment/key correspondence information according to the second embodiment;

FIG. 14D is a diagram of a data structure of permission level/key correspondence information according to the second embodiment;

FIG. 15 is a sequence diagram of a procedure of registration processing for vehicle cabin lending information according to the second embodiment;

FIG. 16A is a schematic diagram of a display screen displayed on the lender terminal according to the second embodiment;

FIG. 16B is a schematic diagram of the display screen displayed on the lender terminal according to the second embodiment;

FIG. 16C is a schematic diagram of the display screen displayed on the lender terminal according to the second embodiment;

FIG. 16D is a schematic diagram of the display screen displayed on the lender terminal for the second embodiment;

FIG. 17 is a sequence diagram of a procedure of the use starting processing according to the second embodiment;

FIG. 18A is a schematic diagram of a display screen displayed on the user terminal according to the second embodiment;

FIG. 18B is a schematic diagram of the display screen displayed on the user terminal according to the second embodiment;

FIG. 18C is a schematic diagram of the display screen displayed on the user terminal according to the second embodiment;

FIG. 18D is a schematic diagram of the display screen displayed on the user terminal according to the second embodiment;

FIG. 19 is a sequence diagram of a procedure of use starting processing according to the second embodiment;

FIG. 20 is a sequence diagram of a procedure of update processing for use history information according to the second embodiment;

FIG. 21 is a flowchart of a procedure of the use starting processing according to the second embodiment;

FIG. 22 is a flowchart of a procedure of the use starting processing according to the second embodiment;

FIG. 23 is a block diagram of a functional configuration of an information processing apparatus according to a third embodiment;

FIG. 24A is a diagram of a data structure of vehicle cabin management information according to the third embodiment;

FIG. 24B is a diagram of a data structure of lending request management information according to the third embodiment;

FIG. 25 is a sequence diagram of a procedure of registration processing for vehicle cabin lending information according to the third embodiment;

FIG. 26A is a schematic diagram of an input screen for a scheduled standing ending time according to the third embodiment;

FIG. 26B is a schematic diagram of the input screen for the scheduled standing ending time according to the third embodiment;

FIG. 27 is a sequence diagram of a procedure of use starting processing according to the third embodiment;

FIG. 28A is a schematic diagram of a display screen according to the third embodiment;

FIG. 28B is a schematic diagram of the display screen according to the third embodiment;

FIG. 28C is a schematic diagram of the display screen according to the third embodiment;

FIG. 29A is a schematic diagram of the display screen according to the third embodiment;

FIG. 29B is a schematic diagram of the display screen according to the third embodiment;

FIG. 29C is a schematic diagram of the display screen according to the third embodiment;

FIG. 30 is a flowchart of a procedure of registration processing for the vehicle cabin management information according to the third embodiment;

FIG. 31 is a flowchart of a procedure of the use starting processing according to the third embodiment;

FIG. 32 is a block diagram of a functional configuration of an information processing apparatus according to a fourth embodiment;

FIG. 33A is a diagram of a data structure of vehicle cabin management information according to the fourth embodiment;

FIG. 33B is a diagram of a data structure of lending management information according to the fourth embodiment;

FIG. 34A is a schematic diagram of a display screen according to the fourth embodiment;

FIG. 34B is a schematic diagram of the display screen according to the fourth embodiment;

FIG. 34C is a schematic diagram of the display screen according to the fourth embodiment;

FIG. 35 is a sequence diagram of a procedure of registration processing for lending energy amount information according to the fourth embodiment;

FIG. 36 is a sequence diagram of a procedure of use starting processing according to the fourth embodiment;

FIG. 37 is a sequence diagram of a procedure of processing at the time of the use of a vehicle cabin by a user according to the fourth embodiment;

FIG. 38 is a flowchart of a procedure of the registration processing for the first energy amount information according to the fourth embodiment; and

FIG. 39 is a flowchart of a procedure of information processing according to the fourth embodiment.

### DETAILED DESCRIPTION

The following describes embodiments of the present disclosure in detail based on the accompanying drawings. In each of the following embodiments, the same parts are given the same symbols, and a duplicate description is omitted.

### First Embodiment

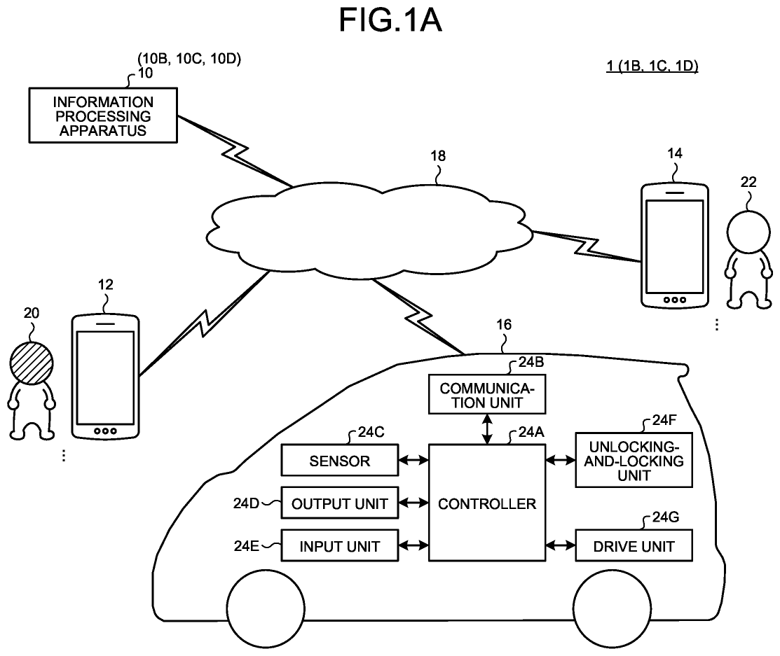

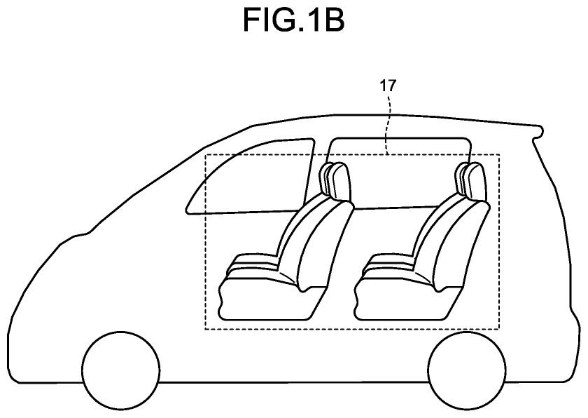

FIG. 1A is a schematic diagram of an example of an information processing system 1 of the present embodiment. The information processing system 1 is a sharing system in which a vehicle cabin of a mobile object is an object to be lent out.

The information processing system 1 includes an information processing apparatus 10, a lender terminal 12, a user terminal 14, and a vehicle 16. The information processing system 1, the lender terminal 12, the user terminal 14, and the vehicle 16 are communicably connected to each other in a wireless or wired manner via a network 18.

FIG. 1A illustrates a configuration in which the information processing system 1 includes one each of the information processing apparatus 10, the lender terminal 12, the user terminal 14, and the vehicle 16 as an example. However, the information processing system 1 may include one or more lender terminals 12, one or more user terminals 14, or one or more vehicles 16.

The information processing apparatus 10 is an apparatus managing the information processing system 1. Examples of the information processing system 1 include, but are not limited to, server apparatuses and apparatuses implemented in a cloud system. In the present embodiment, the information processing apparatus 10 manages the vehicle cabin of the vehicle 16 as the object to be lent out.

The lender terminal 12 is a terminal apparatus operated by a lender 20. The lender 20 is a user lending out the vehicle 16 or desiring to lend out the vehicle 16. The lender terminal 12 is a computer operated by the lender 20. Examples of the lender terminal 12 include, but are not limited to, tablet terminals and smartphones.

The user terminal 14 is a terminal apparatus operated by a user 22. The user 22 is a user using the information processing system 1 and a user borrowing or desiring to borrow the vehicle cabin of the vehicle 16. The user terminal 14 is a computer operated by the user 22. Examples of the user terminal 14 include, but are not limited to, tablet terminals and smartphones.

The vehicle 16 is an example of a mobile object. The mobile object is anything that can move. The present embodiment describes a case in which the mobile object is a passenger car as an example. The passenger car is the vehicle 16 in which the user can ride. Examples of the passenger car include normal passenger cars, large-sized passenger cars, and small-sized passenger cars. The power source of the passenger car is not limited. The passenger car may be any of a gasoline car, an electric car, a fuel cell car, and the like, for example. The vehicle 16 may be any of a mobile object moving via a human driving operation and a mobile object that can automatically move or autonomously move without any human driving operation. The mobile object may be a mobile object for movement on the water such as a ship as well as the passenger car, for example. The mobile object may be owned by an individual or be owned by a corporation.

The vehicle cabin is a space within the mobile object. Specifically, the vehicle cabin is a space in which the user can be present in the mobile object. The vehicle cabin may be either a closed space that can be closed from the outside world with a member such as a window or an open space at least part of which is continuous with the outside world without interruption. FIG. 1B illustrates an example of a vehicle cabin 17 when the mobile object is the vehicle 16. The vehicle cabin 17 is a space inside the vehicle 16 and is a space in which the user can be present, for example.

Referring back to FIG. 1A, the description is continued. The vehicle 16 includes a controller 24A, a communication unit 24B, a sensor 24C, an output unit 24D, an input unit 24E, an unlocking-and-locking unit 24F, and a drive unit 24G. The communication unit 24B, the sensor 24C, the output unit 24D, the input unit 24E, the unlocking-and-locking unit 24F, and the drive unit 24G and the controller 24A are connected to each other in such a manner that data or signals can be exchanged.

The controller 24A is a dedicated or general-purpose computer and controls the vehicle 16. The communication unit 24B is a communication interface (I/F) for communicating with other apparatuses via the network 18.

The sensor 24C is a sensor detecting the position, the driven state, and the like of the vehicle 16. The sensor 24C is an inertial measurement unit (IMU), a speed sensor, or the global positioning system (GPS), for example.

The output unit 24D outputs various kinds of information. The output unit 24D is a speaker outputting voices, a display displaying images, or the like. The display is an organic electro luminescence (OLED) display, a liquid crystal display (LCD), or a projector, which are known, for example.

The input unit 24E receives instructions or information input from the user. The input unit 24E is at least either an instruction input device receiving input through user operation input or a microphone receiving voice input, for example. The instruction input device is a button, a pointing device such as a mouse or a trackball, or a keyboard, for example. The instruction input device may be an input function in a touch panel provided integrally with the output unit 24D, which is a display.

The unlocking-and-locking unit 24F is a mechanism for unlocking or locking each of one or more pieces of equipment provided in the vehicle 16. When receiving key information, the unlocking-and-locking unit 24F makes equipment corresponding to the key information an unlocked state, which is unlocked, or a locked state, which is locked. The unlocked state means a state in which the equipment is available to the user or a state in which the equipment can be driven. The locked state means a state in which the equipment is unavailable to the user or a state in which the equipment cannot be driven.

The equipment is a mechanism installed in the vehicle 16. Examples of the equipment include, but are not limited to, a front window_driver's seat, a front window_passenger's seat, rear windows, an air conditioner, a front door_driver's seat, a front door_passenger's seat, audio, lights, an engine, and unlockable-and-lockable boxes.

The drive unit 24G is a drive device installed in the vehicle 16. The drive unit 24G is an engine, a motor, or wheels, for example.

The present embodiment describes a case in which the lender 20 is the owner of the vehicle 16 as an example. That is to say, the present embodiment describes a case as an example in which the information processing apparatus 10 manages the lending and borrowing of the vehicle cabin 17 between the lender 20, who is the owner of the vehicle 16, and the user 22 of the vehicle cabin 17 of the vehicle 16. Sharing between the owner of the vehicle 16 and the user 22 may be referred to as a person-to-person transaction or consumer-to-consumer (C2C) sharing. The information processing system 1 is not limited to C2C sharing and may also be a system in which a non-individual such as an operating organization owns the vehicle 16, which is used by the user 22, who is a member.

The following describes a hardware configuration of the information processing apparatus 10, the lender terminal 12, the user terminal 14, and the controller 24A of the vehicle 16.

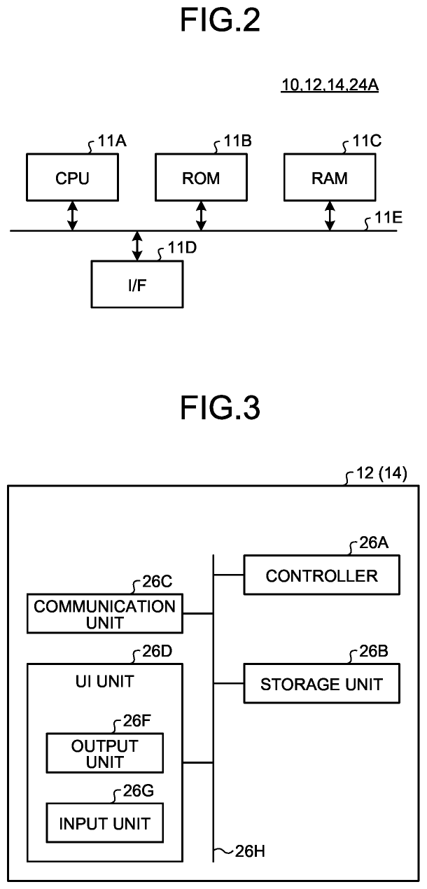

FIG. 2 is an example of a hardware configuration diagram of the information processing apparatus 10, the lender terminal 12, the user terminal 14, and the controller 24A of the vehicle 16.

The information processing apparatus 10, the lender terminal 12, the user terminal 14, and the controller 24A, in which a central processing unit (CPU) 11A, a read only memory (ROM) 11B, a random access memory (RAM) 11C, an interface (VF) 11D, and the like are connected to each other with a bus 11E, have a hardware configuration using a normal computer.

The CPU 11A is a processor (an example of the hardware processor). The ROM 11B stores therein a computer program implementing processing by the CPU 11A and the like. The RAM 11C stores therein data necessary for the processing by the CPU 11A. The IN 11D is an interface for transmitting and receiving data.

A computer program for executing information processing to be executed by the information processing apparatus 10, the lender terminal 12, the user terminal 14, and the controller 24A of the present embodiment is embedded in the ROM 11B or the like in advance to be provided. The computer program to be executed by the information processing apparatus 10, the lender terminal 12, the user terminal 14, and the controller 24A of the present embodiment may be recorded and provided in a computer-readable recording medium such as a compact disc read only memory (CD-ROM), a flexible disk (FD), a compact disc recordable (CD-R), or a digital versatile disc (DVD) as an installable or executable file.

The following describes a functional configuration of the lender terminal 12 and the user terminal 14.

FIG. 3 is a block diagram of an example of the functional configuration of the lender terminal 12 and user terminal 14.

The lender terminal 12 and user terminal 14 include a controller 26A, a storage unit 26B, a communication unit 26C, and a user interface (UI) unit 26D. The controller 26A, the storage unit 26B, the communication unit 26C, and the UI unit 26D are connected to each other in such a manner that data or signals can be exchanged via a bus 26H.

The controller 26A controls the lender terminal 12 or the user terminal 14. The storage unit 26B stores therein data. The storage unit 26B is a semiconductor memory element such as a random access memory (RAM) or a flash memory, a hard disk, or an optical disc, for example. The storage unit 26B may be a storage apparatus provided outside the lender terminal 12 or the user terminal 14. The storage unit 26B may be a storage medium. Specifically, the storage medium may download a computer program or information via a local area network (LAN), the Internet, or the like and store or temporarily store it therein. The storage unit 26B may include a plurality of storage media.

The communication unit 26C is a communication IN for communicating with other apparatuses via the network 18. The UI unit 26D includes an input function for receiving operation instructions from the user and a display function displaying images. In the present embodiment, the UI unit 26D includes an output unit 26F and an input unit 26G. The output unit 26F is an example of the display function. The output unit 26F is a liquid crystal display or an organic EL display, for example. The input unit 26G is an example of the input function. The input unit 26G is a keyboard or a mouse, for example. The UI unit 26 may be a touch panel integrally including the input function and the display function.

The following describes a functional configuration of the information processing apparatus 10.

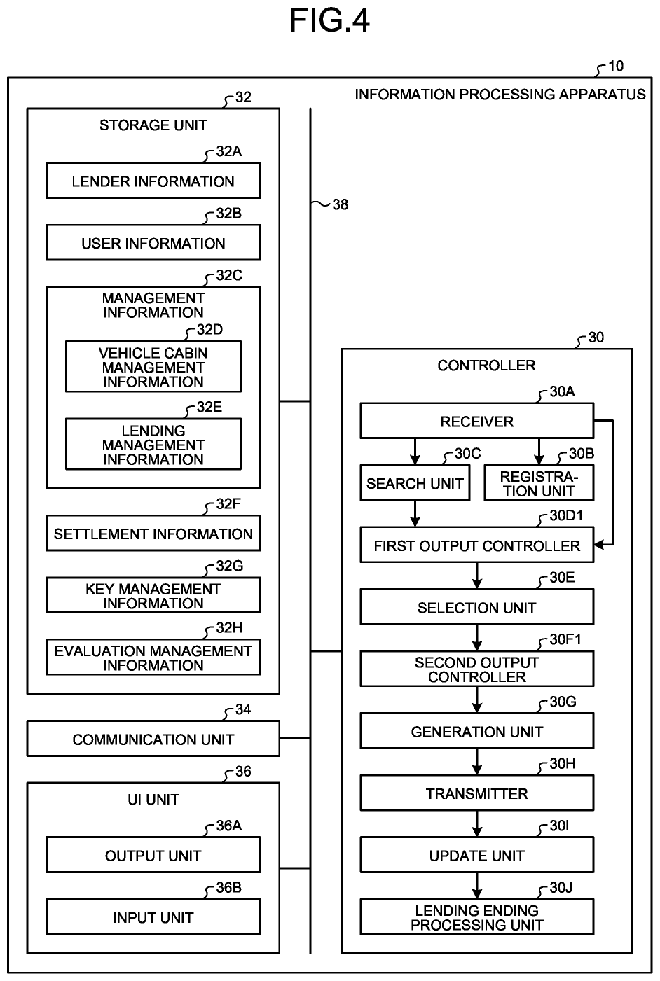

FIG. 4 is a block diagram of an example of the functional configuration of the information processing apparatus 10.

The information processing apparatus 10 includes a controller 30, a storage unit 32, a communication unit 34, and a UI unit 36. The controller 30, the storage unit 32, the communication unit 34, and the UI unit 36 are connected to each other in such a manner that data or signals to be exchanged via a bus 38.

At least either the storage unit 32 or the UI unit 36 may be connected to the controller 30 in a wired or wireless manner. At least either the storage unit 32 or the UI unit 36 and the controller 30 may be connected to each other via the network 18.

The communication unit 34 is a communication IN for communicating with other apparatuses via the network 18. The UI unit 36 includes an input function receiving operation instructions from the user and a display function displaying images. In the present embodiment, the UI unit 36 includes an output unit 36A and an input unit 36B. The output unit 36A is an example of the display function. The output unit 36A is a liquid crystal display or an organic EL display, for example. The input unit 36B is an example of the input function. The input unit 36B is a keyboard or a mouse, for example. The UI unit 36 may be a touch panel integrally including the input function and the display function.

The storage unit 32 stores therein data. The storage unit 32 is a semiconductor memory element such as a RAM or a flash memory, a hard disk, or an optical disc, for example. The storage unit 32 may be a storage apparatus provided outside the information processing apparatus 10. The storage unit 32 may be a storage medium. Specifically, the storage medium may download a computer program or information via a local area network (LAN), the Internet, or the like and store or temporarily store it therein. The storage unit 32 may include a plurality of storage media.

In the present embodiment, the storage unit 32 stores therein lender information 32A, user information 32B, management information 32C, settlement information 32F, key management information 32G, and evaluation management information 32H.

The lender information 32A is a database for managing information on the lender 20. The lender information 32A is information that can identify the lender 20.

The lender information 32A is information associating the identification information of the lender 20, the name of the lender 20, the contact address of the lender 20, and the identification information of the lender terminal 12 operated by the lender 20 with each other, for example. Hereinafter, the identification information of the lender 20 will be described referred to as a lender ID. Hereinafter, the identification information of the lender terminal 12 may be described referred to as a lender terminal ID. The lender information 32A may be information further including other information on the lender 20.

The contact address of the lender 20 is an address, an e-mail address, or a telephone number, for example. In the present embodiment, the contact address of the lender 20 is assumed to include a contact address that can be checked by the lender 20 on the lender terminal 12. Specifically, the contact address of the lender 20 is assumed to include information such as an e-mail address that can be received by the lender terminal 12.

The user information 32B is a database for managing information on the user 22. The user information 32B is information that can identify the user 22.

The user information 32B stores therein the identification information of the user 22, the name of the user 22, the contact address of the user 22, the characteristic information of the user 22, the identification information of the user terminal 14 operated by the user 22, and the like in association with each other, for example. Hereinafter, the identification information of the user 22 will be described referred to as a user ID. Hereinafter, the identification information of the user terminal 14 may be described referred to as a user terminal ID. The contact address of the user 22 is an address, an e-mail address, or a telephone number, for example. In the present embodiment, the contact address of the user 22 is assumed to include a contact address that can be checked by the user 22 on the user terminal 14. Specifically, the contact address of the user 22 is assumed to include information such as an e-mail address that can be received by the user terminal 14. The characteristic information of the user 22 is the internal characteristics or the external characteristics such as interests, ideas, personality, age, and body shape of the user 22. The user information 32B may be information further including other information on the user 22.

The management information 32C is a database for managing the vehicle cabin 17 of the vehicle 16 as the object to be lent out. The information processing apparatus 10 manages the management information 32C to manage the vehicle cabin 17 as the object to be lent out.

In the present embodiment, the management information 32C includes vehicle cabin management information 32D and lending management information 32E. The vehicle cabin management information 32D is a database for managing the vehicle cabin 17. The lending management information 32E is a database for managing the lending status of the vehicle cabin 17. The vehicle cabin management information 32D and the lending management information 32E may be configured in a single database.

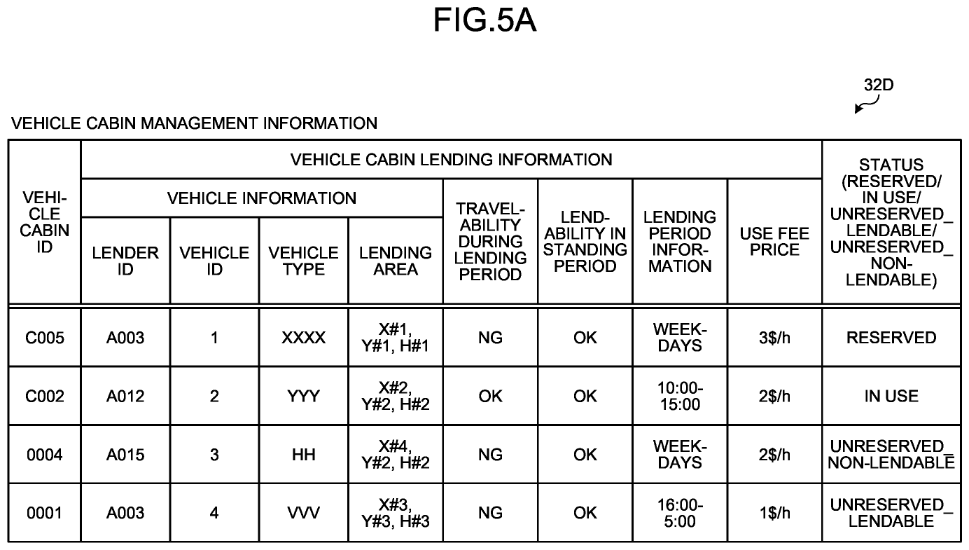

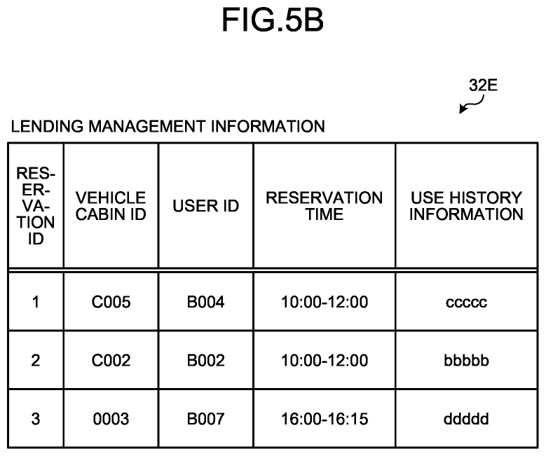

FIG. 5A is a diagram of an example of a data structure of the vehicle cabin management information 32D.

The vehicle cabin management information 32D is a database associating vehicle cabin lending information and a status with each other for each vehicle cabin 17. Specifically, the vehicle cabin management information 32D is a database associating a vehicle cabin ID, the vehicle cabin lending information, and the status with each other.

The vehicle cabin ID is the identification information of the vehicle cabin 17.

The vehicle cabin lending information is information on the lending out of the vehicle cabin 17 and is information registered through an instruction by the lender 20. The vehicle cabin lending information includes information on each of vehicle information, travelability during a lending period, lendability in a standing period, a lending period, and a use fee. The vehicle cabin lending information may be information further including other information related to the lending out of the vehicle cabin 17.

The vehicle information is information on the vehicle 16. The vehicle information includes the lender ID, a vehicle ID, a vehicle type, and a lending area, for example. The lender ID is the identification information of the lender 20. The lender ID is the identification information of the lender 20, who is the owner of the vehicle 16. The vehicle ID is the identification information of the vehicle 16. The vehicle type is information indicating the vehicle type of the vehicle 16. The lending area is an area in which the vehicle 16 including the vehicle cabin 17 is scheduled to be positioned when the vehicle cabin 17 is lent out. The vehicle information may be information further including other information on the vehicle 16.

The travelability during the lending period is information indicating whether the traveling of the vehicle 16 in the lending period is permitted. The travelability during the lending period is represented by “OK” indicating permission to travel given or “NG” indicating permission to travel not given, for example.

The lendability in the standing period is information indicating whether the lending out of the vehicle cabin 17 of the vehicle 16 to the user 22 in the standing period of the vehicle 16 is permitted.

Permitting the lending out of the vehicle cabin 17 of the vehicle 16 to the user 22 in the standing period means that at least a partial period of the standing period can be set as the lending period. Not permitting the lending out of the vehicle cabin 17 of the vehicle 16 to the user 22 in the standing period means that the entire period of the standing period cannot be set as the lending period.

The standing period is a period during which the mobile object stops moving. The standing period is specifically a parking period or a stopping period. The parking period is a stop for a preset amount of time or longer or a stop in a state in which a driver is away from the vehicle 16 and cannot immediately drive it. The stopping period is a stop for less than the preset amount of time. When the mobile object is a self-driving vehicle, the standing period includes a period during which the mobile object goes around a certain area.

The lendability in the standing period is represented by “OK” indicating being lendable or “NG” indicating being non-lendable, for example.

When “the lendability in the standing period” is “OK,” the vehicle cabin 17 identified by the corresponding vehicle cabin ID is the vehicle cabin 17 for which at least a partial period of the standing period of the vehicle 16 can be set as the lending period. In other words, when the lendability in the standing period is “OK,” information indicating that the vehicle cabin 17 identified by the corresponding vehicle cabin ID is lent out with the vehicle 16 standing is set in the vehicle cabin management information 32D.

When “the lendability in the standing period” is “NG,” the vehicle cabin 17 identified by the corresponding vehicle cabin ID is the vehicle cabin 17 prohibited from being lent out in the standing period of the vehicle 16.

The lending period is information indicating a period during which the vehicle cabin 17 can be lent out. The lending period is represented by a lending starting time and a lending ending time, the day of a week, a date, and a time slot when one day is divided into a plurality of time slots, for example. The time slot is the morning or the afternoon, for example.

“The lendability in the standing period” being “OK” indicating being lendable indicates that “the lending period” corresponding to “the lendability in the standing period” may be a period overlapping the at least a partial period of the standing period of the vehicle 16. “The lendability in the standing period” being “NG” indicating being not lendable indicates that “the lending period” corresponding to “the lendability in the standing period” must not be a period overlapping the at least a partial period of the standing period of the vehicle 16.

Thus, the controller 30 described below manages the vehicle cabin 17 as the object to be lent out based on the vehicle cabin management information 32D, whereby for the vehicle cabin 17 of the vehicle 16 used in the information processing system 1, the at least a partial period of the standing period thereof can be set as the lending period.

It is assumed that “the lendability in the standing period” is “OK” indicating being lendable and “the travelability during the lending period” is “OK” indicating permission to travel. This case indicates that “the lending period” corresponding to these may be a period overlapping the at least a partial period of the standing period of the vehicle 16 and that the vehicle 16 may be caused to travel in “the lending period.”

Thus, the controller 30 described below manages the vehicle cabin 17 as the object to be lent out based on the vehicle cabin management information 32D, whereby for the vehicle 16 used in the information processing system 1, the at least a partial period of the standing period thereof can be set as the lending period, and the traveling thereof during the lending period can be set to be permissible.

The use fee is information indicating a use fee per unit time during lending out or a use fee being a fixed amount for a certain period. The use fee is not limited to the currency unit used in each country and may be electronic money such as virtual currency or points. The use fee registered in the vehicle cabin management information 32D is a use fee in a state indicated by the vehicle information, the travelability during the lending period, the lendability in the standing period, and lending period information, which correspond thereto.

The status is information indicating the reservation state of the vehicle cabin 17 identified by the corresponding vehicle cabin ID. The status is information indicating reserved, in use, unreserved_lendable, and unreserved_non-lendable, for example. Reserved is information indicating that the vehicle cabin 17 identified by the corresponding vehicle cabin ID has been reserved by the user 22. In use is information indicating that the vehicle cabin 17 identified by the corresponding vehicle cabin ID is in use by the user 22. Unreserved_lendable is information indicating that the vehicle cabin 17 identified by the corresponding vehicle cabin ID has not been reserved by the user 22 and is in a lendable state. Unreserved_non-lendable is information indicating that the vehicle cabin 17 identified by the corresponding vehicle cabin ID has not been reserved by the user 22 and is in a non-lendable state. The status is updated by the control of the controller 30 described below.

The following describes a data structure of the lending management information 32E.

FIG. 5B is a diagram of an example of the data structure of the lending management information 32E.

The lending management information 32E is a database for managing the use state of the vehicle cabin 17. The lending management information 32E is a database associating a reservation ID, the vehicle cabin ID, the user ID, a reservation time, and use history information with each other, for example.

The reservation ID is the identification information of a lending reservation. The user ID is the identification information of the user 22. The reservation time is information indicating a reservation time for the vehicle cabin 17. The use history information is information indicating the history of the actual use state of the vehicle cabin 17. The lending management information 32E is updated by the control of the controller 30 described below.

Referring back to FIG. 4, the description is continued. The settlement information 32F is a database in which information to be used at the time of settlement is registered. The settlement information 32F is a database associating the lender ID of the lender 20 and information for use in the settlement of the lender 20 with each other and also associating the user ID of the user 22 and information for use in the settlement of the user 22 with each other, for example. The information for use in the settlement of the lender 20 is information to be used at the time of fee transfer or fee payment and is the bank account information, the credit card information, or the like of the lender 20, for example. The information for use in the settlement of the user 22 is information to be used at the time of fee transfer or payment and is the bank account information, the credit card information, or the like of the user 22, for example.

The key management information 32G is a database for managing key information for the user to unlock or lock the equipment of the vehicle cabin 17. The key information for unlocking each of the equipment is registered in the key management information 32G for each of the equipment of the vehicle cabin 17 such as a door and an engine, for example.

The evaluation management information 32H is a database for registering evaluation information, which is an evaluation result of at least one of the vehicle 16, the vehicle cabin 17, the lender 20, and the user 22. Examples of the evaluation information include, but are not limited to, information in which the lender 20 evaluates the user 22 and information in which the user 22 evaluates at least one of the vehicle 16, the vehicle cabin 17, and the lender 20. In the present embodiment, the evaluation management information 32H is information associating the user information of the user 22 having used the vehicle cabin 17, the lender information of the lender 20 having lent out the vehicle cabin 17, lending environment information, and the evaluation result of at least one of the lender 20, the user 22, the vehicle 16, and the vehicle cabin 17 with each other. The lending environment information is information indicating a lending environment and includes information such as a lending date and time and a lending location.

The above information stored in the storage unit 32 is registered and updated as appropriate by the processing described below by the controller 30. The details of these pieces of processing will be described below.

The data format of each of the above information stored in the storage unit 32 is not limited to the database. The data format may be a table format, for example.

The following describes the controller 30. The controller 30 includes a receiver 30A, a registration unit 30B, a search unit 30C, a first output controller 30D1, a selection unit 30E, a second output controller 30F1, a generation unit 30G, a transmitter 30H, an update unit 30I, and a lending ending processing unit 30J.

The receiver 30A, the registration unit 30B, the search unit 30C, the first output controller 30D1, the selection unit 30E, the second output controller 30F1, the generation unit 30G, the transmitter 30H, the update unit 30I, and the lending ending processing unit 30J are implemented by one or more processors, for example. Each of the above units may be implemented by causing a processor such as a CPU to execute a computer program, that is, software, for example. Each of the above units may be implemented by a processor such as a dedicated integrated circuit (IC), that is, hardware. Each of the above units may be implemented using software and hardware in combination. When the processors are used, each of the processors may implement one of the units or implement two or more of the units.

The processor reads a computer program stored in the storage unit 32 and executes it to implement the units. In place of storing the computer program in the storage unit 32, the computer program may directly be incorporated into the circuitry of the processor. In this case, the processor reads the computer program incorporated into the circuitry and executes it to implement the units.

The receiver 30A receives various kinds of information from at least one of the lender terminal 12, the user terminal 14, and vehicle 16 via the communication unit 34 and the network 18.

Specifically, the receiver 30A receives the lender information, the vehicle cabin lending information, the evaluation information, and the like from the lender terminal 12. The receiver 30A receives the user information, the use reservation information, the use request, the evaluation information, and the like from the user terminal 14.

The use reservation information is information to be input by the user 22 making a use reservation of the vehicle cabin 17. In other words, the use reservation information is search conditions for the vehicle cabin 17 desired to be used by the user 22 and is information including one or more search words. The use reservation information includes at least one search word of a date, a use starting time, a use time, and a use location on which the vehicle cabin 17 is scheduled to be used, for example. The use reservation information may be information further including other search words. The use reservation information may be information further including search words such as the vehicle type of the vehicle 16, the characteristic information of the lender 20 owing the vehicle 16, and the evaluation information of the vehicle 16, the vehicle cabin 17, or the lender 20, for example.

The use request is information to be input by the user 22 making a use reservation of the vehicle cabin 17. The use request is information including the vehicle cabin lending information of the vehicle cabin 17 desired to be used by the user 22 among one or more pieces of vehicle cabin lending information matching at least one of the search conditions indicated in the use reservation information and a request signal requesting the use of the vehicle cabin 17.

The registration unit 30B executes registration processing such as registration of the lender information in the lender information 32A, registration of the user information in the user information 32B, and registration of the vehicle cabin lending information in the vehicle cabin management information 32D.

Upon reception of the lender information from the lender terminal 12, the registration unit 30B registers the lender information in the lender information 32A. Upon reception of the user information from the user terminal 14, the registration unit 30B registers the user information in the user information 32B. Upon reception of the vehicle cabin lending information from the lender terminal 12, the registration unit 30B registers the vehicle cabin lending information in the vehicle cabin management information 32D.

The search unit 30C searches the vehicle cabin management information 32D for the vehicle cabin lending information satisfying the use reservation information received from the user terminal 14. The search unit 30C searches the vehicle cabin management information 32D for the vehicle cabin lending information matching or similar to the search word(s) included in the use reservation information received by the receiver 30A.

Assumed is a case in which the use reservation information received by the receiver 30A includes the use starting time and the use time on which the vehicle cabin 17 is scheduled to be used, for example. In this case, the search unit 30C searches the vehicle cabin management information 32D for the vehicle cabin lending information including the lending period at least part of which overlaps with the period from the use starting time to a lapse of the use time. The description continues assuming a case in which the search unit 30C has searched for a plurality of pieces of vehicle cabin lending information, that is, the vehicle cabin lending information corresponding to each of a plurality of vehicle cabin IDs from the vehicle cabin management information 32D.

The first output controller 30D1 outputs list information to the output unit 26F of the user terminal 14.

The list information is information on the vehicle cabin 17 of the vehicle 16 in which at least a partial period of the standing period of the vehicle 16 can be set as the lending period. Specifically, the list information is information indicating a list of the vehicle cabin lending information of the vehicle cabin 17 of the vehicle 16 searched for by the search unit 30C. The list information may include the vehicle cabin lending information of one or more vehicle cabins 17.

As described above, the vehicle 16 of the information processing system 1 is the vehicle 16 at least the partial period of the standing period of which can be set as the lending period. The vehicle 16 is the vehicle 16 at least the partial period of the standing period of which can be set as the lending period and the traveling of which during the lending period can be set to be permissible.

Thus, the first output controller 30D1 outputs the list information to output the list information, which is the list of the vehicle cabin lending information of the vehicle cabin 17 of the vehicle 16 at least the partial period of the standing period of which can be set as the lending period, to the output unit 26F of the user terminal 14. The first output controller 30D1 also outputs the list information of the vehicle cabin 17 of the vehicle 16 at least the partial period of the standing period of which can be set as the lending period, the vehicle cabin 17 of the vehicle 16 the traveling of which during the lending period being capable of being set to be permissible, to the output unit 26F of the user terminal 14.

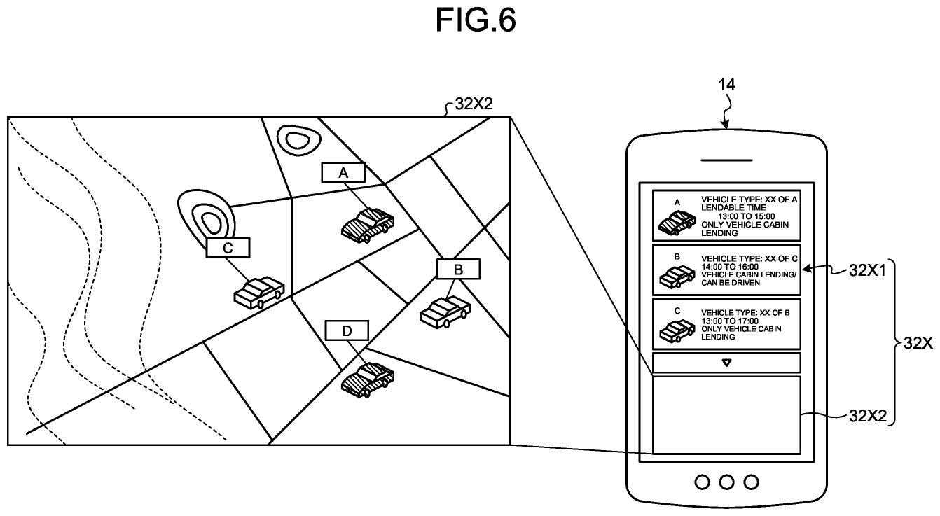

FIG. 6 is a schematic diagram of an example of list information 32X. The list information 32X includes one or more pieces of vehicle cabin lending information searched for by the search unit 30C. The list information 32X includes text information 32X1, which is the vehicle cabin lending information, and an image 32X2, which is the vehicle cabin lending information, for example. The image 32X2 is an image in which, at a position corresponding to the lending area on a map image, an image indicating the corresponding vehicle cabin lending information is placed, for example. The image indicating the vehicle cabin lending information is represented by an image indicating the vehicle 16 in a schematic manner, for example.

The user 22 operates the user terminal 14 while referring to the list information 32X displayed on the user terminal 14 to select one piece of vehicle cabin lending information desired to be used. The user terminal 14 then transmits the use request including the selected vehicle cabin lending information and the request signal requesting the use of the vehicle cabin 17 to the information processing apparatus 10.

The output unit to which the first output controller 30D1 outputs the list information 32X may be any output mechanism viewable by the user 22 and is not limited to the output unit 26F provided in the user terminal 14. The first output controller 30D1 may use various kinds of displays connected to the network 18 as the output unit outputting the list information 32X, for example. Examples of the displays include, but are not limited to, bulletin boards and electronic signs. The first output controller 30D1 may use a speaker outputting voices connected to the network 18 as the output unit outputting the list information 32X.

Referring back to FIG. 4, the description is continued. The selection unit 30E selects the vehicle cabin lending information included in the use request received from the user terminal 14 as the vehicle cabin lending information of the vehicle cabin 17 to be lent out to the user 22. That is to say, the selection unit 30E selects the vehicle cabin lending information of the vehicle cabin 17 to be lent out to the user 22 among the vehicle cabin lending information of the vehicle cabin 17 included in the list information 32X based on an instruction by the user 22.

The second output controller 30F1 outputs lendable information to the output unit 26F of the user terminal 14 based on an instruction by the user received by a reception unit, which is at least either the communication unit 34 or the UI unit 36.

The lendable information is information indicating that the vehicle cabin 17 selected by the selection unit 30E is lendable. The lendable information includes at least partial information included in the vehicle cabin lending information of the vehicle cabin 17 selected by the selection unit 30E and information indicating that the vehicle cabin 17 is to be lent out, for example.

The second output controller 30F1 calculates an overlapping period between the period from the use starting time to a lapse of the use time included in the use reservation information received from the user terminal 14 and the lending period included in the lendable information as an actual reservation time. Then the second output controller 30F1 outputs the vehicle cabin lending information including the reservation time in place of the lending period to the user terminal 14 as the lendable information.

The second output controller 30F1 registers the user ID of the user 22 of the user terminal 14, which is the output destination of the lendable information, the vehicle cabin ID included in the lendable information, the calculated reservation time, and the reservation ID in the lending management information 32E in association with each other (refer to FIG. 5B).

The user terminal 14 having received the lendable information displays the lendable information on the output unit 26F of the user terminal 14. Thus, the user 22 refers to the user terminal 14 and can thus check the vehicle cabin lending information of the vehicle cabin 17 permitted to be used by the user 22.

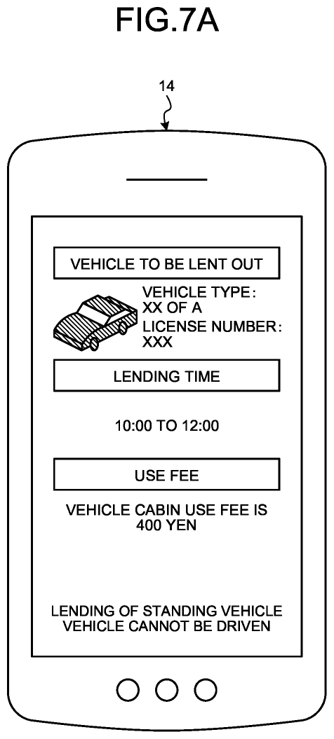

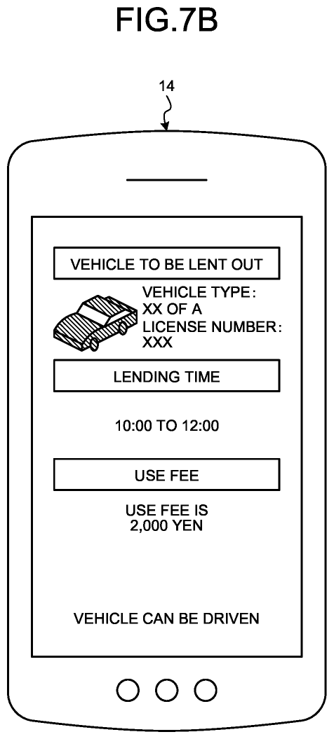

FIG. 7A and FIG. 7B are schematic diagrams of examples of a screen of the lendable information output to the output unit 26F of the user terminal 14.

It is assumed that the vehicle cabin lending information included in the lendable information includes “NG” as the information indicating the travelability during the lending period and includes “OK” as the information indicating the lendability in the standing period, for example. In this case, the lendable information illustrated in FIG. 7A is output to the output unit 26F of the user terminal 14, for example.

It is assumed that the vehicle cabin lending information included in the lendable information includes “OK” as the information indicating the travelability during the lending period and includes “OK” as the information indicating the lendability in the standing period, for example. In this case, the lendable information illustrated in FIG. 7B is output to the output unit 26F of the user terminal 14, for example.

As illustrated in FIG. 7A and FIG. 7B, the use fee can differ between lending with the vehicle 16 standing (refer to FIG. 7A) and lending with the vehicle 16 permitted to travel (refer to FIG. 7B).

Referring back to FIG. 4, the description is continued. As described above, the lending area included in the vehicle cabin lending information registered in the vehicle cabin management information 32D is the area in which, when the vehicle cabin 17 is lent out, the vehicle 16 including the vehicle cabin 17 is scheduled to be positioned. Thus, when the object to be lent out to the user 22 is selected by the selection unit 30E, the user 22 is preferably notified of information indicating the actual lending position of the vehicle 16.

Given this, the second output controller 30F1 preferably transmits selection information to the lender terminal 12 before outputting the lendable information to the output unit 26F of the user terminal 14. The selection information is information including at least an input instruction signal of parking lot information. The selection information includes the vehicle cabin lending information of the vehicle cabin 17 selected by the selection unit 30E and the input instruction signal of the parking lot information, for example.

A parking lot is an area as large as the size of one vehicle 16. The parking lot information is information indicating the parking lot in the lending area for the vehicle 16 having the vehicle cabin 17 selected by the selection unit 30E.

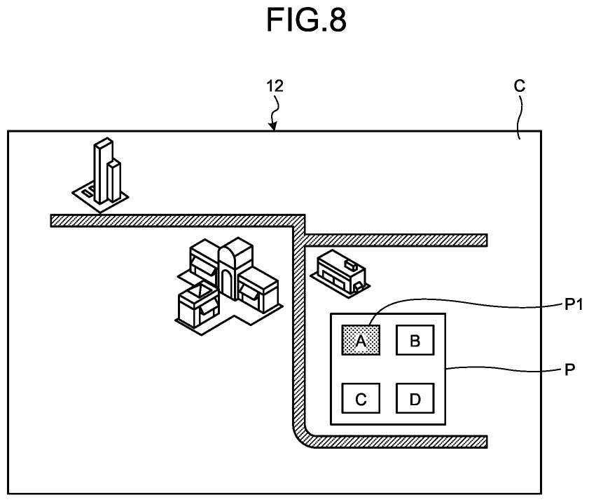

Upon reception of the selection information by the lender terminal 12, the lender 20 of the lender terminal 12 inputs the parking lot information in which the vehicle 16 owned by the lender 20 has actually been placed. In this case, the lender terminal 12 displays an input screen for receiving input of the parking lot on the lender terminal 12, for example. FIG. 8 is a schematic diagram of an example of the input screen for receiving input of the parking lot displayed on the lender terminal 12. The lender 20 instruction-inputs a parking lot P1, where the vehicle 16 has actually been parked, within a lending area P, for example. The lender terminal 12 then transmits the parking lot information of the parking lot P1 having been instruction-input to the information processing apparatus 10.

Referring back to FIG. 4, the description is continued. The second output controller 30F1 of the information processing apparatus 10 receives the parking lot information from the lender terminal 12 via the receiver 30A and the communication unit 34. Then the second output controller 30F1 may output the lendable information further including the parking lot information received from the lender terminal 12 to the user terminal 14.

The following describes the generation unit 30G. The generation unit 30G generates the key information. The generation unit 30G generates the key information to enable the vehicle cabin 17 to be used by the user 22 to be used. The transmitter 30H transmits the key information generated by the generation unit 30G to the user terminal 14, to which the generation unit 30G has output the lendable information immediately before the transmission. The user terminal 14 having received the key information stores therein the received key information.

The update unit 30I updates the lending management information 32E. The update unit 30I detects the actual use state of the vehicle cabin 17 during a use period by the user 22 and registers it in the lending management information 32E as the use history information. The actual use state of the vehicle cabin 17 includes the position information of the vehicle 16 detected by the sensor 24C of the vehicle 16 and the operating state of various kinds of electronic devices installed in the vehicle 16, for example.

The controller 24A of the vehicle 16 may analyze signals output from the sensor 24C, the input unit 24E, and the drive unit 24G by a known method to detect the use state of the vehicle cabin 17 and transmit a detection result to the information processing apparatus 10. The update unit 30I of the information processing apparatus 10 receives the detection result from the vehicle 16 via the receiver 30A and the network 18. Then the update unit 30I registers the received detection result in the lending management information 32E as the use history information.

The lending ending processing unit 30J executes lending ending processing. The lending ending processing is processing executed at the end of the use of the vehicle cabin 17 by the user 22. The lending ending processing includes ending time notification processing, key information deactivation processing, fee calculation processing, settlement processing, and evaluation processing, for example.

The lending ending processing unit 30J, as the ending time notification processing, provides notification of an ending time of the reservation time to at least either the user terminal 14 or the vehicle 16, for example. Specifically, the lending ending processing unit 30J refers to the lending management information 32E and provides notification of the ending time of the reservation time to the user terminal 14 of the user 22 identified by the user ID corresponding to the reservation time at a time a certain time before the ending time of the reservation time registered in the lending management information 32E. The lending ending processing unit 30J may provide notification of the ending time of the reservation time to the vehicle 16 of the vehicle cabin 17 identified by the vehicle cabin ID corresponding to the reservation time.

At least either the user terminal 14 or the vehicle 16 having received the ending time of the reservation time outputs information indicating the ending time. Thus, the user 22 who is using the vehicle cabin 17 of the vehicle 16 can be provided with the ending time of the reservation time.

The lending ending processing unit 30J, as the key information deactivation processing, deactivates the key information transmitted to the user terminal 14 to a state impossible to switch the equipment of the vehicle 16 to the unlocked state, for example.

The lending ending processing unit 30J, as the fee calculation processing, calculates a fee based on the time from the start of use to the end of use and the use fee registered in the vehicle cabin management information 32D, for example. Then the lending ending processing unit 30J transmits the fee information of the calculated fee to the user terminal 14 and the lender terminal 12. Then the lending ending processing unit 30J executes the settlement processing such as debiting from the bank account of the user 22 and transfer to a bank account of the lender 20 of the fee of the calculated fee information.

The lending ending processing unit 30J, as the evaluation processing, receives the evaluation information from each of the lender terminal 12 and user terminal 14 and registers it in the evaluation management information 32H, for example. In this process, the lending ending processing unit 30J registers the user information of the user 22 having used the vehicle cabin 17, the lender information of the lender 20 having lent out the vehicle cabin 17, the lending environment information, and the received evaluation information of at least one of the lender 20, the user 22, the vehicle 16, and the vehicle cabin 17 in the evaluation management information 32H in association with each other.

Thus, information on lending and borrowing between the users, or the lender 20 and the user 22, is registered in the evaluation management information 32H together with their respective pieces of evaluation information to be managed.

The following describes an example of a procedure of information processing executed by the information processing system 1.

The following first describes a procedure of registration processing by the registration unit 30B.

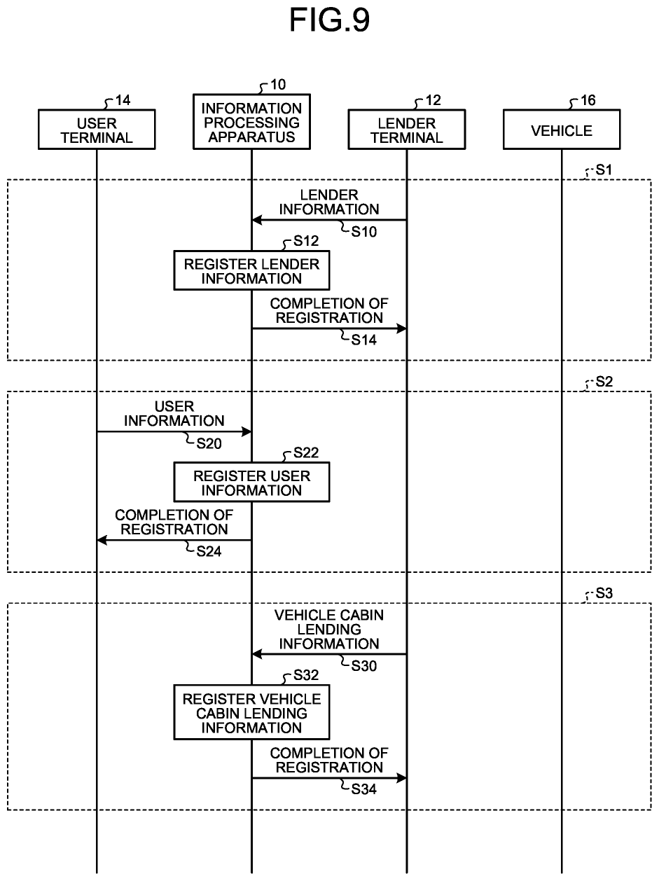

FIG. 9 is a sequence diagram of an example of the procedure of the registration processing executed by the information processing system 1.

The following first describes registration processing for the lender information (Step S1). The lender 20 operates the lender terminal 12 to input the lender information including the name of the lender 20 and the contact address of the lender 20. The lender terminal 12 transmits the input lender information to the information processing apparatus 10 via the network 18 (Step S10). The registration unit 30B of the information processing apparatus 10 registers the lender information received from the lender terminal 12 in the lender information 32A in association with the lender ID of the lender 20 (Step S12). Then the registration unit 30B of the information processing apparatus 10 transmits information indicating the completion of registration to the lender terminal 12 (Step S14).

The lender information is input by each of one or more lenders 20 by operating their respective lender terminals 12. Then each time the lender information is input to the lender terminal 12, the information processing system 1 executes the registration processing for the lender information (Step S1).

The following describes registration processing for the user information (Step S2). The user 22 operates the user terminal 14 to input the user information including the name of the user 22, the contact address of the user 22, and the characteristic information of the user 22. The user terminal 14 transmits the input user information to the information processing apparatus 10 via the network 18 (Step S20). The registration unit 30B of the information processing apparatus 10 registers the user information received from the user terminal 14 in the user information 32B in association with the user ID of the user 22 (Step S22). Then the registration unit 30B of the information processing apparatus 10 transmits information indicating the completion of registration to the user terminal 14 (Step S24).

The user information is input by each of one or more users 22 by operating their respective user terminals 14. Then each time the user information is input to the user terminal 14, the information processing system 1 executes the registration processing for the user information (Step S2).

The following describes registration processing for the vehicle cabin lending information (Step S3). The lender 20 operates the lender terminal 12 to input the vehicle cabin lending information. Specifically, the lender 20 operates the lender terminal 12 to input information on each of the vehicle information, the travelability during the lending period, the lendability in the standing period, the lending period, and the use fee. That is to say, the lender 20 can set whether the traveling of the vehicle 16 in the lending period is permitted for the vehicle cabin 17 of the vehicle 16. In addition, the lender 20 can also set whether the lending out of the vehicle cabin 17 of the vehicle 16 to the user 22 in the standing period of the vehicle 16 is permitted.

The lender terminal 12 transmits the input vehicle cabin lending information to the information processing apparatus 10 via the network 18 (Step S30). The registration unit 30B of the information processing apparatus 10 registers the vehicle cabin lending information received from the lender terminal 12 in the vehicle cabin management information 32D in association with the vehicle cabin ID of the vehicle cabin 17 (Step S32). Then the registration unit 30B of the information processing apparatus 10 transmits information indicating the completion of registration to the lender terminal 12 (Step S34).

The vehicle cabin lending information is input by each of the lender(s) 20 by operating their respective lender terminals 12. Then each time the vehicle cabin lending information is input to the lender terminal 12, the information processing system 1 executes the registration processing for the vehicle cabin lending information (Step S3).

The following describes a procedure of use starting processing from when the use reservation information is input from the user terminal 14 to when the use of the vehicle cabin 17 is started.

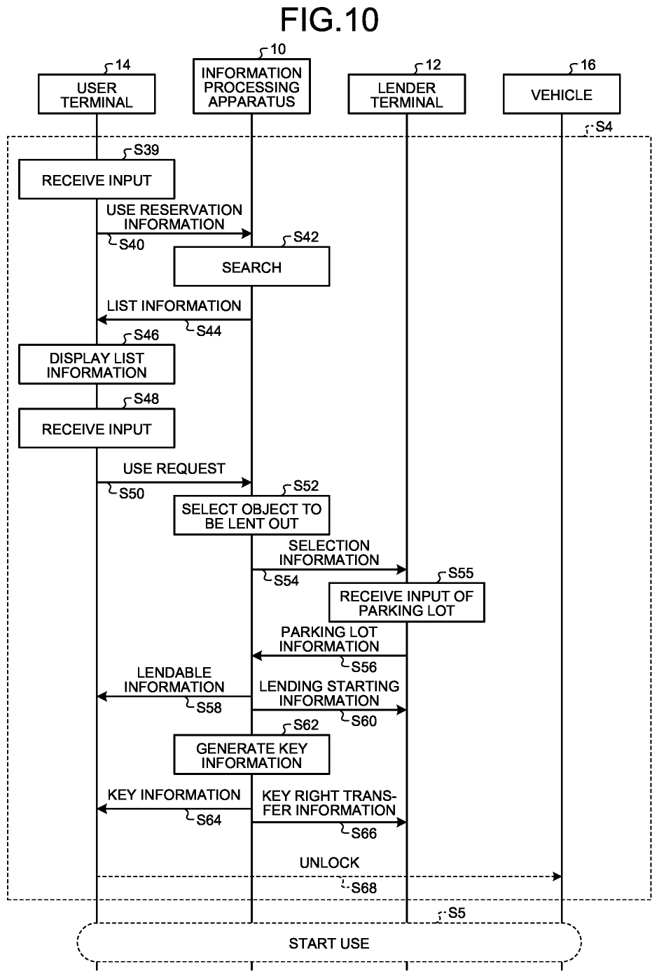

FIG. 10 is a sequence diagram of an example of the procedure of the use starting processing (Step S4) executed by the information processing system 1.

The user 22 operates the user terminal 14 to input the use reservation information, which is search conditions for the vehicle cabin 17 that the user 22 desires to use and is information including one or more search words. As described above, the search words are the use starting time, the use time, the use location, and the like on which the vehicle cabin 17 is scheduled to be used. The user terminal 14 receives input of the use reservation information by the user 22 (Step S39). The user terminal 14 transmits the received use reservation information to the information processing apparatus 10 (Step S40). The search unit 30C of the information processing apparatus 10 searches the vehicle cabin management information 32D for the vehicle cabin lending information satisfying the use reservation information received from the user terminal 14 (Step S42).

The first output controller 30D1 transmits the list information 32X, which is a list of the vehicle cabin lending information searched for by the search unit 30C, to the user terminal 14 (Step S44). The user terminal 14 outputs the list information 32X to the output unit 26F of the user terminal 14 (Step S46) (refer to FIG. 6).

The user 22 operates the user terminal 14 while referring to the list information 32X displayed on the user terminal 14 to select one piece of vehicle cabin lending information that the user 22 desires to use. The user terminal 14 receives input of the selected vehicle cabin lending information (Step S48). The user terminal 14 transmits the use request including the received vehicle cabin lending information and the request signal requesting the use of the vehicle cabin 17 to the information processing apparatus 10 (Step S50).

The selection unit 30E of the information processing apparatus 10 selects the vehicle cabin lending information included in the use request received at Step S50 as the vehicle cabin lending information of the vehicle cabin 17 to be lent out (Step S52).

The selection unit 30E of the information processing apparatus 10 transmits the selection information including the vehicle cabin lending information of the vehicle cabin 17 selected at Step S52 and the input instruction signal of the parking lot information to the lender terminal 12 of the lender 20 identified by the lender ID included in the vehicle cabin lending information (Step S54).

Upon reception of the selection information by the lender terminal 12, the lender 20 of the lender terminal 12 inputs the parking lot information in which the vehicle 16 owned by the lender 20 has actually been placed. The lender terminal 12 displays the input screen for receiving input of the parking lot on the lender terminal 12, for example (refer to FIG. 8). Upon reception of input of the parking lot (Step S55), the lender terminal 12 transmits the parking lot information of the received parking lot to the information processing apparatus 10 (Step S56).

The second output controller 30F1 of the information processing apparatus 10 transmits the lendable information including the parking lot information received at Step S56 and indicating that the vehicle cabin 17 selected by the selection unit 30E at Step S52 is lendable to the user terminal 14 (Step S58). The user terminal 14 outputs the lendable information to the output unit 26F of the user terminal 14 (refer to FIG. 7A and FIG. 7B). The second output controller 30F1 transmits lending starting information to the lender terminal 12 (Step S60).

Next, the generation unit 30G of the information processing apparatus 10 generates the key information (Step S62). Then the transmitter 30H of the information processing apparatus 10 transmits the key information generated at Step S62 to the user terminal 14, to which the lendable information has been transmitted at Step S58 (Step S64). The user terminal 14 having received the key information stores therein the received key information. The transmitter 30H of the information processing apparatus 10 transmits transfer information indicating that a key right has been transferred to the user 22 to the lender terminal 12 (Step S66).

The key information is communicated between the user terminal 14 and the vehicle 16, whereby the equipment of the vehicle cabin 17 of the vehicle 16 becomes the unlocked state (Step S68). Thus, the user 22 can use the vehicle cabin 17 identified by the lendable information received from the information processing apparatus 10 at Step S58.

The user 22 brings the user terminal 14 close to the vehicle 16 of the vehicle cabin 17 permitted to be used, whereby communication between the user terminal 14 and the vehicle 16 is executed by a known technology, and the equipment such as a door of the vehicle cabin 17 of the vehicle 16 becomes the unlocked state, for example. Thus, the user 22 becomes able to use the vehicle cabin 17 and can start the use of the vehicle cabin 17.

Specifically, the user 22 brings the user terminal 14 close to the vehicle cabin 17, whereby the key information of the user terminal 14 is transmitted to the vehicle 16 through short-range wireless communication or the like between the user terminal 14 and the vehicle 16, for example. The controller 24A of the vehicle 16 authenticates whether the received key information is legitimate key information by a known method and, if it is the legitimate key information, makes the equipment corresponding to the key information the unlocked state. The controller 24A switches the unlocking-and-locking unit 24F corresponding to a door, which is an example of the equipment corresponding to the key information, to the unlocked state, for example. With this processing, the user 22 can enter the vehicle cabin 17. Then the use starting processing (Step S4) ends. Thus, the use of the vehicle cabin 17 by the user 22 is started (Step S5).

The following describes a procedure of update processing for the use history information and the lending ending processing.

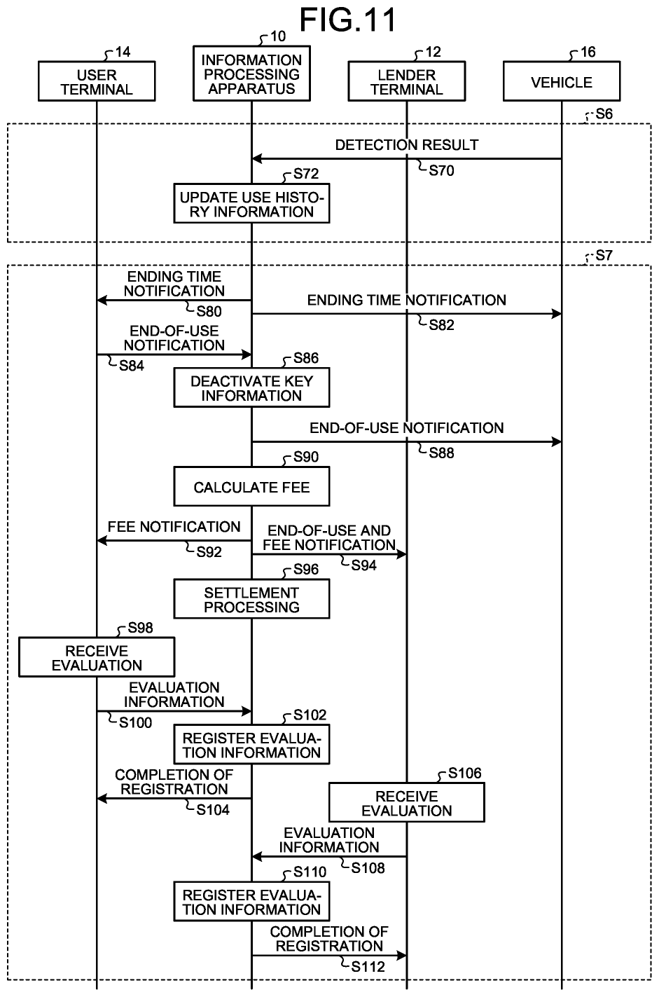

FIG. 11 is a sequence diagram of an example of a procedure of the update processing for the use history information (Step S6) and the lending ending processing (Step S7) executed by the information processing system 1.

The update processing for the use history information (Step S6) includes processing at Step S70 to Step S72.

First, when the use of the vehicle cabin 17 by the user 22 is started, the controller 24A of the vehicle 16 acquires the detection result of the use state including the position information of the vehicle 16 detected by the sensor 24C of the vehicle 16 and the operating state of each of the various kinds of electronic devices installed in the vehicle 16. The controller 24A of the vehicle 16 may acquire the detection result for each certain time or each time the situation changes. The controller 24A of the vehicle 16 then transmits the detection result of the use state of the vehicle cabin 17 to the information processing apparatus 10 (Step S70).

The update unit 30I of the information processing apparatus 10 registers the detection result received at Step S70 in the lending management information 32E as the use history information (Step S72) (refer to FIG. 5B). Each time the detection result is received from the vehicle 16, the update unit 30I may register it in the lending management information 32E as the use history information. Thus, the lending management information 32E is updated throughout the use period.

The following describes the lending ending processing (Step S7). The lending ending processing (Step S7) includes processing at Step S80 to Step S112.

The lending ending processing unit 30J of the information processing apparatus 10 provides notification of the ending time of the reservation time to the user terminal 14 and the vehicle 16 (Step S80 and Step S82).

The user terminal 14 having received the ending time of the reservation time outputs information indicating the ending time to the output unit 26F of the user terminal 14. Thus, the user 22 who is using the vehicle cabin 17 of the vehicle 16 operates the user terminal 14 to input the end of use of the vehicle cabin 17. Upon reception of the operation instruction of the end of use, the user terminal 14 transmits an end-of-use notification to the information processing apparatus 10 (Step S84).

Upon reception of the end-of-use notification, the lending ending processing unit 30J of the information processing apparatus 10 executes the key information deactivation processing, which deactivates the key information (Step S86). Then the lending ending processing unit 30J of the information processing apparatus 10 transmits an end-of-use notification of the vehicle cabin 17 to the vehicle 16 (Step S88). The controller 24A of the vehicle 16 having received the end-of-use notification controls the unlocking-and-locking unit 24F to switch the equipment of the vehicle 16 from the unlocked state to the locked state.

The lending ending processing unit 30J of the information processing apparatus 10 executes the fee calculation processing to calculate the fee based on the time from the start of use to the end of use and the use fee registered in the vehicle cabin management information 32D (Step S90). Then the lending ending processing unit 30J of the information processing apparatus 10 transmits the fee information of the calculated fee to the user terminal 14 (Step S92). The lending ending processing unit 30J of the information processing apparatus 10 transmits the fee information of the calculated fee and information indicating the end of use to the lender terminal 12 (Step S94).

Next, the lending ending processing unit 30J of the information processing apparatus 10 executes the settlement processing such as debiting from the bank account of the user 22 and transfer to the bank account of the lender 20 of the fee of the fee information calculated at Step S90 (Step S96).

The user terminal 14 having received the end-of-use notification receives operation input of the evaluation information from the user 22 (Step S98). The user 22 having used the vehicle cabin 17 operates the user terminal 14 to input the evaluation information evaluating at least one of the used vehicle 16, the vehicle cabin 17, and the lender 20, for example.

The user terminal 14 transmits the received evaluation information to the information processing apparatus 10 (Step S100). The lending ending processing unit 30J of the information processing apparatus 10 registers the evaluation information received from the user terminal 14 in the evaluation management information 32H in association with each of the vehicle ID of the corresponding vehicle 16, the vehicle cabin ID of the vehicle cabin 17, and the lender ID of the lender 20 (Step S102). Then the lending ending processing unit 30J of the information processing apparatus 10 transmits information indicating the completion of the registration of the evaluation information to the user terminal 14 (Step S104).

The lender 20 having lent out the vehicle cabin 17 operates the lender terminal 12 to input the evaluation information of the user 22 having used the vehicle cabin 17 having been lent out. The lender terminal 12 receives operation input of the evaluation information from the lender 20 (Step S106). The lender 20 having lent out the vehicle cabin 17 operates the lender terminal 12 to input the evaluation information of the user 22 having used the vehicle cabin 17 having been lent out, for example. The lender terminal 12 transmits the received evaluation information to the information processing apparatus 10 (Step S108). The lending ending processing unit 30J of the information processing apparatus 10 registers the evaluation information received from the lender terminal 12 in the evaluation management information 32H in association with the user ID of the corresponding user 22 (Step S110). Then the lending ending processing unit 30J of the information processing apparatus 10 transmits information indicating the completion of the registration of the evaluation information to the lender terminal 12 (Step S112).

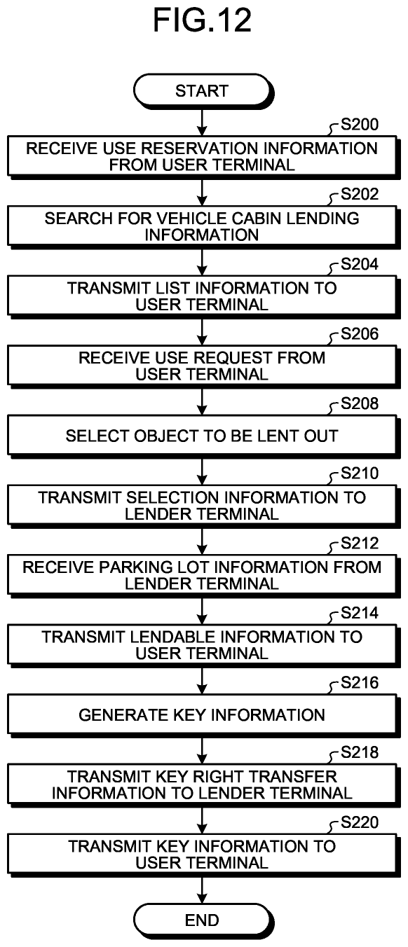

The following describes an example of a procedure of information processing executed by the information processing apparatus 10. FIG. 12 is a flowchart of an example of the procedure of the use starting processing (refer to Step S4 in FIG. 10) executed by the information processing apparatus 10.

The receiver 30A receives the use reservation information from the user terminal 14 (Step S200). The search unit 30C searches the vehicle cabin management information 32D for the vehicle cabin lending information satisfying the use reservation information received at Step S200 (Step S202).

The first output controller 30D1 transmits the list information 32X, which is the list of the vehicle cabin lending information searched for by the search unit 30C, to the user terminal 14 (Step S204).

In the search processing at Step S202, if the vehicle cabin lending information satisfying the use reservation information received at Step S200 cannot be searched for from the vehicle cabin management information 32D, the present routine may end.

Next, the receiver 30A receives the use request including the vehicle cabin lending information and the request signal requesting the use of the vehicle cabin 17 from the user terminal 14 (Step S206).

The selection unit 30E selects the vehicle cabin lending information included in the use request received at Step S206 as the vehicle cabin lending information of the vehicle cabin 17 to be lent out (Step S208).

The selection unit 30E transmits the selection information including the vehicle cabin lending information of the vehicle cabin 17 selected at Step S208 and the input instruction signal of the parking lot information to the lender terminal 12 of the lender 20 identified by the lender ID included in the vehicle cabin lending information (Step S210).

The receiver 30A receives the parking lot information from the lender terminal 12 (Step S212).

The second output controller 30F1 transmits the lendable information including the parking lot information received at Step S212 and indicating that the vehicle cabin 17 selected by the selection unit 30E at Step S208 is lendable to the user terminal 14 (Step S214).

Next, the generation unit 30G generates the key information (Step S216). Then the transmitter 30H transmits the transfer information indicating that the key right has been transferred to the user 22 to the lender terminal 12 (Step S218). The transmitter 30H also transmits the key information generated at Step S216 to the user terminal 14, to which the lendable information has been transmitted at Step S214 (Step S220). Then the present routine ends.

As described above, the information processing apparatus 10 of the present embodiment is the information processing apparatus 10 in the system lending out the vehicle cabin 17 of the vehicle 16. The information processing apparatus 10 includes the first output controller 30D1, the reception unit, and the second output controller 30F1. The first output controller 30D1 outputs the list information 32X indicating the information on the vehicle cabin 17 of the vehicle 16 in which at least the partial period of the standing period of the vehicle 16 can be set as the lending period. The reception unit is at least either the communication unit 34 or the UI unit. The reception unit receives the instruction by the user. The second output controller 30F1 outputs the lendable information indicating that the vehicle cabin 17 to be lent out to the user 22 among the vehicle cabins 17 included in the list information 32X is lendable based on the instruction by the user 22 received by the reception unit.

Thus, the information processing apparatus 10 of the present embodiment makes the vehicle cabin 17 of the vehicle 16 at least the partial period of the standing period of which can be set as the lending period the object to be lent out. Thus, the information processing apparatus 10 of the present embodiment can, for the vehicle 16 as an object not in a moving state such as during a stop or during parking, manage the vehicle cabin 17 of the vehicle 16 as the object to be lent out.

Consequently, the information processing apparatus 10 of the present embodiment can achieve effective sharing of the mobile object not in a moving state.

### Second Embodiment

The present embodiment describes a form in which the lender 20 can set the use condition of the vehicle 16 to be lent out.

In the present embodiment, the same functions and components as those of the first embodiment are given the same symbols, and a detailed description is omitted. In the sequence diagrams and the flowcharts used in the present embodiment, the same processing parts as those of the first embodiment are given the same step numbers, and a detailed description is omitted.

As illustrated in FIG. 1A, an information processing system 1B of the present embodiment is the same as the information processing system 1 of the first embodiment except that it includes an information processing apparatus 10B in place of the information processing apparatus 10 (refer to FIG. 1A). The hardware configuration of the information processing apparatus 10B is the same as that of the information processing apparatus 10 (refer to FIG. 2).

The information processing apparatus 10B manages the vehicle cabin 17 of the vehicle 16 as the object to be lent out in the same manner as the information processing apparatus 10 of the first embodiment.

The following describes a case in which the information processing apparatus 10B is C2C sharing as an example, which manages the lending and borrowing of the vehicle cabin 17 between the lender 20, who is the owner of the vehicle 16, and the user 22 of the vehicle cabin 17 of the vehicle 16 in the same manner as the information processing apparatus 10 and the information processing system 1 of the first embodiment. The information processing system 1B is not limited to C2C sharing.

The following describes a functional configuration of the information processing apparatus 10B of the present embodiment.

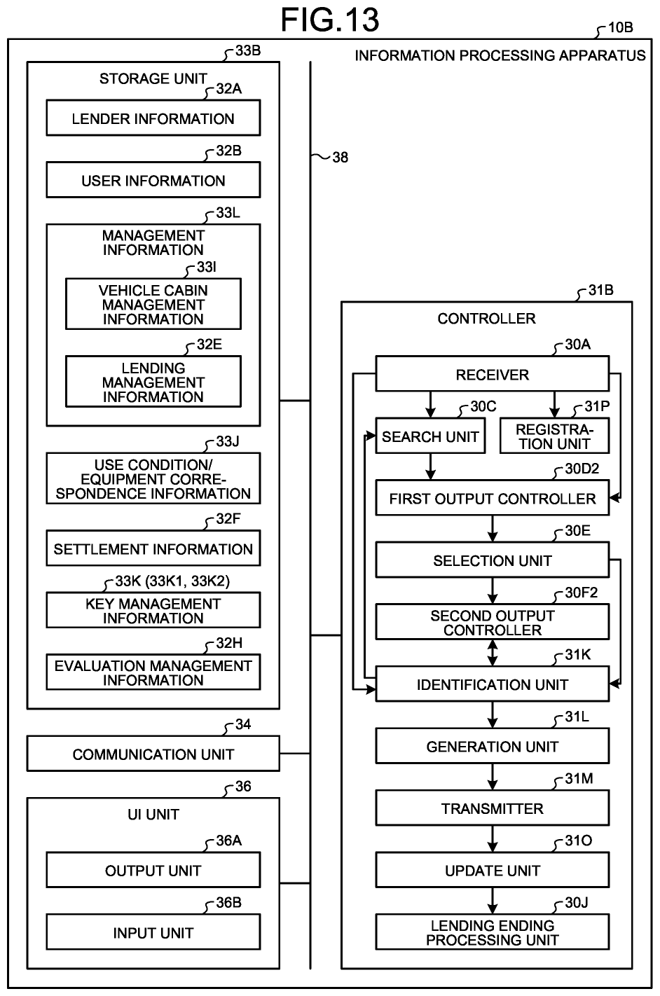

FIG. 13 is a block diagram of an example of the functional configuration of the information processing apparatus 10B.

The information processing apparatus 10B includes a controller 31B, a storage unit 33B, the communication unit 34, and the UI unit 36. The controller 31B, the storage unit 33B, the communication unit 34, and the UI unit 36 are connected to each other in such a manner that data or signals can be exchanged via the bus 38. The communication unit 34 and the UI unit 36 are the same as those of the first embodiment.

The storage unit 33B stores therein data. The storage unit 33B is a semiconductor memory element such as a RAM or a flash memory, a hard disk, or an optical disc, for example. The storage unit 33B may be a storage apparatus provided outside the information processing apparatus 10B. The storage unit 33B may be a storage medium. The storage unit 33B may include a plurality of storage media.

In the present embodiment, the storage unit 33B stores therein the lender information 32A, the user information 32B, management information 33L, the settlement information 32F, key management information 33K, the evaluation management information 32H, and use condition/equipment correspondence information 33J. The lender information 32A, the user information 32B, the settlement information 32F, and the evaluation management information 32H are the same as those of the first embodiment.

The management information 33L is a database for managing the vehicle cabin 17 of the vehicle 16 as the object to be lent out. The information processing apparatus 10B manages the management information 32C to manage the vehicle cabin 17 as the object to be lent out.

In the present embodiment, the management information 33L includes vehicle cabin management information 33I and the lending management information 32E. The lending management information 32E is the same as that of the first embodiment.

The vehicle cabin management information 33I is a database for managing the vehicle cabin 17. The vehicle cabin management information 33I and the lending management information 32E may be configured in a single database.

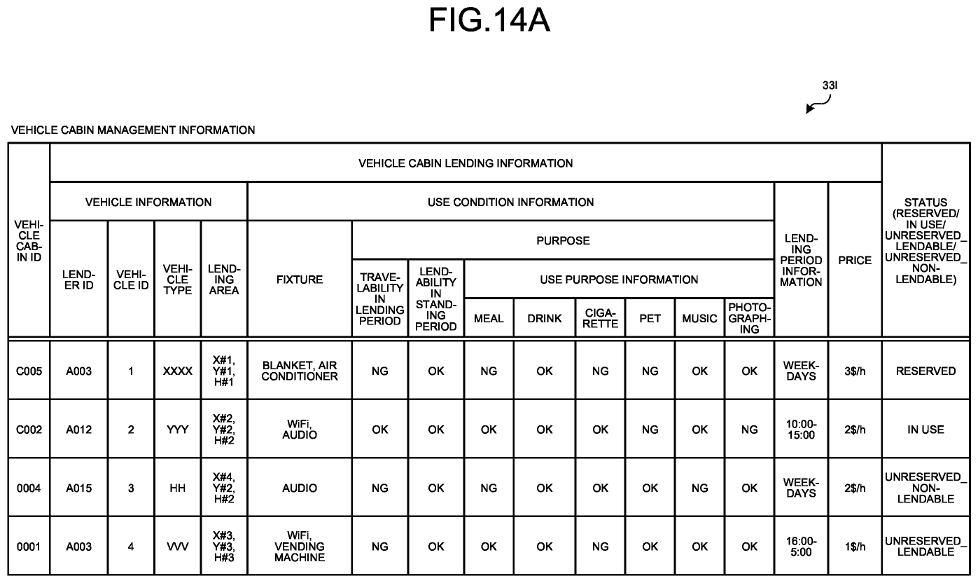

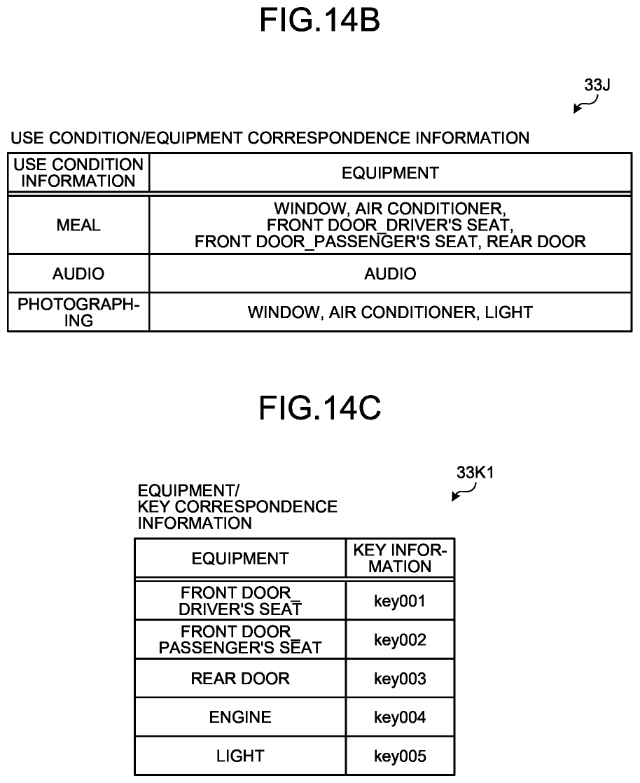

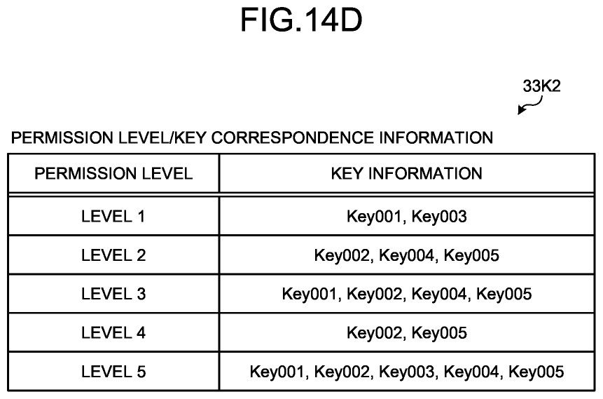

FIG. 14A is a diagram of an example of a data structure of the vehicle cabin management information 33I.

The vehicle cabin management information 33I is a database associating the vehicle cabin ID, the vehicle cabin lending information, and the status with each other.

The vehicle cabin lending information is information on the lending out of the vehicle cabin 17 and is information registered through an instruction by the lender 20. In the present embodiment, the vehicle cabin lending information includes information on each of the vehicle cabin information, use condition information, the lending period, and the use fee. The vehicle cabin information, the lending period, and the use fee are the same as those of the first embodiment.

The use condition information is information indicating a use condition when the vehicle cabin 17 is used. The use condition information is information including a fixture and a purpose, for example.

The fixture is information indicating each of various kinds of fixtures that can be used in the vehicle cabin 17 of the vehicle 16. The fixture is an electronic device that can be used in the vehicle cabin 17 or a non-electronic device that can be used in the vehicle cabin 17. The fixture may be an item fixed to or not fixed to the vehicle cabin 17. Specific examples of the fixture include, but are not limited to, blankets, air conditioners, audio, radios, interior lights, chargers, drive recorders, and Wi-Fi.

FIG. 14A illustrates an example of a form in which a list of fixtures permitted to be used by the lender 20 is registered in the vehicle cabin management information 33I. The vehicle cabin management information 33I may be a form of registering information indicating whether, for each of the fixtures, it is permitted to be used by the lender 20.

The purpose is information indicating a purpose when the user 22 uses the vehicle cabin 17 and the vehicle 16. The purpose includes information on each of the travelability during the lending period, the lendability in the standing period, and use purpose information. The definitions of the travelability during the lending period and the lendability in the standing period are the same as those of the first embodiment.

The use purpose information is information indicating a detailed purpose when the vehicle 16 or the vehicle cabin 17 is used. Examples of the use purpose information include, but are not limited to, meal, drink, cigarette, pet, music, photographing, and children.

FIG. 14A illustrates a case in which, for each use purpose information, “OK” indicating that it is a use purpose permitted to be used by the lender 20 or “NG” indicating that it is a use purpose not permitted to be used by the lender 20 is registered as an example. The vehicle cabin management information 33I may be a form of registering a list of the use purpose information permitted to be used by the lender 20.

The use condition information is information indicating each of fixtures and each of purposes. Thus, one piece of use condition information is described with a meaning of one among these pieces of information. A plurality of pieces of use condition information is described with a meaning of two or more among these pieces of information.

The vehicle cabin lending information of the vehicle cabin management information 33I is registered and updated through an instruction by the lender 20. The details of these pieces of processing will be described below.

As described in the first embodiment, the travelability during the lending period is the information indicating whether the traveling of the vehicle 16 in the lending period is permitted. The lendability in the standing period is the information indicating whether the lending out of the vehicle cabin 17 of the vehicle 16 to the user 22 in the standing period of the vehicle 16 is permitted.

Thus, when “the lendability in the standing period” is “OK,” the corresponding use purpose information for which “OK” is set is the use purpose information in the vehicle 16 in a stopping state permitted to be used by the lender 20. When “the travelability during the lending period” is “OK,” the corresponding use purpose information for which “OK” is set is the use purpose information in the vehicle 16 in a moving state permitted to be used by the lender 20.

Assumed is a case in which “the lendability in the standing period” is “OK” and “the travelability during the lending period” is “OK.” In this case, the corresponding use purpose information for which “OK” is set is the use purpose information in the vehicle 16 in each of the moving state and the stopping state permitted to be used by the lender 20.

The following describes the use condition/equipment correspondence information 33J.

FIG. 14B is a diagram of an example of a data structure of the use condition/equipment correspondence information 33J. The use condition/equipment correspondence information 33J is a database associating the use condition information and the equipment for implementing the use condition of the use condition information with each other.

As described in the first embodiment, the equipment is the mechanism provided in the vehicle 16. In the present embodiment, the equipment is the mechanism provided in the vehicle 16 and is a mechanism that can be unlocked or locked. In other words, the equipment is a mechanism that is made the unlocked state or the locked state by the unlocking-and-locking unit 24F of the vehicle 16. The definitions of the unlocked state and the locked state are the same as those of the first embodiment.

Examples of the equipment include, but are not limited to, a front window_driver's seat, a front window_passenger's seat, rear windows, an air conditioner, a front door_driver's seat, a front door_passenger's seat, audio, lights, an engine, and unlockable-and-lockable boxes. The fixtures described above may be included as examples of the equipment. The descriptive parts driver's seat and passenger's seat after “_” mean the driver's seat side and the passenger's seat side, respectively.

It is assumed that the use condition/equipment correspondence information 33J is generated in advance and is stored in the storage unit 33B in advance. The use condition/equipment correspondence information 33J may be able to be changed as appropriate through an operation instruction on the UI unit 36 by the user or the like.

Referring back to FIG. 13, the description is continued. The following describes the key management information 33K. The key management information 33K is a database for managing key information for unlocking the equipment of the vehicle cabin 17. The key information for unlocking each of the equipment is registered in the key management information 32G for each of the equipment of the vehicle cabin 17, for example. In the present embodiment, the key management information 33K includes equipment/key correspondence information 33K1 and permission level/key correspondence information 33K2.

FIG. 14C is a diagram of an example of a data structure of the equipment/key correspondence information 33K1. The equipment/key correspondence information 33K1 is a database associating the equipment and the key information with each other. The equipment/key correspondence information 33K1 stores therein in advance the key information for switching the equipment from the locked state to the unlocked state for each of the equipment.

FIG. 14D is a diagram of an example of a data structure of the permission level/key correspondence information 33K2. The permission level/key correspondence information 33K2 is a database associating a permission level and the key information with each other. A plurality of permission levels that are different from each other are registered in the permission level/key correspondence information 33K2, and a group including one or more pieces of key information is registered in association with each of the permission levels in advance.

It is assumed that the equipment/key correspondence information 33K1 and the permission level/key correspondence information 33K2 are generated in advance and are stored in the storage unit 33B in advance. A generation unit 31L described below may generate and update the equipment/key correspondence information 33K1 and the permission level/key correspondence information 33K2.

Referring back to FIG. 13, the description is continued. The data format of each of the above information stored in the storage unit 33B is not limited to the database. The data format may be a table format, for example.

The following describes the controller 31B. The controller 31B includes the receiver 30A, a registration unit 31P, the search unit 30C, a first output controller 30D2, the selection unit 30E, a second output controller 30F2, an identification unit 31K, the generation unit 31L, a transmitter 31M, an update unit 31O, and the lending ending processing unit 30J.

The receiver 30A, the registration unit 31P, the search unit 30C, the first output controller 30D2, the selection unit 30E, the second output controller 30F2, the identification unit 31K, the generation unit 31L, the transmitter 31M, the update unit 31O, and the lending ending processing unit 30J are implemented by one or more processors, for example. Each of the above units may be implemented by causing a processor such as a CPU to execute a computer program, that is, software, for example. Each of the above units may be implemented by a processor such as a dedicated IC, that is, hardware. Each of the above units may be implemented using software and hardware in combination. When the processors are used, each of the processors may implement one of the units or implement two or more of the units.

The receiver 30A, the search unit 30C, the first output controller 30D2, the selection unit 30E, the second output controller 30F2, and the lending ending processing unit 30J are the same as those of the first embodiment.

The registration unit 31P executes registration processing such as registration of the lender information in the lender information 32A, registration of the user information in the user information 32B, and registration of the vehicle cabin lending information in the vehicle cabin management information 33I in the same manner as the registration unit 30B of the first embodiment.

In the present embodiment, the registration unit 31P further registers the use condition information received from the lender terminal 12 in the vehicle cabin management information 33I.

The lender 20 operates the lender terminal 12 to input information on each of the vehicle information, the lending period, and the use fee. In the present embodiment, the lender 20 operates the lender terminal 12 to input the use condition information. That is to say, in the present embodiment, the lender 20 can designate the use condition of the vehicle 16 to be lent out. Then the registration unit 31P registers the use condition information received from the lender terminal 12 in the vehicle cabin management information 33I.

The identification unit 31K identifies the use condition information desired by the user 22 for whom the use of the vehicle cabin 17 is permitted among one or more pieces of use condition information indicating permission of use by the lender 20.

It is assumed that the use condition information permitted to be used by the lender 20 has already been registered in the vehicle cabin management information 33I. In this case, the identification unit 31K identifies the use condition information desired by the user 22 for whom the use of the vehicle cabin 17 is permitted among the one or pieces of use condition information indicating permission of use set in advance by the lender 20 registered in the vehicle cabin management information 33I.

The use condition information desired to be used by the user 22 for whom the use of the vehicle cabin 17 is permitted is received from the user terminal 14 together with the use reservation information, for example.

The reception timing of the use condition information is not limited to this timing. The use condition information desired to be used by the user 22 may be received together with the use request, for example. The use condition information desired to be used by the user 22 may be received from the user terminal 14 at any timing.

At the time of receiving operation input of the use condition information, the user terminal 14 displays a selection screen for the use condition information. The user 22 operates the user terminal 14 while referring to the selection screen to select the use condition information desired to be used. In this process, the selection screen may be provided with a remark input field to which the user 22 can input optional use condition information. In this case, the user 22 can input his/her desire of use for the use condition information not displayed on the selection screen.

On the other hand, assumed is a case in which the use condition information permitted to be used by the lender 20 is not registered in the vehicle cabin management information 33I.

In this case, the identification unit 31K transmits the use condition information received from the user terminal 14 to the lender terminal 12. The lender 20 operates the lender terminal 12 to select the use condition information permitted to be used among the received use condition information. Assumed is a case in which the optional use condition information of the user 22 has been input via the remark input field. In this case, for the use condition information, the use fee is not necessarily set. Thus, in this case, the lender 20 may input an additional fee when the use condition indicated in the use condition information is used. In this case, the lender terminal 12 transmits the use condition information permitted to be used by the lender 20 and additional fee information of the additional fee to the information processing apparatus 10B. Then the identification unit 31K identifies the use condition information permitted to be used by the lender 20 among the use condition information desired to be used by the user 22.

In the present embodiment, the identification unit 31K further generates a permission list. The permission list is information on a list of the equipment corresponding to the identified use condition information. The identification unit 31K identifies the equipment corresponding to the identified use condition information by reading it from the use condition/equipment correspondence information 33J and generates the permission list. The second output controller 30F2 transmits the generated permission list to the user terminal 14 and also transmits it to the vehicle 16 to be lent out.

The following describes the generation unit 31L.

The generation unit 31L generates the key information in the same manner as the generation unit 30G of the first embodiment. However, the generation unit 31L of the present embodiment generates the key information to make the equipment corresponding to the use condition information identified by the identification unit 31K the unlocked state. That is to say, the generation unit 31L generates the key information to make the equipment corresponding to the one or pieces of use condition information indicating permission of use set by the lender 20 of the vehicle cabin 17 the unlocked state.

Specifically, the generation unit 31L reads the equipment corresponding to the use condition information identified by the identification unit 31K from the use condition/equipment correspondence information 33J.

Then the generation unit 31L identifies the key information corresponding to each of the read equipment from the equipment/key correspondence information 33K1 (refer to FIG. 14C). The generation unit 31L may generate the key information corresponding to each of the read equipment and register it in the equipment/key correspondence information 33K1.

The generation unit 31L may also read the permission level corresponding to a group of the key information corresponding to each of the read equipment from the permission level/key correspondence information 33K2 (refer to FIG. 14D). Then the generation unit 31L may generate, from the group of the key information corresponding to the read permission level, a master key that can unlock all pieces of equipment corresponding to the key information included in the group. The master key may set information indicating the corresponding permission level. In the following, the master key with the information indicating the permission level set will be described referred to as the key information with the permission level set.

The transmitter 31M transmits the key information or the key information with the permission level set generated by the generation unit 31L to the user terminal 14.

Assumed is a case in which the generation unit 31L has generated the key information corresponding to each of the equipment permitted to be used, for example. In this case, the transmitter 31M transmits the generated key information corresponding to each of the equipment permitted to be used to the user terminal 14. In this process, the transmitter 31M may transmit locking instruction information, which instructs to make all pieces of equipment the locked state, and the key information to the vehicle 16.

Also assumed is a case in which the generation unit 31L has generated the key information with the permission level set, for example. In this case, the transmitter 31M transmits the generated key information with the permission level set to the user terminal 14. In this process, the transmitter 31M may transmit the locking instruction information, which instructs to make all pieces of equipment the locked state, and the key information with the permission level set to the vehicle 16.

The following describes the update unit 31O.

The update unit 31O detects the actual use state of the vehicle cabin 17 during the use period by the user 22 and registers it in the lending management information 32E as the use history information in the same manner as the update unit 30I of the first embodiment. As described in the first embodiment, the actual use state of the vehicle cabin 17 includes the position information of the vehicle 16 detected by the sensor 24C of the vehicle 16 and the operating state of each of the various kinds of electronic devices installed in the vehicle 16, for example.

In the present embodiment, the actual use state of the vehicle cabin 17 further includes whether the unlocking-and-locking unit 24F has been made the unlocked state and a time when it has been made the unlocked state corresponding to the equipment for implementing the use condition of the use condition information identified by the identification unit 31K.

That is to say, in the present embodiment, the update unit 31O executes update processing to update the use history information of the equipment permitted to be used by the lender 20 in the use period by the user 22 of the vehicle cabin 17 in addition to the functions of the update unit 30I of the first embodiment.

The following describes an example of a procedure of information processing executed by the information processing system 1B.

The following first describes a procedure of registration processing by the registration unit 31P. Registration processing for the lender information and registration processing for the user information by the registration unit 31P are the same as those of the first embodiment (refer to Step S1 and Step S2 in FIG. 9).

The following describes a procedure of registration processing for the vehicle cabin lending information executed by the information processing system 1B.

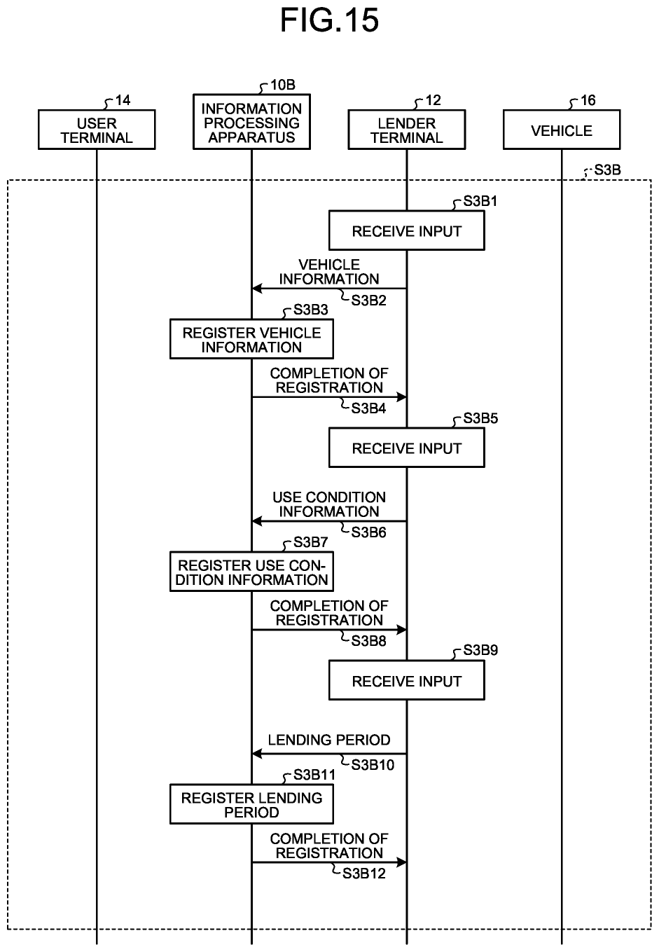

FIG. 15 is a sequence diagram of the procedure of the registration processing for the vehicle cabin lending information (Step S3B) executed by the information processing system 1B.

The lender 20 operates the lender terminal 12 to input the vehicle information in the vehicle cabin lending information. The lender terminal 12 receives input of the vehicle information (Step S3B1). The lender terminal 12 transmits the input vehicle information to the information processing apparatus 10B via the network 18 (Step S3B2). The registration unit 31P of the information processing apparatus 10B registers the vehicle information received from the lender terminal 12 in the vehicle cabin management information 33I in association with the vehicle cabin ID of the vehicle cabin 17 (Step S3B3). Then the registration unit 31P of the information processing apparatus 10B transmits information indicating the completion of registration to the lender terminal 12 (Step S3B4).

In addition, the lender 20 operates the lender terminal 12 to input the use condition information of the vehicle cabin 17. Specifically, the lender terminal 12 displays a display screen for receiving input of the use condition information of the vehicle cabin 17 and receives input of the use condition information by the lender 20 (Step S3B5).

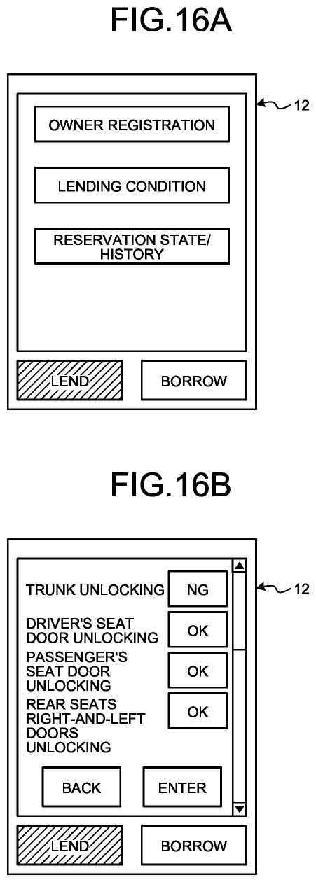

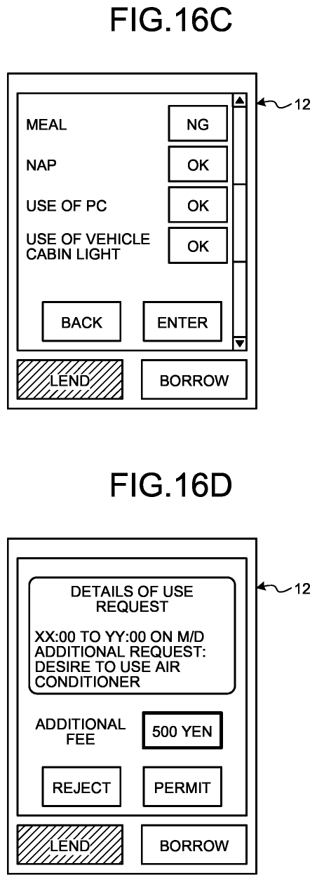

FIG. 16A to FIG. 16D are schematic diagrams of examples of the display screen displayed on the lender terminal 12. Upon input of a start-up instruction of the sharing system through an operation by the lender 20, the display screen illustrated in FIG. 16A is displayed on the lender terminal 12, for example. Upon selection of “OWNER REGISTRATION” by the lender 20, an input screen for the lender information is displayed, and the registration processing for the lender information is executed (refer to Step S1). On the other hand, it is assumed that “LENDING CONDITION” has been selected by the lender 20. The lender terminal 12 then displays a display screen for receiving input of the use condition information of the vehicle cabin 17.

The lender terminal 12 displays the display screen illustrated in FIG. 16B and the display screen illustrated in FIG. 16C, for example. These display screens include selection buttons to select whether each of the use condition information is to be permitted to be used. The lender 20 selects the use condition information to be permitted to be used while referring to the display screens to input the use condition information to be permitted to be used. FIG. 16D will be discussed below.

Referring back to FIG. 15, the description is continued. The lender terminal 12 receives input of the use condition information to be permitted to be used (Step S3B5). The lender terminal 12 transmits the input use condition information to the information processing apparatus 10B via the network 18 (Step S3B6). The registration unit 31P of the information processing apparatus 10B registers the use condition information received from the lender terminal 12 in the vehicle cabin management information 33I as the use condition information permitted to be used by the lender 20 in association with the vehicle cabin ID of the vehicle cabin 17 and the lender ID (Step S3B7). Then the registration unit 31P of the information processing apparatus 10B transmits information indicating the completion of registration to the lender terminal 12 (Step S3B8).

Next, the lender 20 operates the lender terminal 12 to input the lending period and the use fee in the vehicle cabin lending information. The lender terminal 12 receives input of the lending period and the use fee (Step S3B9). The lender terminal 12 transmits the lending period and the use fee having been input to the information processing apparatus 10B via the network 18 (Step S3B10). The registration unit 31P of the information processing apparatus 10B registers the lending period and the use fee received from the lender terminal 12 in the vehicle cabin management information 33I in association with the vehicle cabin ID of the vehicle cabin 17 (Step S3B11). Then the registration unit 31P of the information processing apparatus 10B transmits information indicating the completion of registration to the lender terminal 12 (Step S3B12).

The following describes a procedure of the use starting processing from when the use reservation information is input from the user terminal 14 to when the use of the vehicle cabin 17 is started.

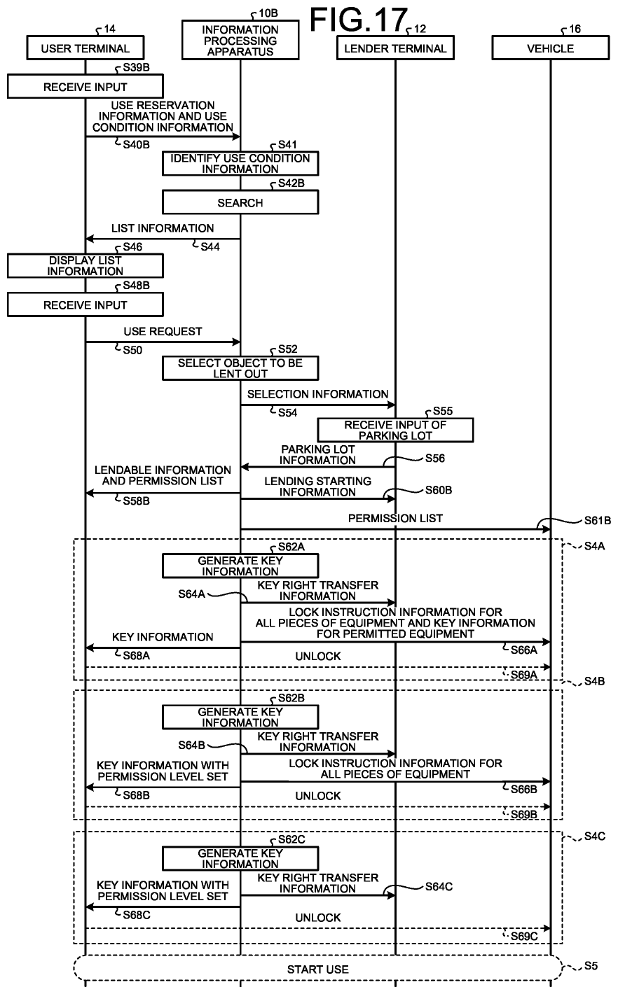

FIG. 17 is a sequence diagram of an example of the procedure of the use starting processing executed by the information processing system 1B.

FIG. 17 is a sequence diagram of an example of the procedure of the use starting processing when the reception of the use condition information to be permitted to be used from the lender terminal 12 of the lender 20 and the registration processing for the use condition information to be permitted to be used in the vehicle cabin management information 33I have been executed before receiving the use reservation information desired to be used from the user terminal 14 of the user 22.

The user terminal 14 receives input of the use reservation information and the use condition information (Step S39B).

The user 22 operates the user terminal 14 to input the use reservation information, which is search conditions for the vehicle cabin 17 that the user 22 desires to use and is information including one or more search words. The user 22 also inputs the use condition information of the vehicle cabin 17 desired to be used by the user 22.

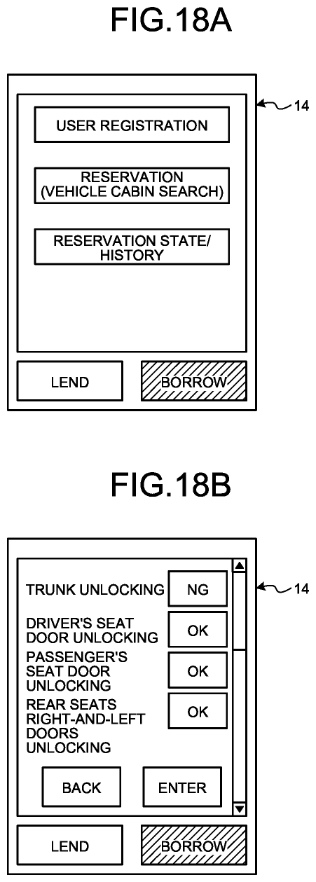

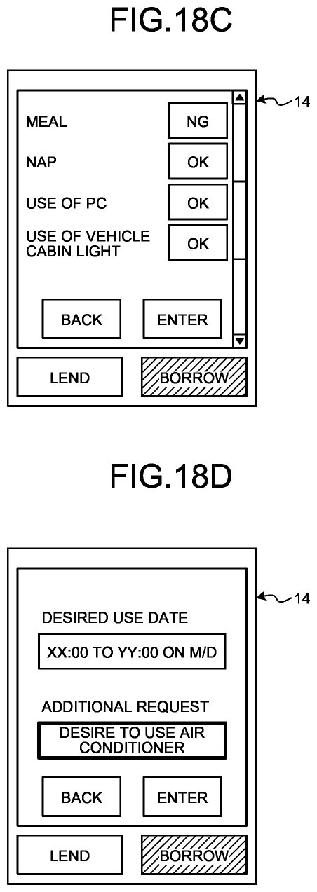

FIG. 18A to FIG. 18D are schematic diagrams of examples of a display screen displayed on the user terminal 14. Upon input of a start-up instruction of the sharing system through an operation by the user 22, the display screen illustrated in FIG. 18A is displayed on the user terminal 14, for example. Upon selection of “USER REGISTRATION” by the user 22, an input screen for the user information is displayed, and the registration processing for the user information is executed (Step S2) (refer to FIG. 9). On the other hand, it is assumed that “RESERVATION (VEHICLE CABIN SEARCH)” has been selected by the user 22. The user terminal 14 then displays a display screen for receiving input of the use reservation information. Through an operation instruction by the user 22, the use reservation information is input via the display screen. The user terminal 14 also displays an input screen for the use condition information.

The user terminal 14 displays the input screen illustrated in FIG. 18B and the input screen illustrated in FIG. 18C, for example. These input screens include selection buttons to select whether each of the use condition information is desired to be used. The user 22 selects the use condition information desired to be used while referring to the input screen to input the use condition information desired to be used.

As described above, the user 22 may desire input of optional use condition information. For this purpose, as illustrated in FIG. 18D, the display screen may be provided with a remark input field to which an optional use condition of the user 22 can be input. FIG. 18D illustrates the display of “ADDITIONAL REQUEST” and an input field therefor as an example of the remark input field. In this case, the user 22 operates the user terminal 14 to input information indicating desire of use to the input field. FIG. 18D illustrates a form in which “DESIRE TO USE AIR CONDITIONER” has been input as an example. This input screen may display at least partial information included in the use reservation information input by the user 22. The at least partial information is the date, the use starting time, or the use ending time on which the vehicle cabin 17 is scheduled to be used, for example.

Referring back to FIG. 17, the description is continued. The user terminal 14 receives input of the use reservation information and the use condition information by the user 22 (Step S39B). The user terminal 14 transmits the use reservation information and the use condition information having been received to the information processing apparatus 10B (Step S40B).

The identification unit 31K searches the vehicle cabin management information 33I to identify the use condition information desired by the user 22 among the one or pieces of use condition information indicating permission of use by the lender 20 (Step S41).

The search unit 30C of the information processing apparatus 10B searches the vehicle cabin management information 32D for the vehicle cabin lending information satisfying the use reservation information and the use condition information received from the user terminal 14 (Step S42B).

The first output controller 30D2 of the information processing apparatus 10B transmits the list information 32X, which is the list of the vehicle cabin lending information searched for by the search unit 30C, to the user terminal 14 (Step S44). The user terminal 14 outputs the list information 32X to the output unit 26F of the user terminal 14 (Step S46) (refer to FIG. 6).

The user 22 operates the user terminal 14 while referring to the list information 32X displayed on the user terminal 14 to select one piece of vehicle cabin lending information that the user 22 desires to use (Step S48B). The user terminal 14 transmits the use request including the input vehicle cabin lending information to the information processing apparatus 10B (Step S50).

The selection unit 30E of the information processing apparatus 10B selects the vehicle cabin lending information received at Step S50 as the vehicle cabin lending information of the vehicle cabin 17 to be lent out (Step S52). The selection unit 30E of the information processing apparatus 10B transmits the selection information including the vehicle cabin lending information of the vehicle cabin 17 selected at Step S52 and the input instruction signal of the parking lot information to the lender terminal 12 of the lender 20 identified by the lender ID included in the vehicle cabin lending information (Step S54). Upon reception of input of the parking lot (Step S55), the lender terminal 12 transmits the parking lot information of the received parking lot to the information processing apparatus 10B (Step S56).

The identification unit 31K of the information processing apparatus 10B may at this timing identify the use condition information desired to be used by the user 22 received at Step S40B among the use condition information permitted to be used registered in the vehicle cabin lending information selected at Step S52.

The identification unit 31K generates the permission list, which is the list of the equipment corresponding to the identified use condition information. The second output controller 30F2 transmits the generated permission list to the user terminal 14 together with the lendable information (Step S58B). The user terminal 14 stores therein the received permission list.

The second output controller 30F2 transmits lending starting information to the lender terminal 12 (Step S60B). The second output controller 30F2 also transmits the permission list to the vehicle 16 (Step S61B). The vehicle 16 stores therein the received permission list.

Next, the generation unit 31L of the information processing apparatus 10B generates the key information.

The information processing system 1B executes key generation processing at Step S62A to Step S69A (Step S4A), for example.

Specifically, the generation unit 31L of the information processing apparatus 10B generates the key information to make each of the equipment corresponding to the use condition information identified at Step S57B the unlocked state (Step S62A). Then the transmitter 31M of the information processing apparatus 10B provides notification that a key right, which is the right of the key information to make the equipment of the vehicle cabin 17 the unlocked state, has been transferred to the user terminal 14 to the lender terminal 12 (Step S64A). Next, the transmitter 31M of the information processing apparatus 10B transmits the locking instruction information indicating that all pieces of equipment provided in the vehicle 16 are made the locked state and the key information generated at Step S62A to the vehicle 16 (Step S66A). The vehicle 16 having received the locking instruction information and the key information makes all pieces of equipment of the vehicle 16 the locked state and stores therein the key information.

The transmitter 31M of the information processing apparatus 10B transmits the key information generated at Step S62B to the user terminal 14, to which the lendable information has been transmitted at Step S58B (Step S68A). The user terminal 14 having received the key information for each of the equipment stores therein the received key information.

The key information is communicated between the user terminal 14 and the vehicle 16, whereby the equipment of the vehicle cabin 17 of the vehicle 16 corresponding to the information becomes the unlocked state (Step S69A). That is to say, the equipment permitted to be used by the lender 20 among the equipment desired to be used by the user 22 can be made the unlocked state. Thus, the user 22 using the vehicle cabin 17 can use the equipment (Step S5).

The information processing system 1B executes key generation processing at Step S62B to Step S69B (Step S4B), for example.

Specifically, the generation unit 31L of the information processing apparatus 10B reads the equipment corresponding to the use condition information identified at Step S57B from the use condition/equipment correspondence information 33J. Then the generation unit 31L reads the key information corresponding to the read equipment from the equipment/key correspondence information 33K1. Further, the generation unit 31L reads the permission level corresponding to the read key information from the permission level/key correspondence information 33K2. Then the generation unit 31L generates the master key, from the group of the key information corresponding to the read permission level, that can unlock all pieces of equipment corresponding to the key information included in the group as the key information with the permission level set (Step S62B).

Next, the transmitter 31M of the information processing apparatus 10B provides notification that the key right, which is the right of the key information to make the equipment of the vehicle cabin 17 the unlocked state, has been transferred to the user terminal 14 to the lender terminal 12 (Step S64B). Specifically, the transmitter 31M transmits the transfer information indicating that the key right has been transferred to the user 22 to the lender terminal 12. Next, the transmitter 31M of the information processing apparatus 10B transmits the locking instruction information indicating that all pieces of equipment provided in the vehicle 16 are made the locked state and the key information with the permission level set generated at Step S62B to the vehicle 16 (Step S66B). The vehicle 16 having received the locking instruction information and the key information with the permission level set makes all pieces of equipment of the vehicle 16 the locked state and stores therein the key information with the permission level set.

The transmitter 31M of the information processing apparatus 10B transmits the key information with the permission level set generated at Step S62B to the user terminal 14, to which the lendable information has been transmitted at Step S58B (Step S68B). The user terminal 14 having received the key information with the permission level set stores therein the received key information.

The key information with the permission level set is communicated between the user terminal 14 and the vehicle 16, whereby a group of the equipment of the vehicle cabin 17 of the vehicle 16 corresponding to the key information becomes the unlocked state (Step S69B). That is to say, the equipment permitted to be used by the lender 20 among the equipment desired to be used by the user 22 can be made the unlocked state. Thus, the user 22 using the vehicle cabin 17 can use the equipment (Step S5).

The information processing system 1B executes key generation processing at Step S62C to Step S69C (Step S4C), for example.

Specifically, the generation unit 31L of the information processing apparatus 10B generates the key information with the permission level set in the same manner as Step 62B (Step S62C).

Next, the transmitter 31M of the information processing apparatus 10B provides notification that the key right, which is the right of the key information to make the equipment of the vehicle cabin 17 the unlocked state, has been transferred to the user terminal 14 to the lender terminal 12 (Step S64C). Next, the transmitter 31M of the information processing apparatus 10B transmits the key information with the permission level set generated at Step S62C to the user terminal 14, to which the lendable information has been transmitted at Step S58B (Step S68C). The user terminal 14 having received the key information with the permission level set stores therein the received key information.

The key information with the permission level set is communicated between the user terminal 14 and the vehicle 16, whereby a group of the equipment of the vehicle cabin 17 of the vehicle 16 corresponding to the key information becomes the unlocked state (Step S69C). That is to say, the equipment permitted to be used by the lender 20 among the equipment desired to be used by the user 22 can be made the unlocked state. Thus, the user 22 using the vehicle cabin 17 can use the equipment (Step S5).

The following describes an example of a procedure of the use starting processing when the use condition information permitted to be used by the lender 20 is set in accordance with a request from the user 22.

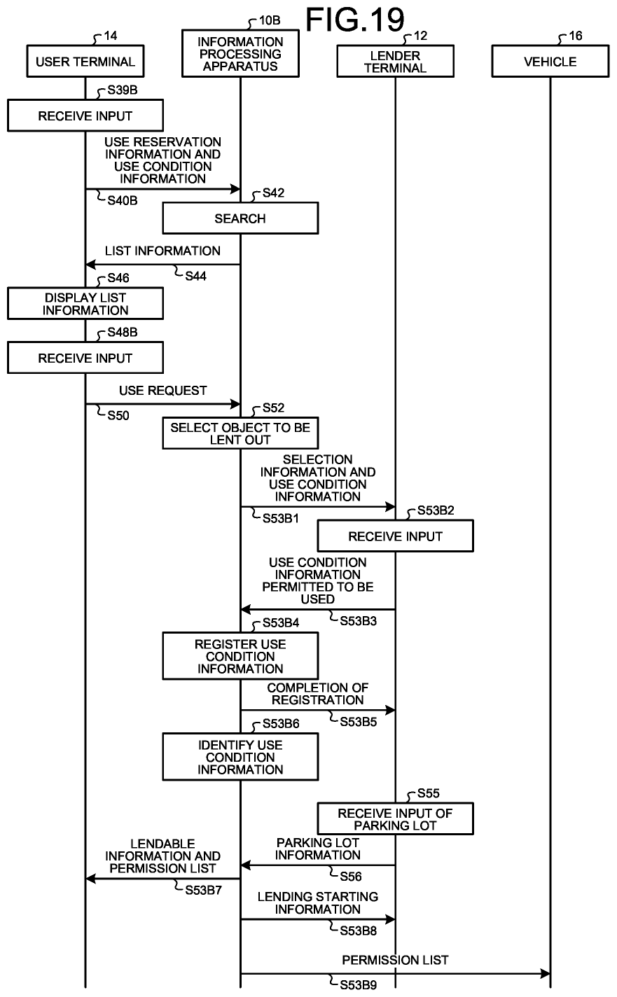

FIG. 19 is a sequence diagram of an example of the procedure of the use starting processing when the use condition information permitted to be used by the lender 20 is set in accordance with the request from the user 22.

In this case, it is assumed that the information processing system 1B has not executed the registration processing for the use condition information to be permitted to be used by the lender 20 (Step S3B5 to Step S3B8) in the registration processing (Step S3B) described with reference to FIG. 15.

The user terminal 14 receives input of the use reservation information and the use condition information by the user 22 (Step S39B). The user terminal 14 transmits the use reservation information and the use condition information having been received to the information processing apparatus 10B (Step S40B). The search unit 30C of the information processing apparatus 10B searches the vehicle cabin management information 32D for the vehicle cabin lending information satisfying the use reservation information received from the user terminal 14 (Step S42).

The first output controller 30D2 of the information processing apparatus 10B transmits the list information 32X to the user terminal 14 (Step S44). The user terminal 14 outputs the list information 32X to the output unit 26F of the user terminal 14 (Step S46). The user terminal 14 receives selection of one piece of vehicle cabin lending information that the user 22 desires to use (Step S48).

The user terminal 14 transmits the use request including the input vehicle cabin lending information to the information processing apparatus 10B (Step S50). The selection unit 30E of the information processing apparatus 10B selects the vehicle cabin lending information included in the use request received at Step S50 as the vehicle cabin lending information of the vehicle cabin 17 to be lent out (Step S52).

Next, the second output controller 30F2 of the information processing apparatus 10B transmits the selection information including the vehicle cabin lending information of the vehicle cabin 17 selected at Step S52 and the input instruction signal of the parking lot information and the use condition information received at Step S40B to the lender terminal 12 (Step S53B1).

The lender terminal 12 operates the lender terminal 12 to select the use condition information to be permitted to be used among the use condition information received at Step S53B1. The lender terminal 12 displays the display screens illustrated in FIG. 16B to FIG. 16D, for example. The lender 20 selects the use condition information to be permitted to be used while referring to the display screens to input the use condition information to be permitted to be used. When the optional use condition information of the user 22 has been input via the remark input field, the lender 20 inputs whether the use condition information is to be permitted to be used. When the optional use condition information of the user 22 is permitted to be used, an additional fee is input (refer to FIG. 16D).

The lender terminal 12 receives input of the use condition information permitted to be used by the lender 20 (Step S53B2). Then the lender terminal 12 transmits the use condition information permitted to be used to the information processing apparatus 10B (Step S53B3). When receiving input of the optional use condition information of the user 22 and the additional fee, the lender terminal 12 also transmits the use condition information and the additional fee to the information processing apparatus 10B.

The registration unit 31P of the information processing apparatus 10B registers the use condition information received from the lender terminal 12 in the vehicle cabin management information 33I as the use condition information permitted to be used by the lender 20 in association with the vehicle cabin ID of the vehicle cabin 17 and the lender ID (Step S53B4). Then the registration unit 31P of the information processing apparatus 10B transmits information indicating the completion of registration to the lender terminal 12 (Step S53B5).

The identification unit 31K of the information processing apparatus 10B identifies the use condition information registered in the vehicle cabin management information 33I at Step S53B4 as the use condition information permitted to be used by the lender 20 and desired to be used by the user 22 (Step S53B6).

Next, upon reception of input of the parking lot (Step S55), the lender terminal 12 transmits the parking lot information of the received parking lot to the information processing apparatus 10B (Step S56). The processing at Step S55 and Step S56 may be performed simultaneously with the processing at Step S53B2 and Step S53B3.

Then the identification unit 31K generates the permission list, which is the list of the equipment corresponding to the use condition information identified at Step S53B6. The second output controller 30F2 transmits the generated permission list to the user terminal 14 together with the lendable information (Step S53B7). The user terminal 14 stores therein the received permission list.

The second output controller 30F2 transmits the lendable information to the lender terminal 12 (Step S53B8). The second output controller 30F2 also transmits the permission list to the vehicle 16 (Step S53B9). The vehicle 16 stores therein the received permission list.

Next, the generation unit 31L of the information processing apparatus 10B executes the key generation processing. The key generation processing is the same as Step S4A, Step S4B, or Step S4C in FIG. 17.

The following describes update processing for the use history information executed by the information processing system 1B. The information processing system 1B executes the update processing at Step S6 described with reference to FIG. 11.

In addition, the information processing system 1B further executes update processing to update the use history information of the equipment permitted to be used by the lender 20.

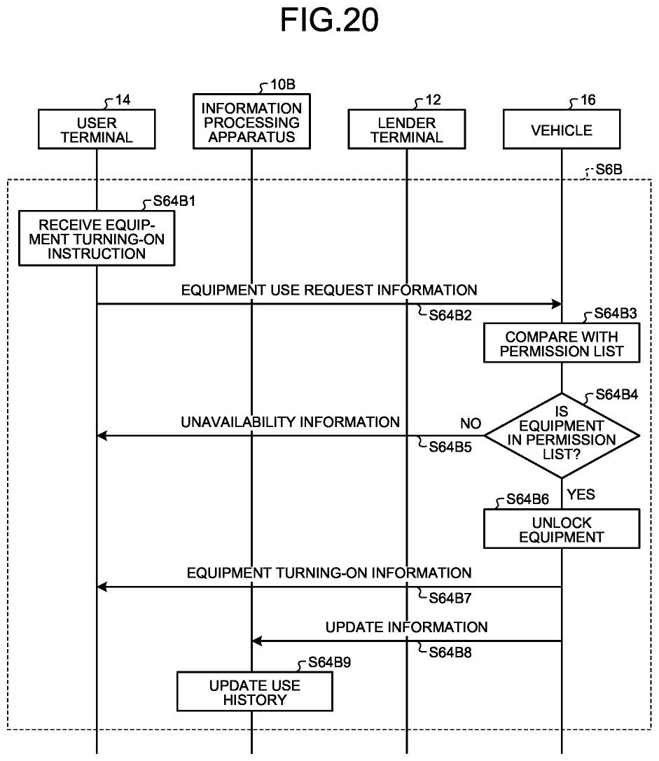

FIG. 20 is a sequence diagram of an example of a procedure of the update processing for the use history information of the equipment permitted to be used (Step S6B) As described above, each of the user terminal 14 and the vehicle 16 has already stored the permission list.

During the use period of the vehicle cabin 17, the user 22 operates the user terminal 14 to input an equipment turning-on instruction to make the equipment permitted to be used indicated in the permission list the unlocked state. Each time the equipment turning-on instruction is input, the information processing system 1B executes the update processing (Step S6B).

Upon reception of input of the equipment turning-on instruction (Step S64B1), the user terminal 14 transmits equipment use request information of the equipment indicated by the received equipment turning-on instruction to the vehicle 16 (Step S64B2).

The controller 24A of the vehicle 16 refers to the permission list to check whether the equipment included in the received equipment use request information is included in the permission list (Step S64B3). If determining that the equipment included in the received equipment use request information is not included in the permission list (No at Step S64B4), the controller 24A of the vehicle 16 transmits unavailability information indicating the unavailability of the equipment to the user terminal 14 (Step S64B5).

On the other hand, if determining that the equipment included in the received equipment use request information is included in the permission list (Yes at Step S64B4), the controller 24A of the vehicle 16 drives the unlocking-and-locking unit 24F corresponding to the equipment to make the equipment the unlocked state (Step S64B6). With this processing, the equipment becomes the unlocked state, that is, available to the user or the equipment becomes able to be driven. Then the controller 24A of the vehicle 16 transmits update information including the identification information of the equipment, information indicating that the equipment has been made the unlocked state, and a time at which the unlocked state was made to the information processing apparatus 10B (Step S64B8).

The update unit 31O of the information processing apparatus 10B registers the update information received from the vehicle 16 in the lending management information 32E as the history information of the equipment (Step S64B9).

The following describes an example of a procedure of information processing executed by the information processing apparatus 10B.

The following first describes the use starting processing when the reception of the use condition information to be permitted to be used from the lender terminal 12 of the lender 20 and the registration processing for the use condition information to be permitted to be used in the vehicle cabin management information 33I have been executed before receiving the use reservation information desired to be used from the user terminal 14 of the user 22.

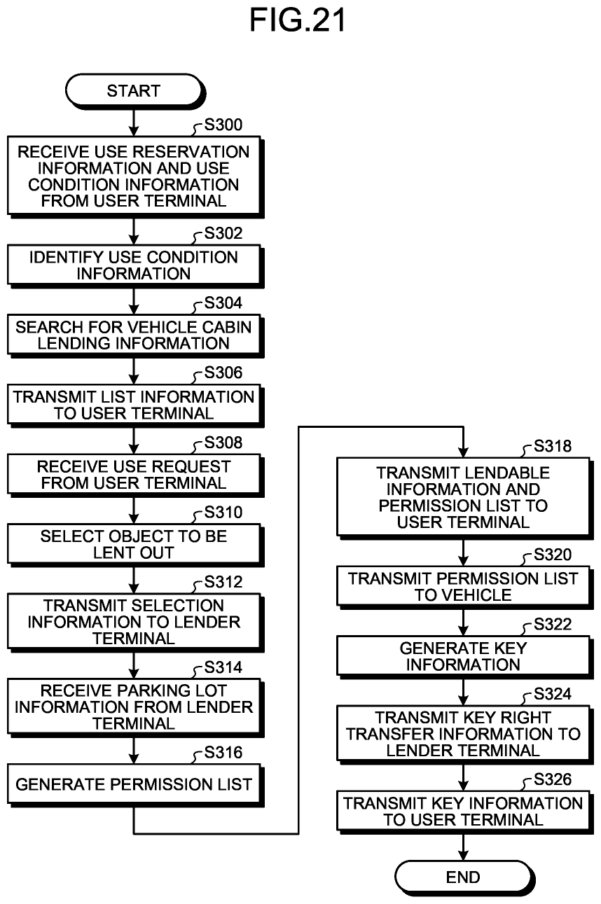

FIG. 21 is a flowchart of an example of a procedure of the use starting processing (refer to FIG. 17) executed by the information processing apparatus 10B.

The receiver 30A receives the use reservation information and the use condition information desired to be used by the user 22 from the user terminal 14 (Step S300).

The identification unit 31K searches the vehicle cabin management information 33I to identify the use condition information desired by the user 22 received at Step S300 among the one or pieces of use condition information indicating permission of use by the lender 20 (Step S302).

Next, the search unit 30C searches the vehicle cabin management information 32D for the vehicle cabin lending information satisfying the use reservation information and the use condition information received at Step S300 (Step S304).

The first output controller 30D2 transmits the list information 32X, which is the list of the vehicle cabin lending information searched for by the search unit 30C, to the user terminal 14 (Step S306).

In the search processing at Step S302, when the vehicle cabin lending information satisfying the use reservation information and the use condition information received at Step S300 cannot be searched for from the vehicle cabin management information 32D, the present routine may end.

Next, the receiver 30A receives the use request including the vehicle cabin lending information selected by the user 22 from the user terminal 14 (Step S308).

Next, the selection unit 30E selects the vehicle cabin lending information included in the use request received at step S308 as the vehicle cabin lending information of the vehicle cabin 17 to be lent out (Step S310). The selection unit 30E of the information processing apparatus 10B transmits the selection information including the vehicle cabin lending information of the vehicle cabin 17 selected at Step S310 and the input instruction signal of the parking lot information to the lender terminal 12 of the lender 20 identified by the lender ID included in the vehicle cabin lending information (Step S312).

The receiver 30A receives the parking lot information from the lender terminal 12 (Step S314).

The identification unit 31K generates the permission list, which is the list of the equipment corresponding to the use condition information identified at Step S302 (Step S316).

The identification unit 31K may identify the use condition information and generate the permission list at this timing. In this case, the identification unit 31K may identify the use condition information received at Step S300 among the use condition information registered in the vehicle cabin lending information selected at Step S310.

The second output controller 30F2 transmits the generated permission list to the user terminal 14 together with the lendable information (Step S318). The second output controller 30F2 also transmits the permission list generated at Step S316 to the vehicle 16 (Step S320).

Next, the generation unit 31L generates the key information (Step S322). The transmitter 31M provides notification that the key right, which is the right of the key information to make the equipment of the vehicle cabin 17 the unlocked state, has been transferred to the user terminal 14 to the lender terminal 12 (Step S324). Next, the transmitter 31M transmits the key information generated at Step S322 to the user terminal 14, which is the transmission source of the use request at Step S308 (Step S326). Then the present routine ends.

The following describes an example of a procedure of the use starting processing executed by the information processing apparatus 10B when the lender 20 sets the use condition information to be permitted to be used in accordance with the request from the user 22.

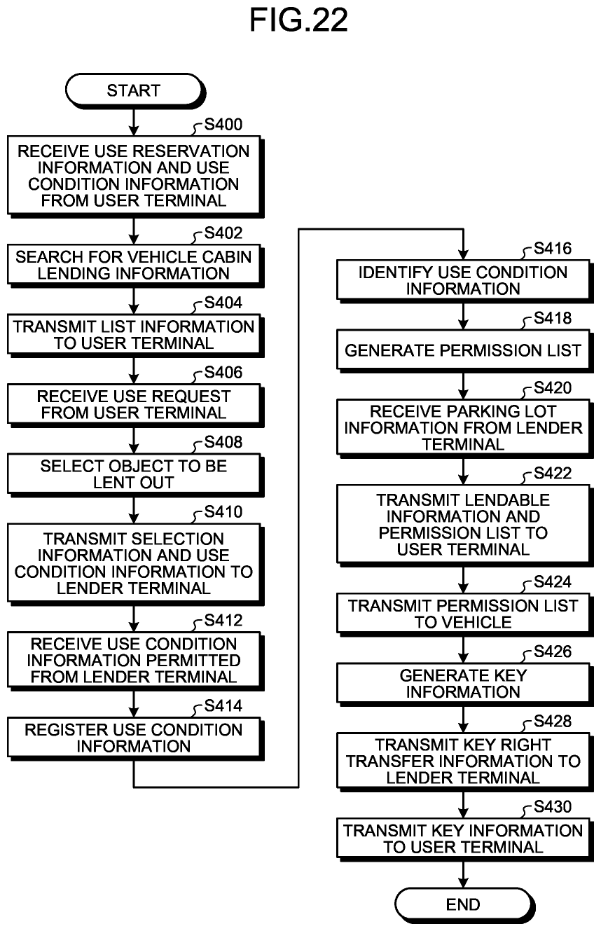

FIG. 22 is a flowchart of an example of the procedure of the use starting processing executed by the information processing apparatus 10B. As described above, in this case, it is assumed that the information processing apparatus 10B has not executed the registration processing for the use condition information to be permitted to be used by the lender 20 (Step S3B5 to Step S3B8) in the registration processing (Step S3B) described with reference to FIG. 15.

The receiver 30A receives the use reservation information and the use condition information desired to be used by the user 22 from the user terminal 14 (Step S400). The search unit 30C searches the vehicle cabin management information 32D for the vehicle cabin lending information satisfying the use reservation information received at Step S400 (Step S402).

The first output controller 30D2 transmits the list information 32X, which is the list of the vehicle cabin lending information searched for by the search unit 30C, to the user terminal 14 (Step S404).

In the search processing at Step S402, if the vehicle cabin lending information satisfying the use reservation information received at Step S400 cannot be searched for from the vehicle cabin management information 32D, the present routine may end.

Next, the receiver 30A receives the use request including the vehicle cabin lending information selected by the user 22 and the request signal requesting the use of the vehicle cabin 17 from the user terminal 14 (Step S406).

Next, the selection unit 30E selects the vehicle cabin lending information included in the use request received at step S406 as the vehicle cabin lending information of the vehicle cabin 17 to be lent out (Step S408). The selection unit 30E of the information processing apparatus 10B transmits the selection information including the vehicle cabin lending information of the vehicle cabin 17 selected at Step S408 and the input instruction signal of the parking lot information and the use condition information received at Step S400 to the lender terminal 12 (Step S410).

The receiver 30A receives the use condition information permitted by the lender 20 from the lender terminal 12 (Step S412). When the optional use condition information of the user 22 has been input via the remark input field on the user terminal 14, and when the use condition information has been permitted to be used by the lender 20, the receiver 30A also receives the use condition information and the additional fee information.

Next, the registration unit 31P registers the use condition information received at Step S412 in the vehicle cabin management information 33I as the use condition information permitted to be used by the lender 20 in association with the vehicle cabin ID of the vehicle cabin 17 and the lender ID (Step S414). When the additional fee information is received at Step S412, the additional fee is registered in the vehicle cabin management information 33I.

The identification unit 31K identifies the use condition information received from the lender terminal 12 at Step S412 (Step S416).

Then the identification unit 31K generates the permission list, which is the list of the equipment corresponding to the use condition information identified at Step S416 (Step S418).

Next, the receiver 30A receives the parking lot information from the lender terminal 12 (Step S420).

The second output controller 30F2 transmits the permission list generated at Step S418 to the user terminal 14 together with the lendable information (Step S422). The second output controller 30F2 also transmits the permission list generated at Step S316 to the vehicle 16 (Step S424).

Next, the generation unit 31L generates the key information (Step S426). The transmitter 31M provides notification that the key right, which is the right of the key information to make the equipment of the vehicle cabin 17 the unlocked state, has been transferred to the user terminal 14 to the lender terminal 12 (Step S428). Next, the transmitter 31M transmits the key information generated at Step S426 to the user terminal 14, which is the reception source of the use request at Step S406 (Step S430). Then the present routine ends.

As described above, the information processing apparatus 10B of the present embodiment is the information processing apparatus 10B in the system lending out the vehicle cabin 17 of the vehicle 16. The information processing apparatus 10B includes the generation unit 31L and the transmitter 31M. The generation unit 31L generates the key information to make the equipment of the vehicle cabin 17 corresponding to the use condition information indicating one or more use conditions indicating permission of use set by the lender 20 of the vehicle cabin 17 the unlocked state. The transmitter 31M transmits the key information to the user terminal 14 of the user 22 for whom the use the vehicle cabin 17 is permitted.

Thus, the information processing apparatus 10B of the present embodiment manages not the vehicle 16 but the vehicle cabin 17 of the vehicle 16 as the object to be lent out. Thus, the vehicle cabin 17 to be lent out can be managed regardless of whether the vehicle 16 moves or does not move while being lent out.

Consequently, the information processing apparatus 10B of the present embodiment can achieve effective sharing of the mobile object not in a moving state.

The information processing apparatus 10B of the present embodiment generates the key information of the equipment corresponding to the use condition information to be permitted to be used set by the lender 20 of the vehicle cabin 17 and transmits the generated key information to the user terminal 14.

Thus, in addition to the above effects, the information processing apparatus 10B of the present embodiment enables the lender 20 to set the use condition of the equipment of the vehicle cabin 17. The user 22 can use the equipment permitted to be used by the lender 20.

### Third Embodiment

The present embodiment describes a form in which the vehicle cabin 17 of the vehicle 16 for which the completion of standing is detected is the object to be lent out.

In the present embodiment, the same functions and components as those of the first embodiment or the second embodiment are given the same symbols, and a detailed description is omitted. In the sequence diagrams and the flowcharts used in the present embodiment, the same processing parts as those of the first embodiment or the second embodiment are given the same step numbers, and a detailed description is omitted.

As illustrated in FIG. 1A, an information processing system 1C of the present embodiment is the same as the information processing system 1 of the first embodiment except that it includes an information processing apparatus 10C in place of the information processing apparatus 10 (refer to FIG. 1A). The hardware configuration of the information processing apparatus 10C is the same as that of the information processing apparatus 10 (refer to FIG. 2).

The information processing apparatus 10C manages the vehicle cabin 17 of the vehicle 16 as the object to be lent out in the same manner as the information processing apparatus 10 of the first embodiment.

The following describes a case in which the information processing apparatus 10C is C2C sharing as an example, which manages the lending and borrowing of the vehicle cabin 17 between the lender 20, who is the owner of the vehicle 16, and the user 22 of the vehicle cabin 17 of the vehicle 16 in the same manner as the information processing apparatus 10 and the information processing system 1 of the first embodiment.

The following describes a functional configuration of the information processing apparatus 10C of the present embodiment.

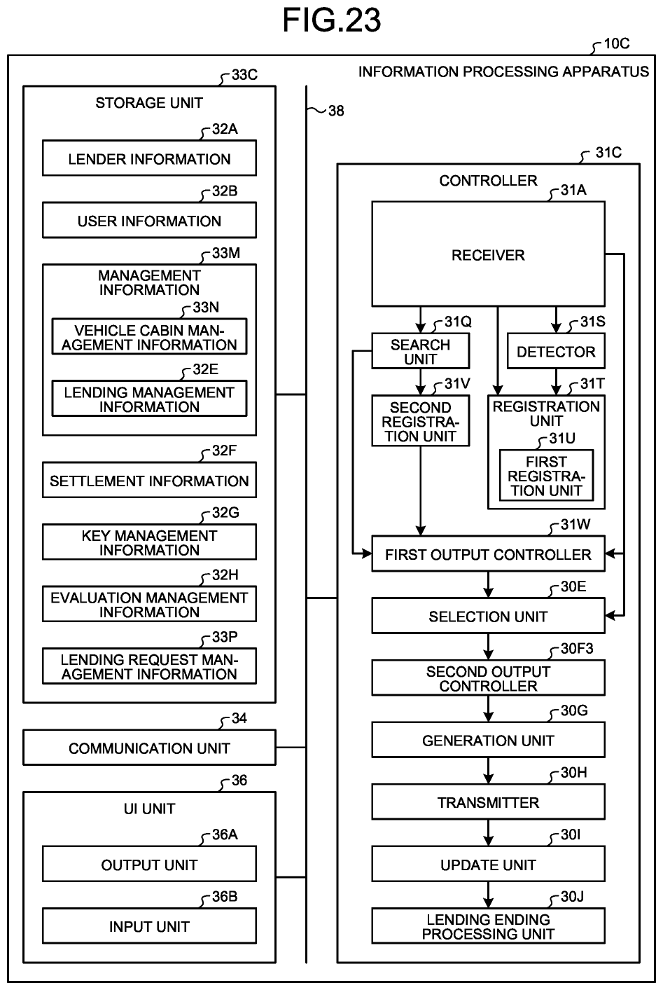

FIG. 23 is a block diagram of an example of the functional configuration of the information processing apparatus 10C.

The information processing apparatus 10C includes a controller 31C, a storage unit 33C, the communication unit 34, and the UI unit 36. The controller 31C, the storage unit 33C, the communication unit 34, and the UI unit 36 are connected to each other in such a manner that data or signals can be exchanged via the bus 38. The communication unit 34 and the UI unit 36 are the same as those of the first embodiment.

The storage unit 33C stores therein data. The storage unit 33C is a semiconductor memory element such as a RAM or a flash memory, a hard disk, or an optical disc, for example. The storage unit 33C may be a storage apparatus provided outside the information processing apparatus 10C. The storage unit 33C may be a storage medium. The storage unit 33C may include a plurality of storage media.

In the present embodiment, the storage unit 33C stores therein the lender information 32A, the user information 32B, management information 33M, the settlement information 32F, the key management information 32G, the evaluation management information 32H, and lending request management information 33P. The lender information 32A, the user information 32B, the settlement information 32F, the key management information 32G, and the evaluation management information 32H are the same as those of the first embodiment.

The management information 33M is a database for managing the vehicle cabin 17 of the vehicle 16 as the object to be lent out. The information processing apparatus 10C manages the management information 33M to manage the vehicle cabin 17 as the object to be lent out.

In the present embodiment, the management information 33M includes vehicle cabin management information 33N and the lending management information 32E. The lending management information 32E is the same as that of the first embodiment.

The vehicle cabin management information 33N is a database for managing the vehicle cabin 17. The vehicle cabin management information 33N and the lending management information 32E may be configured in a single database.

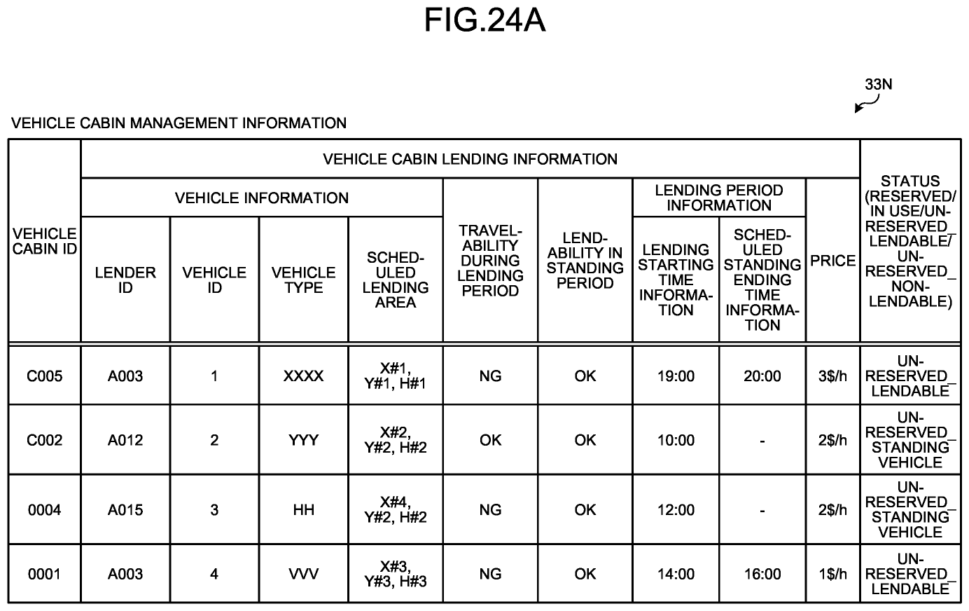

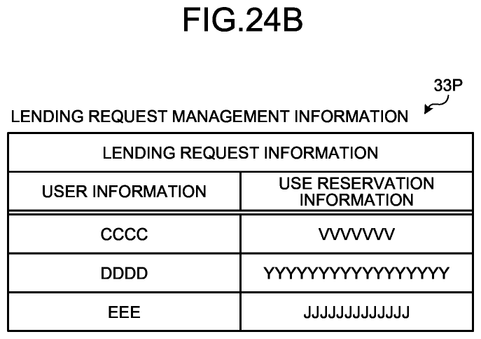

FIG. 24A is a diagram of an example of a data structure of the vehicle cabin management information 33N. The vehicle cabin management information 33N is a database associating the vehicle cabin ID, the vehicle cabin lending information, and the status with each other.

The vehicle cabin lending information is the same as that of the first embodiment. The present embodiment describes a form in which lending period information included in the vehicle cabin lending information is represented by lending starting time information and scheduled standing ending time information.

The lending starting time information is information indicating timing at which the lending out of the vehicle cabin 17 is scheduled to start. The timing at which lending out is scheduled to start is represented by information indicating a time at which lending out is scheduled to start, for example. In the present embodiment, the lending starting time information is information indicating a time at which the completion of stopping of the vehicle 16 driven by the lender 20 is detected. In the present embodiment, the lending starting time information is not any time for the lender 20 but is set by the processing of the controller 31C described below.

The scheduled standing ending time information is information indicating timing at which the lending out of the vehicle cabin 17 is scheduled to end. The timing at which lending out is scheduled to end is represented by information indicating a time at which lending out is scheduled to end, for example. In the present embodiment, the scheduled standing ending time information is information indicating a scheduled time at which the lender 20 ends the standing of the vehicle 16. The scheduled standing ending time information is set in accordance with an operation instruction on the lender terminal 12 by the lender 20 (the details will be described below). The scheduled standing ending time may be information indicating an elapsed time from a lending starting time and is not limited to the information indicating timing such as a time.

The lending starting time information and the scheduled standing ending time information are updated by the processing of the controller 31C (the details will be described below).

The status is information indicating the reservation state of the vehicle cabin 17 identified by the corresponding vehicle cabin ID as in the first embodiment.

The present embodiment describes a case in which the status is information indicating reserved, in use, unreserved_lendable, and unreserved_standing vehicle. That is to say, the present embodiment describes a case in which unreserved_standing vehicle is used as one status in place of unreserved_non-lendable as an example. As described in the first embodiment, unreserved_lendable is information indicating that the vehicle cabin 17 identified by the corresponding vehicle cabin ID has not been reserved by the user 22 and is lendable. Unreserved_standing vehicle is information indicating that the vehicle cabin 17 identified by the corresponding vehicle cabin ID has not been reserved by the user 22 and that the vehicle 16 of the vehicle cabin 17 is standing.

The following describes the lending request management information 33P. The lending request management information 33P is a database for managing lending request information. The lending request information is information on a lending request for the vehicle cabin 17 by the user 22.

FIG. 24B is a diagram of an example of a data structure of the lending request management information 33P. The lending request management information 33P stores therein the lending request information. The lending request information includes the user information and the use reservation information. The definitions of these pieces of information are the same as those of the first embodiment. The vehicle cabin management information 33N is updated by the processing of the controller 31C (the details will be described below).

Referring back to FIG. 23, the description is continued. The controller 31C includes a receiver 31A, a search unit 31Q, a second registration unit 31V, a first output controller 31W, the selection unit 30E, a second output controller 30F3, the generation unit 30G, the transmitter 30H, the update unit 30I, the lending ending processing unit 30J, a detector 31S, and a registration unit 31T.

The receiver 31A, the search unit 31Q, the second registration unit 31V, the first output controller 31W, the selection unit 30E, the second output controller 30F3, the generation unit 30G, the transmitter 30H, the update unit 30I, the lending ending processing unit 30J, the detector 31S, and the registration unit 31T are implemented by one or more processors, for example. Each of the above units may be implemented by causing a processor such as a CPU to execute a computer program, that is, software, for example. Each of the above units may be implemented by a processor such as a dedicated IC, that is, hardware. Each of the above units may be implemented using software and hardware in combination. When the processors are used, each of the processors may implement one of the units or implement two or more of the units.

The selection unit 30E, the second output controller 30F3, the generation unit 30G, the transmitter 30H, the update unit 30I, and the lending ending processing unit 30J are the same as those of the first embodiment.

The receiver 31A receives various kinds of information from at least one of the lender terminal 12, the user terminal 14, and the vehicle 16 via the communication unit 34 and the network 18 in the same manner as the receiver 30A of the first embodiment.

Specifically, the receiver 31A receives the lender information, the vehicle cabin lending information, the evaluation information, and the like from the lender terminal 12. The receiver 31A receives the user information, the use reservation information, the use request, the evaluation information, and the like from the user terminal 14. The definitions of these pieces of information are the same as those of the first embodiment.

In the present embodiment, the receiver 31A further receives lending permission information from the lender terminal 12. The lending permission information is information indicating that the lending out of the vehicle cabin 17 requested to be used by the user 22 is permitted.

The detector 31S detects the completion of standing of the vehicle 16 driven by the lender 20, who is the owner of the vehicle 16.

The completion of standing means the completion of stopping of the vehicle 16 or the completion of parking of the vehicle 16. The completion of stopping of the vehicle 16 and the completion of parking of the vehicle 16 mean a state in which the positional movement of the vehicle 16 has been stopped for a preset specified time or more and the lender 20, who is the driver of the vehicle 16, is away from the vehicle 16 by a certain distance or more. The specified time and the certain distance may be set in advance.

The detector 31S may analyze the detection result received from the vehicle 16 to detect the completion of standing of the vehicle 16 driven by the lender 20, who is the owner of the vehicle 16.

The detector 31S detects whether the driver of the vehicle 16 is the owner of the vehicle 16 by the following method, for example.

For detection of whether the driver of the vehicle 16 is the owner of the vehicle 16, any known method may be used. The detector 31S receives the detection result including the position information of the vehicle 16 and the vehicle ID of the vehicle 16 from the vehicle 16, for example. The detector 31S receives the position information of the lender terminal 12 from the lender terminal 12. Then the detector 31S determines that the lender 20 of the lender terminal 12 is the driver of the vehicle 16 when the position information included in the detection result received from the vehicle 16 and the position information of the lender terminal 12 are less than a certain distance. The detector 31S determines that the lender 20 is the owner of the vehicle 16 when the vehicle ID corresponding to the lender ID of the lender 20 in the vehicle cabin management information 33N and the vehicle ID included in the received detection result match.

The detector 31S detects whether the distance between the lender 20, who is the driver, and the vehicle 16 has separated from each other by a certain distance or more by the following method.

For detection of whether the distance between the lender 20 and the vehicle 16 has separated from each other by the certain distance or more, any known method may be used. The detector 31S receives the position information of the lender terminal 12 of the lender 20, who has been determined to be the owner of the vehicle 16 by the above method, from the lender terminal 12, for example. The detector 31S receives the detection result including the position information of the vehicle 16 and the vehicle ID of the vehicle 16 from the vehicle 16. Then the detector 31S may detect the completion of standing of the vehicle 16 driven by the lender 20, who is the owner of the vehicle 16, when the position information included in the detection result received from the vehicle 16 and the position information of the lender terminal 12 have separated from each other by a specified distance or more. This specified distance may be set in advance.

The detector 31S may detect the completion of standing of the vehicle 16 driven by the lender 20, who is the owner of the vehicle 16, when the state in which the position information of the vehicle 16 and the position information of the lender terminal 12 has separated from each other by the specified distance or more is maintained for a preset time or more.

The following describes the registration unit 31T. The registration unit 31T executes registration processing such as registration of the lender information in the lender information 32A and registration of the user information in the user information 32B in the same manner as the registration unit 30B of the first embodiment.

In addition, in the present embodiment, the registration unit 31T executes registration processing for the vehicle cabin lending information in the vehicle cabin management information 33N. Specifically, the registration unit 31T receives information indicating the vehicle information, the travelability during the lending period, and the lendability in the standing period in the vehicle cabin lending information from the lender terminal 12 and registers the information in the vehicle cabin management information 33N in the same manner as the first embodiment.

The registration unit 31T has a first registration unit 31U. The first registration unit 31U executes registration processing for the lending starting time information, the scheduled standing ending time information, and the status in the vehicle cabin management information 33N.

When the detector 31S detects the completion of standing of the vehicle 16 driven by the lender 20, who is the owner, the first registration unit 31U registers the vehicle cabin lending information of the vehicle cabin 17 of the vehicle 16 and the lendable information in the vehicle cabin management information 33N, which is the management information 33M, in association with each other.

Specifically, when the detector 31S detects the completion of standing, the first registration unit 31U identifies the vehicle ID of the vehicle 16, which is the transmission source of the detection result used to determine the completion of standing. The vehicle 16 may transmit the detection result and the vehicle ID to the information processing apparatus 10C, for example. The first registration unit 31U may identify the vehicle ID by receiving the vehicle ID together with the detection result from the vehicle 16.

Then the first registration unit 31U registers a time at which the completion of standing is detected in “the lending starting time information” corresponding to the identified vehicle ID in the vehicle cabin management information 33N. In addition, the first registration unit 31U updates “the status” corresponding to the vehicle ID in the vehicle cabin management information 33N to “unreserved_lendable.” With this processing, the first registration unit 31U registers the status indicating “unreserved_lendable,” which is the lendable information, in association with the vehicle cabin lending information of the vehicle cabin 17 of the vehicle 16 for which the completion of standing has been detected in the vehicle cabin management information 33N.

The first registration unit 31U preferably registers the vehicle cabin lending information of the vehicle cabin 17 of the vehicle 16 and the lendable information in the vehicle cabin management information 33N in association with each other when the completion of standing is detected and the scheduled standing ending time information of the vehicle 16 for which the completion of standing has been detected is received.

In this case, upon detection of the completion of standing, the first registration unit 31U transmits a scheduled standing ending time request to the vehicle 16 or the lender terminal 12. The scheduled standing ending time request is a signal requesting the lender 20 to input a scheduled standing ending time.

The first registration unit 31U transmits the scheduled standing ending time request to at least either the vehicle 16, which is the transmission source of the detection result used to determine the completion of standing, or the lender terminal 12 of the lender 20, who has been determined to be the driver of the vehicle 16. The present embodiment describes a form in which the first registration unit 31U transmits the scheduled standing ending time request to the lender terminal 12 as an example.

The lender terminal 12 having received the scheduled standing ending time request displays an input screen for the scheduled standing ending time. The lender 20 operates the lender terminal 12 while referring to the input screen to input a time at which the standing of the vehicle 16 is scheduled to end. The lender terminal 12 transmits the scheduled standing ending time information input by the lender 20 to the information processing apparatus 10C.

When receiving the scheduled standing ending time information from the lender terminal 12 within a certain time from the transmission of the scheduled standing ending time request, the first registration unit 31U registers the scheduled standing ending time information in the vehicle cabin management information 33N. Specifically, the first registration unit 31U registers the scheduled standing ending time information in the vehicle cabin management information 33N in association with the lender ID of the lender 20 of the lender terminal 12, which is the transmission source of the information. In addition, the first registration unit 31U updates the status corresponding to the registered scheduled standing ending time in the vehicle cabin management information 33N to “unreserved_lendable.”

With this processing, the first registration unit 31U registers the status indicating “unreserved_lendable,” which is the lendable information, when the completion of standing of the vehicle 16 driven by the lender 20 has been detected and the scheduled standing ending time information of the vehicle 16 has been registered in the vehicle cabin management information 33N.

Thus, the controller 31C manages the lending and borrowing of the vehicle cabin 17 in accordance with the vehicle cabin management information 33N, whereby the vehicle cabin 17 of the vehicle 16 for which the completion of standing of the vehicle 16 driven by the lender 20 has been detected and the scheduled standing ending time information has been input by the lender 20 becomes to be managed as the vehicle cabin 17 in a lendable state.

On the other hand, the scheduled standing ending time information may have not been received from the lender terminal 12 for the certain time from the transmission of the scheduled standing ending time request or more. In this case, the first registration unit 31U registers the vehicle cabin lending information and standing vehicle information in the vehicle cabin management information 33N in association with each other. Specifically, the first registration unit 31U updates the status corresponding to the lender ID of the lender 20 of the lender terminal 12, which is the transmission destination of the scheduled standing ending time request, to “unreserved_standing vehicle.”

Thus, the controller 31C manages the lending and borrowing of the vehicle cabin 17 in accordance with the vehicle cabin management information 33N, whereby the vehicle cabin 17 of the vehicle 16 for which the completion of standing of the vehicle 16 driven by the lender 20 has been detected and the scheduled standing ending time information has not been input by the lender 20 becomes to be managed simply as “the standing vehicle.”

The following describes the search unit 31Q. The search unit 31Q searches for the vehicle cabin lending information satisfying the use reservation information received from the user terminal 14 in the same manner as the search unit 30C described in the first embodiment. The search unit 31Q searches the vehicle cabin management information 33N in place of the vehicle cabin management information 33I for the vehicle cabin lending information.

In the present embodiment, the search unit 31Q determines whether there is any lendable vehicle cabin 17 using the use reservation information received from the user terminal 14 and the vehicle cabin management information 33N.

The search unit 31Q determines that there is a lendable vehicle cabin when identifying the vehicle cabin lending information the corresponding status of which is “unreserved_lendable” among a plurality of pieces of vehicle cabin lending information registered in the vehicle cabin management information 33N. The search unit 31Q may determine that there is a lendable vehicle cabin 17 when identifying the vehicle cabin lending information the status of which is “unreserved_lendable” and identifying the vehicle cabin lending information satisfying the use reservation information received from the user terminal 14.

Specifically, the search unit 31Q identifies the vehicle cabin lending information the corresponding status of which is “unreserved_lendable” among the pieces of vehicle cabin lending information registered in the vehicle cabin management information 33N. That is to say, the search unit 31Q identifies the vehicle cabin lending information with which “unreserved_lendable,” which is the lendable information, is associated among the pieces of vehicle cabin lending information registered in the vehicle cabin management information 33N. Then the search unit 31Q searches the identified vehicle cabin lending information for the vehicle cabin lending information satisfying the use reservation information received from the user terminal 14 in the same manner as the search unit 30C.

When the search unit 31Q determines that there is a lendable vehicle cabin 17, the first output controller 31W outputs the list information 32X, which is the list of the vehicle cabin lending information searched for by the search unit 31Q, to the output unit 26F of the user terminal 14. That is to say, the first output controller 31W outputs the list information 32X of the vehicle cabin lending information corresponding to the lendable information registered in the vehicle cabin management information 33N to the output unit 26F of the user terminal 14.

In the same manner as the first output controller 30D1 of the first embodiment, the output unit to which the first output controller 31W outputs the list information 32X may be any output mechanism viewable by the user 22 and is not limited to the output unit 26F provided in the user terminal 14. The first output controller 31W may use various kinds of displays connected to the network 18 as the output unit to which the list information 32X is output, for example. Examples of the displays include, but are not limited to, bulletin boards and electronic signs.

On the other hand, when the search unit 31Q determines that there is no lendable vehicle cabin 17, the controller 31C executes the following processing.

Specifically, the search unit 31Q determines that there is no lendable vehicle cabin 17 when receiving the use reservation information from the user terminal 14 when the vehicle cabin lending information the status of which is “unreserved_lendable,” which is the lendable information, is not registered in the vehicle cabin management information 33N. The search unit 31Q may determine that there is no lendable vehicle cabin 17 even when the vehicle cabin lending information the status of which is “unreserved_lendable” is registered in the vehicle cabin management information 33N when the vehicle cabin lending information satisfying the use reservation information received from the user terminal 14 is not registered in the vehicle cabin management information 33N.

In this case, the second registration unit 31V registers the lending request information including the use reservation information received from the user terminal 14 in the lending request management information 33P. Specifically, the second registration unit 31V registers the use reservation information and the user information in the lending request management information 33P in association with each other as the lending request information (refer to FIG. 24B). The second registration unit 31V may search the user information 32B for the user information corresponding to the terminal ID of the user terminal 14, which is the transmission source of the use reservation information, and register the user information in the lending request management information 33P. The terminal ID of the user terminal 14 used by the user 22 may further be registered in the user information 32B in advance in association with the user ID of the user 22.

Thus, the lending request information requesting the use of the vehicle cabin 17 and in which the vehicle cabin lending information of the vehicle cabin 17 lendable to the user 22 has not been registered in the vehicle cabin management information 33N is registered in the lending request management information 33P.

When the vehicle cabin lending information satisfying the use reservation information received from the user terminal 14 cannot be searched for from the vehicle cabin management information 32D as well, the second registration unit 31V may register the lending request information associating the use reservation information and the user information with each other in the lending request management information 33P.

The second registration unit 31V manages the lending request management information 33P so as to be viewable in accordance with a request confirmation request from the lender terminal 12. Upon reception of the request confirmation request from the lender terminal 12, the second registration unit 31V may transmit the lending request management information 33P to the lender terminal 12, for example.

The lender terminal 12 displays the received lending request management information 33P. The lender 20 checks the displayed lending request management information 33P and selects the lending request information of an object to be permitted to be lent out. The lender terminal 12 transmits the lending permission information to the information processing apparatus 10C. The lending permission information is information indicating the lending request information of the object to be permitted to be lent out by the lender 20. The lending permission information includes the lending request information selected as the object to be permitted to be lent out by the lender 20 and information indicating permission of lending, for example.

The receiver 31A receives the lending permission information from the lender terminal 12. When the receiver 31A receives the lending permission information, the first output controller 31W outputs the list information 32X including the vehicle cabin lending information of the vehicle cabin 17 of the vehicle 16 owned by the lender 20 operating the lending terminal 12, which is the transmission source of the lending permission information, to the output unit 26F of the user terminal 14.

Specifically, the first output controller 31W identifies the lender terminal ID of the lender terminal 12, which is the transmission source of the lending permission information. The lender terminal 12 transmits the lender terminal ID and the lending permission information to the information processing apparatus 10C, for example. The first output controller 31W identifies the lender ID corresponding to the lender terminal ID received together with the lending permission information from the lender information 32A. Then the first output controller 31W identifies the vehicle cabin lending information including the identified lender ID from the vehicle cabin management information 33N.

Then the first output controller 31W outputs the list information 32X including the identified vehicle cabin lending information to the output unit 26F of the user terminal 14. In this process, the first output controller 31W outputs the list information 32X to the output unit 26F of the user terminal 14 of the user 22 identified by the user information included in the lending request information of the object to be permitted to be lent out by the lender 20.

With these pieces of processing, the list information 32X including the vehicle cabin lending information of the vehicle cabin 17 permitted to be lent out by the lender 20 among the vehicle cabin lending information associated with the status “unreserved_standing vehicle” in the vehicle cabin management information 33N is transmitted to the user terminal 14 of the user 22 for whom the lending has been permitted.

Assumed is a case in which the vehicle cabin lending information of the vehicle cabin 17 in a lendable state has not been registered in the vehicle cabin management information 33N when the use reservation information is transmitted. Even in this case, when the lender 20 permits lending out for the use reservation information and the user 22, the information processing apparatus 10C can provide the vehicle cabin lending information of the vehicle cabin 17 of the lender 20 to the user 22 as information indicating the lendable vehicle cabin 17.

The following describes an example of a procedure of information processing executed by the information processing system 1C.

The following first describes a procedure of registration processing for the vehicle cabin lending information executed by the information processing system 1C.

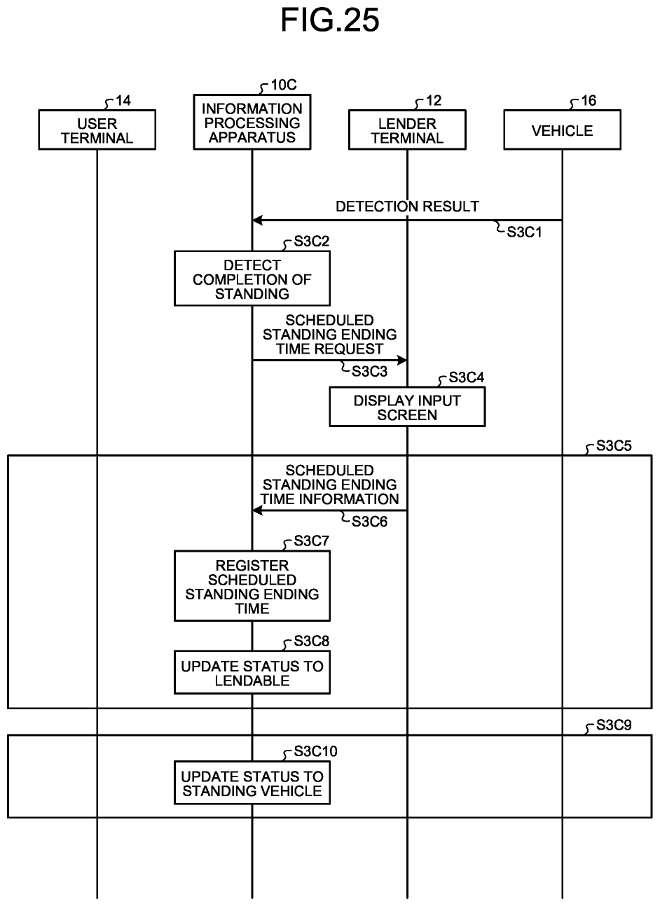

FIG. 25 is a sequence diagram of an example of the procedure of the registration processing for the vehicle cabin lending information executed by the information processing system 1C. The information processing system 1C executes the registration processing for the vehicle cabin lending information in the same manner as the first embodiment (refer to Step S3 in FIG. 9). In the information processing system 1C, the lender 20 operates the lender terminal 12 to input information indicating the vehicle information, the travelability during the lending period, and the lendability in the standing period among the vehicle cabin lending information. In the present embodiment, registration of the lending period information in the vehicle cabin management information 33N is executed by the following processing by the information processing apparatus 10C.

The detector 31S of the information processing apparatus 10C receives the detection result from the vehicle 16 (Step S3C1). Each time the detection result is received, the detector 31S analyzes the received detection result and determines whether the completion of standing of the vehicle 16 driven by the lender 20, who is the owner of the vehicle 16, has been detected. In this section, the description is continued assuming a case in which the completion of stopping has been detected.

When the detector 31S of the information processing apparatus 10C detects the completion of stopping (Step S3C2), the first registration unit 31U of the information processing apparatus 10C transmits the scheduled standing ending time request to the lender terminal 12 (Step S3C3).

The lender terminal 12 having received the scheduled standing ending time request displays the input screen for the scheduled standing ending time (Step S3C4).

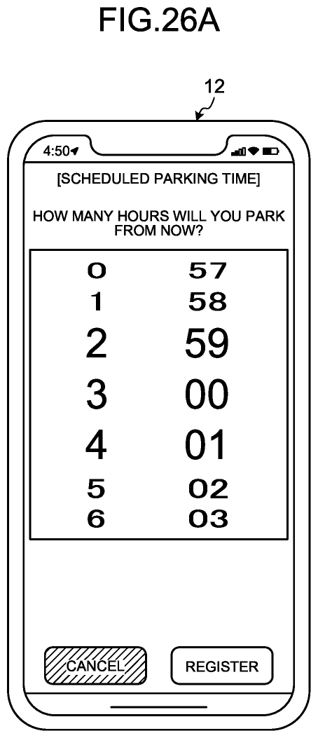

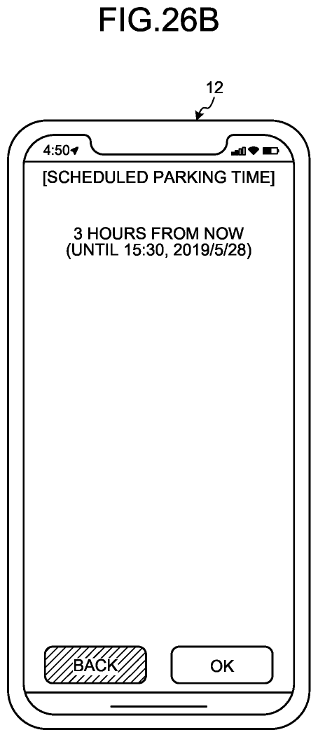

FIG. 26A and FIG. 26B are schematic diagrams of examples of the input screen for the scheduled standing ending time. The lender 20 operates the input screen illustrated in FIG. 26A while referring to it to input the scheduled standing ending time and to indicate the display area of the “REGISTER” button, for example. The scheduled standing ending time may be information indicating an elapsed time from the current timing to the end of standing or information indicating timing such as a time of the end of standing. The lender terminal 12 displays a confirmation screen for the input details illustrated in FIG. 26B, for example. When the display area of the “OK” button is indicated, the lender terminal 12 transmits the input scheduled standing ending time to the information processing apparatus 10C.

Referring back to FIG. 25, the description is continued. The first registration unit 31U of the information processing apparatus 10C executes update processing to be lendable (Step S3C5) when receiving the scheduled standing ending time information from the lender terminal 12 within a certain time after transmitting the scheduled standing ending time request at Step S3C3.

Specifically, the first registration unit 31U of the information processing apparatus 10C receives the scheduled standing ending time information from the lender terminal 12 within the certain time after transmitting the scheduled standing ending time request at Step S3C3 (Step S3C6).

The first registration unit 31U of the information processing apparatus 10C registers the scheduled standing ending time information received at Step S3C6 in the vehicle cabin management information 33N in association with the lender ID of the lender 20 of the lender terminal 12, which is the transmission source of the information (Step S3C7). In addition, the first registration unit 31U updates the status corresponding to the registered scheduled standing ending time in the vehicle cabin management information 33N to “unreserved_lendable” (Step S3C8).

The information processing apparatus 10C executes update processing to the standing vehicle (Step S3C9) when not receiving the scheduled standing ending time information from the lender terminal 12 within the certain time after transmitting the scheduled standing ending time request at Step S3C3.

In this case, the first registration unit 31U of the information processing apparatus 10C updates the status corresponding to the lender ID of the lender 20 of the lender terminal 12, which is the transmission destination of the scheduled standing ending time request to “unreserved_standing vehicle” (Step S3C10).

The following describes a procedure of the use starting processing from when the use reservation information is input from the user terminal 14 to when the use of the vehicle cabin 17 is started.

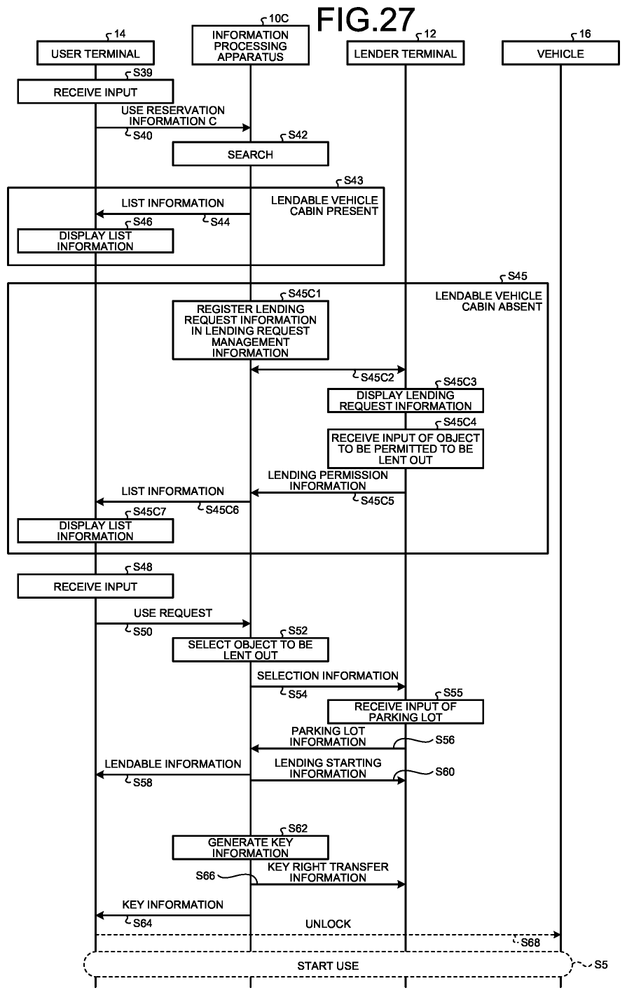

FIG. 27 is a sequence diagram of an example of the procedure of the use starting processing executed by the information processing system 1C.

The user 22 operates the user terminal 14 to input the use reservation information that the user 22 desires to use.

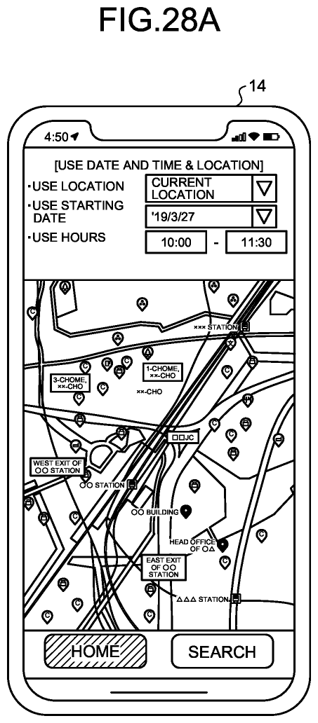

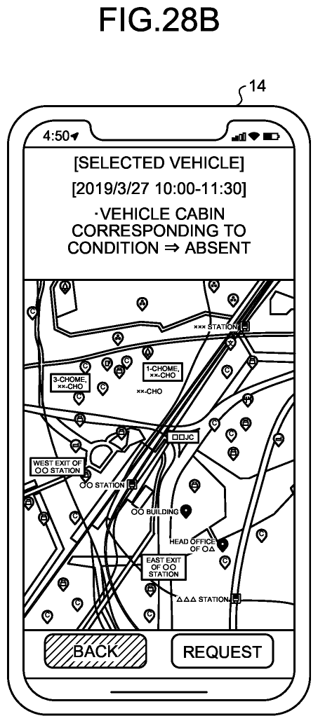

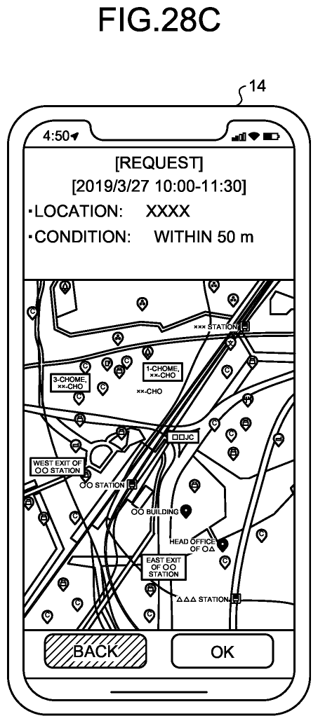

FIG. 28A is a schematic diagram of an example of a display screen displayed on the user terminal 14 at the time of inputting the use reservation information. The user 22 operates the display screen while referring to it to input the use reservation information that the user 22 desires to use.

Referring back to FIG. 27, the description is continued. The user terminal 14 receives input of the use reservation information by the user 22 (Step S39). The user terminal 14 transmits the received use reservation information to the information processing apparatus 10C (Step S40).

The search unit 31Q of the information processing apparatus 10C identifies the vehicle cabin lending information the corresponding status of which is “unreserved_lendable” among the pieces of vehicle cabin lending information registered in the vehicle cabin management information 33N. That is to say, the search unit 31Q identifies the vehicle cabin lending information with which “unreserved_lendable,” which is the lendable information, is associated among the pieces of vehicle cabin lending information registered in the vehicle cabin management information 33N. Then the search unit 31Q searches for the vehicle cabin lending information satisfying the use reservation information received at Step S40 among the identified vehicle cabin lending information (Step S42).

When the search unit 31Q of the information processing apparatus 10C determines that there is a lendable vehicle cabin, the information processing apparatus 10C executes the processing of lendable vehicle cabin present (Step S43). The search unit 31Q of the information processing apparatus 10C determines that there is a lendable vehicle cabin when identifying the vehicle cabin lending information the corresponding status of which is “unreserved_lendable” among a plurality of pieces of vehicle cabin lending information registered in the vehicle cabin management information 33N. In addition, the search unit 31Q may determine that there is a lendable vehicle cabin when identifying the vehicle cabin lending information the status of which is “unreserved_lendable” and identifying the vehicle cabin lending information satisfying the use reservation information received at Step S40.

The processing of lendable vehicle cabin present (Step S43) includes the processing at Step S44 and Step S46. The first output controller 31W of the information processing apparatus 10C outputs the list information 32X, which is the list of the vehicle cabin lending information searched for by the search unit 31Q, to the output unit 26F of the user terminal 14 (Step S44). That is to say, the first output controller 31W outputs the list information 32X of the vehicle cabin lending information corresponding to the lendable information registered in the vehicle cabin management information 33N to the output unit 26F of the user terminal 14. The user terminal 14 outputs the list information 32X received at Step S44 to the output unit 26F of the user terminal 14 (Step S46).

On the other hand, when the search unit 31Q of the information processing apparatus 10C determines that there is no lendable vehicle cabin, the information processing apparatus 10C executes the processing of lendable vehicle cabin absent (Step S45).

The information processing apparatus 10C may execute the processing of lendable vehicle cabin absent (Step S45) when determining that there is no lendable vehicle cabin and receiving a request from the user terminal 14, for example. In this case, the search unit 31Q of the information processing apparatus 10C transmits information indicating that there is no lendable vehicle cabin to the user terminal 14, for example. The user terminal 14 displays the information indicating that there is no lendable vehicle cabin.

FIG. 28B is a schematic diagram of an example of the display screen including the information indicating that there is no lendable vehicle cabin. The display screen illustrated in FIG. 28B is displayed on the user terminal 14, for example. It is assumed that the display area of the “REQUEST” button image to instruct transmission of the request to the information processing apparatus 10C has been selected through an operation instruction by the user 22. The user 22 may modify at least part of the use reservation information input at Step S39. In this case, the user terminal 14 displays the display screen indicating the modified use reservation information illustrated in FIG. 28C, for example. Then the user terminal 14 transmits the request to the information processing apparatus 10C when the display area of the “OK” button image to instruct transmission of the request is selected by the user 22. In this process, the user terminal 14 may transmit the request including the modified use reservation information to the information processing apparatus 10C.

Referring back to FIG. 27, the description is continued. Then upon reception of the request from the user terminal 14, the information processing apparatus 10C executes the processing of lendable vehicle cabin absent (Step S45), for example.

The processing of lendable vehicle cabin absent (Step S45) includes the processing at Step S45C1 to Step S45C7.

The second registration unit 31V of the information processing apparatus 10C registers the lending request information including the use reservation information received from the user terminal 14 at Step S40 in the lending request management information 33P (Step S45C1). In this process, when the request includes the modified use reservation information, the second registration unit 31V may register the lending request information including the use reservation information in the lending request management information 33P.

The lender 20 operates the lender terminal 12 to input a request to view the lending request management information 33P at any timing.

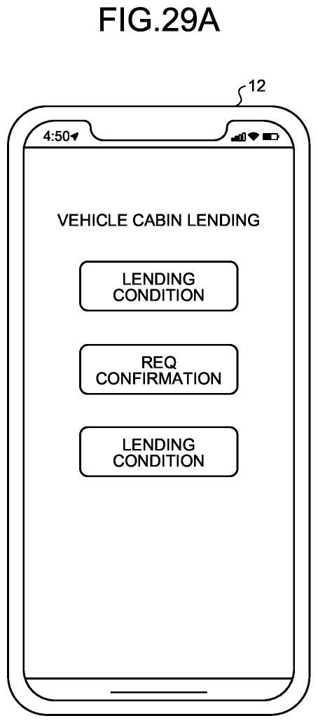

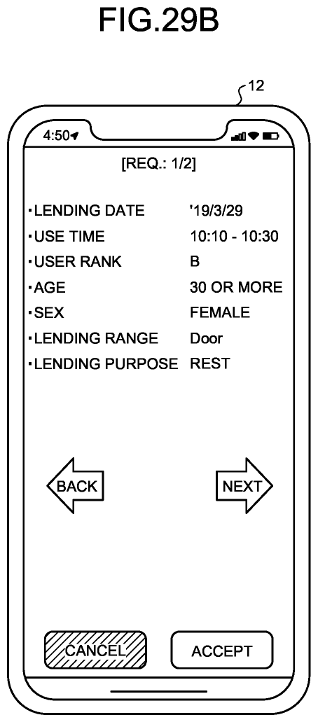

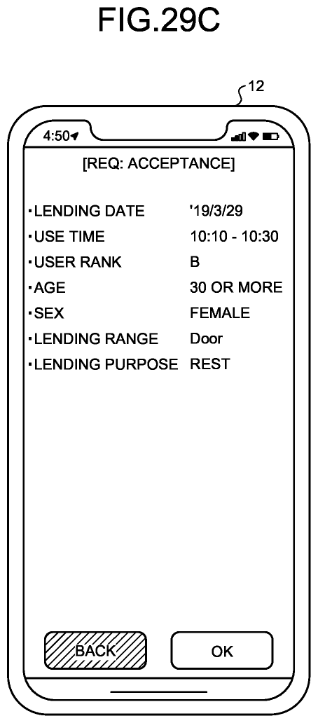

FIG. 29A is a schematic diagram of an example of the display screen displayed on the lender terminal 12. Assumed is a case in which the lender 20 has indicated the display area of the “REQ CONFIRMATION” button image to instruct the request to view the lending request management information 33P, for example. The lender terminal 12 then transmits the request confirmation request to the information processing apparatus 10C.

Referring back to FIG. 27, the description is continued. The second registration unit 31V of the information processing apparatus 10C having received the request confirmation request transmits the lending request management information 33P to the lender terminal 12 (Step S45C2).

The lender terminal 12 displays the received lending request management information 33P (Step S45C3). FIG. 29B and FIG. 29C are schematic diagrams of examples of a display screen for the lending request management information 33P displayed on the lender terminal 12. The lender 20 checks the displayed lending request management information 33P and selects the lending request information of the object to be permitted to be lent out. When agreeing to the use condition information displayed on the display screen illustrated in FIG. 29B, the lender 20 indicates the display area of the “ACCEPT” button image, for example. Then the lender 20 indicates the display area of the “OK” button image indicating an instruction to transmit the lending permission information to the information processing apparatus 10C illustrated in FIG. 29C.

Referring back to FIG. 27, the description is continued. With these pieces of processing, the lender terminal 12 receives input of the object to be permitted to be lent out by the lender 20 (Step S45C4). The lender terminal 12 transmits the lending permission information of the object to be permitted to be lent out by the lender 20 to the information processing apparatus 10C (Step S45C5).

The receiver 31A of the information processing apparatus 10C receives the lending permission information from the lender terminal 12. The first output controller 31W of the information processing apparatus 10C reads the vehicle cabin lending information of the vehicle cabin 17 of the vehicle 16 owned by the lender 20 of the lender terminal 12, which is the transmission source of the lending permission information, from the vehicle cabin management information 33N. Then the first output controller 31W outputs the list information 32X including the read vehicle cabin lending information to the output unit 26F of the user terminal 14 (Step S45C6).

The user terminal 14 displays the list information 32X received from the information processing apparatus 10C (Step S45C7).

The processing at Step S48 to Step S68 is the same as that of the first embodiment, and a description thereof is omitted (refer to FIG. 10).

The following describes an example of a procedure of registration processing for the vehicle cabin management information 33N executed by the information processing apparatus 10C.

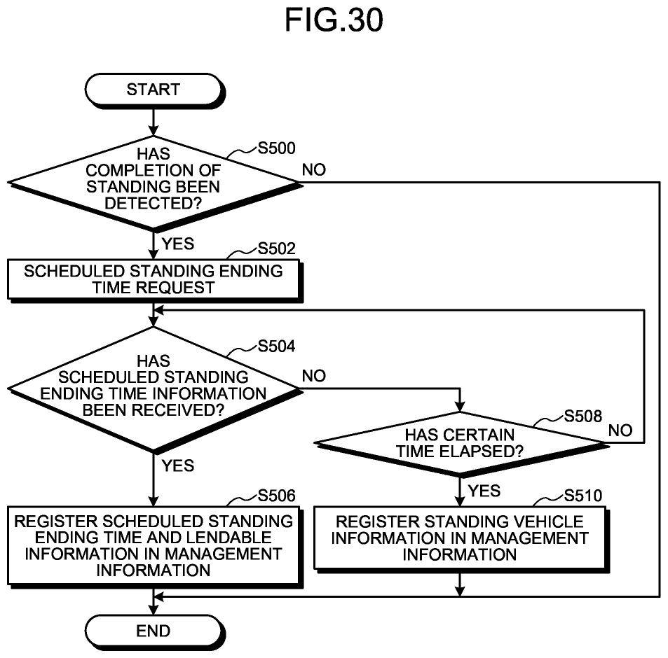

FIG. 30 is a flowchart of an example of the procedure of the registration processing for the vehicle cabin management information 33N executed by the information processing apparatus 10C.

The detector 31S determines whether the completion of standing of the vehicle 16 has been detected (Step S500). The detector 31S uses the detection result received from the vehicle 16 to determine whether the vehicle 16 has completed standing.

If the completion of standing has been detected (Yes at Step S500), the first registration unit 31U transmits the scheduled standing ending time request to the lender terminal 12 of the lender 20, who is the driver of the vehicle 16 and the owner of the vehicle 16 (Step S502).

Next, the first registration unit 31U determines whether the scheduled standing ending time information has been received from the lender terminal 12 (Step S504). If an affirmative determination is made at Step S504 (Yes at Step S504), the process advances to Step S506.

At Step S506, the first registration unit 31U registers the scheduled standing ending time information received at Step S504 and the lendable information in the vehicle cabin management information 33N in association with each other (Step S506). That is to say, the first registration unit 31U registers the scheduled standing ending time information received at Step S504 in the vehicle cabin management information 33N in association with the lender ID of the lender 20 of the lender terminal 12, which is the transmission source of the information. In addition, the first registration unit 31U updates the status corresponding to the registered scheduled standing ending time in the vehicle cabin management information 33N to “unreserved_lendable.” Then the present routine ends.

On the other hand, if a negative determination is made at Step S504 (No at Step S504), the process advances to Step S508. At Step S508, the first registration unit 31U determines whether a certain time has elapsed after transmitting the scheduled standing ending time request at Step S502 (Step S508). If a negative determination is made at Step S508 (No at Step S508), the process returns to Step S504.

On the other hand, if an affirmative determination is made at Step S508 (Yes at Step S508), the process advances to Step S510. At Step S510, the status corresponding to the lender ID of the lender 20 of the lender terminal 12, which is the transmission destination of the scheduled standing ending time request, is updated to “unreserved_standing vehicle” (Step S510). Then the present routine ends.

The following describes an example of a procedure of the use starting processing executed by the information processing apparatus 10C.

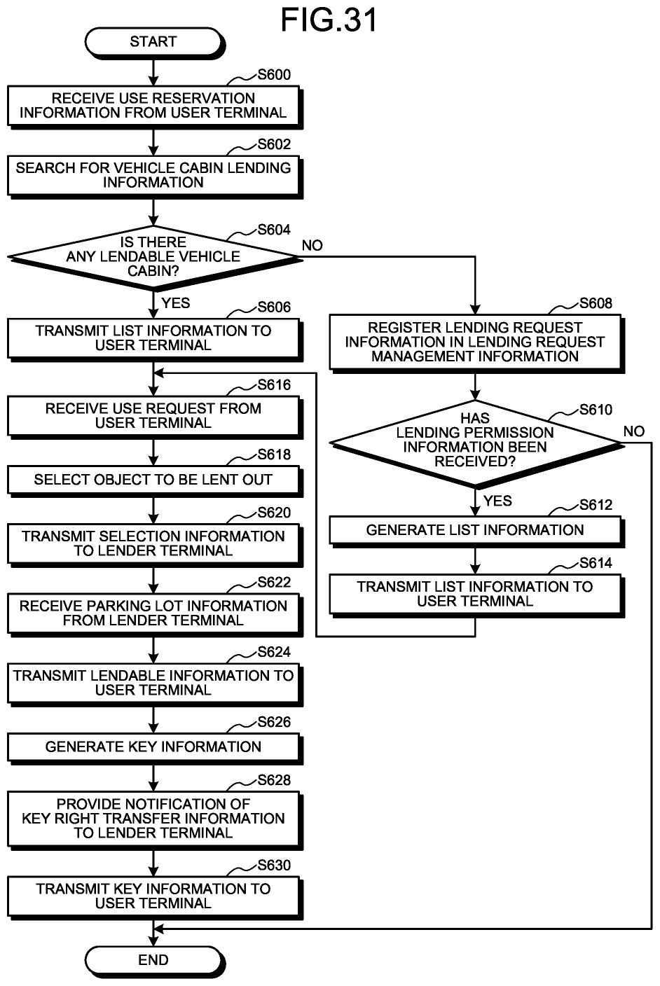

FIG. 31 is a flowchart of an example of the procedure of the use starting processing executed by the information processing apparatus 10C.

The receiver 31A receives the user reservation information from the user terminal 14 (Step S600). The search unit 31Q uses the user reservation information received at Step S600 and the vehicle cabin management information 33N to search for the vehicle cabin lending information of the lendable vehicle cabin 17 (Step S602).

The search unit 31Q identifies the vehicle cabin lending information the corresponding status of which is “unreserved_lendable” among the pieces of vehicle cabin lending information registered in the vehicle cabin management information 33N. Then the search unit 31Q searches for the vehicle cabin lending information satisfying the use reservation information received at Step S600 among the identified vehicle cabin lending information.

Based on the search result at Step S602, the search unit 31Q determines whether there is any lendable vehicle cabin (Step S604). The search unit 31Q determines that there is a lendable vehicle cabin when identifying the vehicle cabin lending information the corresponding status of which is “unreserved_lendable” among a plurality of pieces of vehicle cabin lending information registered in the vehicle cabin management information 33N. In addition, the search unit 31Q may determine that there is a lendable vehicle cabin when identifying the vehicle cabin lending information the status of which is “unreserved_lendable” and identifying the vehicle cabin lending information satisfying the use reservation information received at Step S600.

If an affirmative determination is made at Step S604, the first output controller 31W transmits the list information 32X, which is the list of the vehicle cabin lending information searched for by the search unit 31Q, to the user terminal 14 (Step S606).

Then the controller 31C executes the processing at step S616 to Step S630 in the same manner as Step S206 to Step S220 of the first embodiment.

That is to say, the receiver 31A receives the use request including the vehicle cabin lending information and the request signal requesting the use of the vehicle cabin 17 from the user terminal 14 (Step S616). The selection unit 30E selects the vehicle cabin lending information included in the use request received at Step S616 as the vehicle cabin lending information of the vehicle cabin 17 to be lent out (Step S618).

The selection unit 30E transmits the selection information including the vehicle cabin lending information of the vehicle cabin 17 selected at Step S618 and the input instruction signal of the parking lot information to the lender terminal 12 of the lender 20 identified by the lender ID included in the vehicle cabin lending information (Step S620).

The receiver 30A receives the parking lot information from the lender terminal 12 (Step S622).

The second output controller 30F3 transmits the lendable information including the parking lot information received at Step S622 and indicating that the vehicle cabin 17 selected by the selection unit 30E at Step S618 is lendable to the user terminal 14 (Step S624).

Next, the generation unit 30G generates the key information (Step S626). Then the transmitter 30H transmits the transfer information indicating that the key right has been transferred to the user 22 to the lender terminal 12 (Step S628). The transmitter 30H also transmits the key information generated at Step S626 to the user terminal 14, to which the lendable information has been transmitted at Step S624 (Step S630). Then the present routine ends.

On the other hand, if a negative determination is made at Step S604 (No at Step S604), the process advances to Step S608.

At Step S608, the second registration unit 31V registers the lending request information including the use reservation information received from the user terminal 14 at Step S600 in the lending request management information 33P (Step S608). When the use reservation information modified by the user 22 has been received from the user terminal 14, the second registration unit 31V registers the lending request information including the use reservation information in the lending request management information 33P.

Next, the second registration unit 31V determines whether the lending permission information has been received from the lender terminal 12 (Step S610). If a negative determination is made at Step S610 (No at Step S610), the present routine ends. On the other hand, if an affirmative determination is made at Step S610 (Yes at Step S610), the process advances to Step S612.

At Step S612, the first output controller 31W reads the vehicle cabin lending information of the vehicle cabin 17 of the vehicle 16 owned by the lender 20 of the lender terminal 12, which is the transmission source of the lending permission information received at Step S610, from the vehicle cabin management information 33N. Then the first output controller 31W generates the list information 32X including the read vehicle cabin lending information (Step S612). Then the first output controller 31W transmits the generated list information 32X to the user terminal 14 (Step S614), and the process advances to Step S616.

As described above, the information processing apparatus 10C of the present embodiment is an information processing apparatus in the system lending out the vehicle cabin 17 of the vehicle 16. The information processing apparatus 10C includes the detector 31S, the first registration unit 31U, and the first output controller 31W. The detector 31S detects the completion of standing of the vehicle 16 driven by the lender 20, who is the owner of the vehicle 16. When the completion of standing of the vehicle 16 is detected, the first registration unit 31U registers the vehicle cabin lending information of the vehicle cabin 17 of the vehicle 16 and “unreserved_lendable,” which is the lendable information, in the vehicle cabin management information 33N in association with each other. The first output controller 31W outputs the list information 32X of the vehicle cabin lending information corresponding to the lendable information registered in the vehicle cabin management information 33N.

Thus, the information processing apparatus 10C of the present embodiment, when detecting the completion of standing of the vehicle 16 driven by the owner, manages the vehicle cabin 17 of the vehicle 16 as the lendable vehicle cabin 17. Thus, the information processing apparatus 10C of the present embodiment can easily manage the vehicle cabin 17 of the vehicle 16 for which the completion of standing has been detected as the lendable vehicle cabin 17.

Consequently, the information processing apparatus 10C of the present embodiment can achieve effective sharing of the mobile object not in a moving state.

In addition, in the information processing apparatus 10C of the present embodiment, when the completion of standing is detected and the scheduled standing ending time information of the vehicle 16 for which the completion of standing has been detected is received, the first registration unit 31U registers the vehicle cabin lending information including the scheduled standing ending time information, the scheduled standing ending time information, and the lendable information in the vehicle cabin management information 33N in association with each other.

That is to say, the information processing apparatus 10C of the present embodiment detects the completion of standing of the vehicle 16 and receives the scheduled standing ending time information of the vehicle 16 to manage the vehicle cabin 17 of the vehicle 16 as the lendable vehicle cabin 17. Thus, the information processing apparatus 10C of the present embodiment can reduce the number of false settings of the lending period. In addition, the information processing apparatus 10C of the present embodiment can inhibit the lending opportunities of the vehicle cabin 17 from being reduced and can achieve effective sharing of the vehicle cabin 17 not in a moving state.

### Fourth Embodiment

The present embodiment describes a form in which the lender 20 can set an energy amount scheduled to be used after the vehicle 16 is returned before lending out the vehicle 16.

In the present embodiment, the same functions and components as those of the first embodiment, the second embodiment, or the third embodiment are given the same symbols, and a detailed description is omitted. In the sequence diagrams and the flowcharts used in the present embodiment, the same processing parts as those of the first embodiment, the second embodiment, or the third embodiment are given the same step numbers, and a detailed description is omitted.

As illustrated in FIG. 1A, an information processing system 1D of the present embodiment is the same as the information processing system 1 of the first embodiment except that it includes an information processing apparatus 10D in place of the information processing apparatus 10 (refer to FIG. 1). The hardware configuration of the information processing apparatus 10D is the same as that of the information processing apparatus 10 (refer to FIG. 2).

The information processing apparatus 10D manages the vehicle cabin 17 of the vehicle 16 as the object to be lent out in the same manner as the information processing apparatus 10 of the first embodiment.

The following describes a case in which the information processing apparatus 10D is P2P sharing as an example, which manages lending and borrowing of the vehicle cabin 17 between the lender 20, who is the owner of the vehicle 16, and the user 22 of the vehicle cabin 17 of the vehicle 16 in the same manner as the information processing apparatus 10 and the information processing system 1 of the first embodiment.

The following describes a functional configuration of the information processing apparatus 10D.

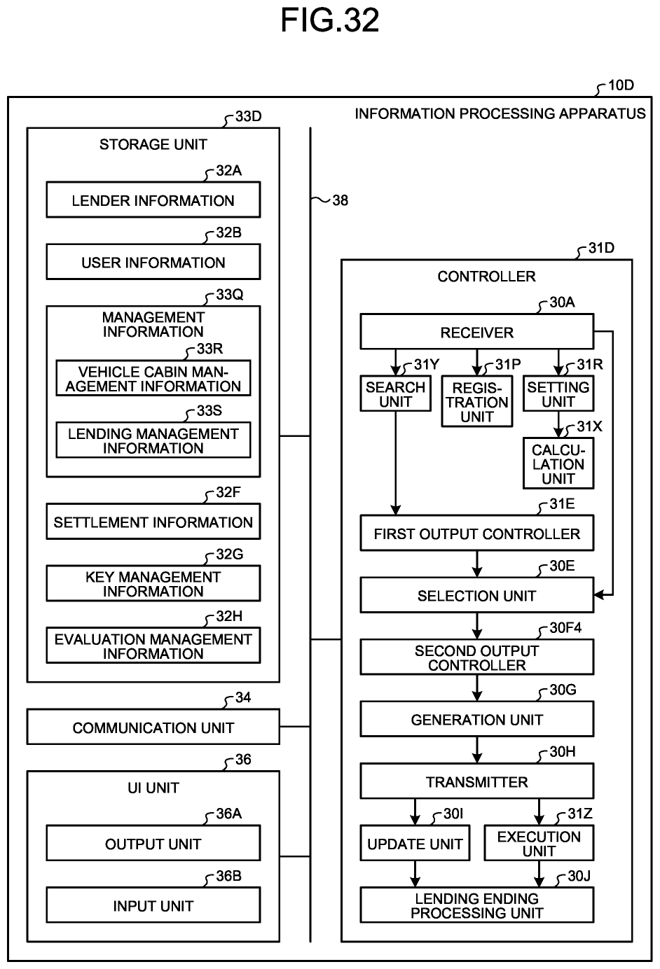

FIG. 32 is a block diagram of an example of the functional configuration of the information processing apparatus 10D.

The information processing apparatus 10D includes a controller 31D, a storage unit 33D, the communication unit 34, and the UI unit 36. The controller 31D, the storage unit 33D, the communication unit 34, and the UI unit 36 are connected to each other in such a manner that data or signals can be exchanged via the bus 38. The communication unit 34 and the UI unit 36 are the same as those of the first embodiment.

The storage unit 33D stores therein data. The storage unit 33D is a semiconductor memory element such as a RAM or a flash memory, a hard disk, or an optical disc, for example. The storage unit 33D may be a storage apparatus provided outside the information processing apparatus 10D. The storage unit 33D may be a storage medium. The storage unit 33D may include a plurality of storage media.

In the present embodiment, the storage unit 33D stores therein the lender information 32A, the user information 32B, management information 33Q, the settlement information 32F, the key management information 32G, and the evaluation management information 32H. The lender information 32A, the user information 32B, the settlement information 32F, the key management information 32G, and the evaluation management information 32H are the same as those of the first embodiment.

The management information 33Q is a database for managing the vehicle cabin 17 of the vehicle 16 as the object to be lent out. The information processing apparatus 10D manages the management information 33Q to manage the vehicle cabin 17 as the object to be lent out.

In the present embodiment, the management information 33Q includes vehicle cabin management information 33R and lending management information 33S. The vehicle cabin management information 33R and the lending management information 33S may be configured in a single database.

The vehicle cabin management information 33R is a database for managing the vehicle cabin 17.

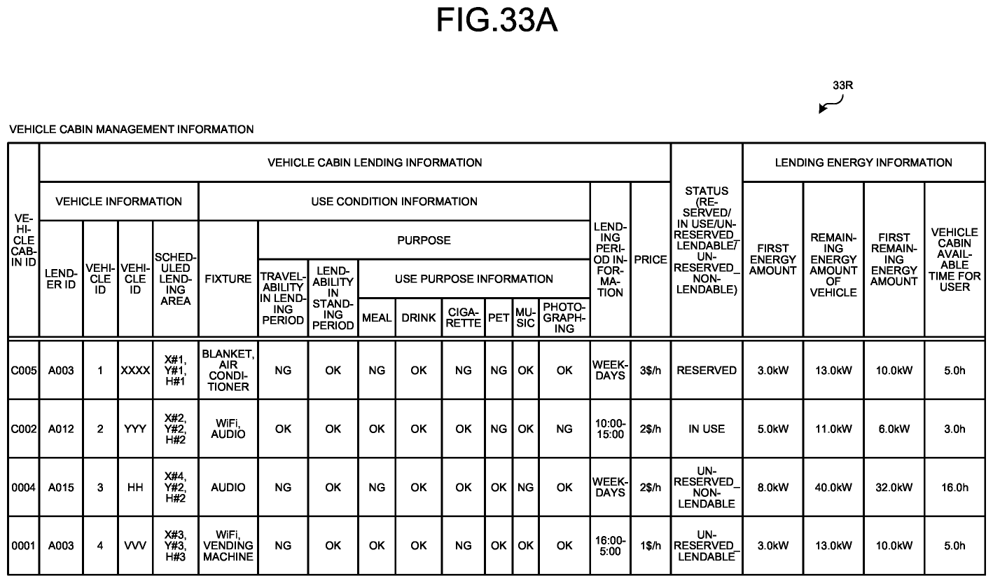

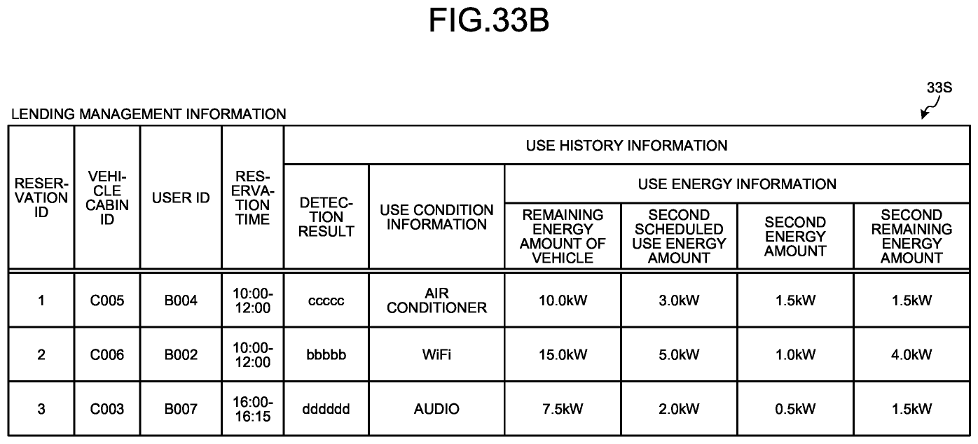

FIG. 33A is a diagram of an example of a data structure of the vehicle cabin management information 33R. The vehicle cabin management information 33R is a database associating the vehicle cabin ID, the vehicle cabin lending information, the status, and lending energy information with each other.

The vehicle cabin lending information and the status in the vehicle cabin management information 33R are the same as the vehicle cabin lending information and the status, respectively, of the vehicle cabin management information 33I in the second embodiment (refer to FIG. 14A).

The lending energy information is information on the energy amount of the vehicle 16 at timing before the vehicle cabin 17 of the vehicle 16 is lent out to the user 22.

The energy amount means the physical amount of energy used to drive the vehicle 16 and the equipment provided in the vehicle 16. Specifically, the energy amount is the use amount of a power source of the vehicle 16. When the power source of the vehicle 16 is gasoline, for example, the energy amount is represented in terms of the amount of gasoline or the amount of electricity obtained by converting gasoline consumption into a physical amount such as electric energy. When the power source of the vehicle 16 is electricity, for example, the energy amount is represented in terms of the amount of electric energy.

In the present embodiment, the lending energy information includes a first energy amount, the remaining energy amount of the vehicle 16, a first remaining energy amount, and vehicle cabin available time for the user.

The first energy amount is the amount of energy scheduled to be consumed by using the vehicle 16 by the lender 20 after the vehicle 16 lent out to the user 22 is returned to the lender 20, who is the owner of the vehicle 16. The first energy amount is set in accordance with an operation instruction by the lender 20. The details of the setting of the first energy amount will be described below.

The remaining energy amount of the vehicle 16 is the current remaining energy amount in the vehicle 16.

The first remaining energy amount is an energy amount obtained by subtracting the first energy amount from the current remaining energy amount of the vehicle 16. In other words, the first remaining energy amount is an energy amount that the user 22 using the vehicle cabin 17 of the vehicle 16 can use when using the vehicle cabin 17. The first remaining energy amount matches a value obtained by subtracting the first energy amount from the current remaining energy amount of the vehicle 16.

The vehicle cabin available time for the user 22 is a time during which the user 22 can use the vehicle cabin 17. In other words, the vehicle cabin available time for the user 22 is information to be supplied to the user 22 when the vehicle 16 is lent out. The vehicle cabin available time for the user 22 is calculated by the control of the controller 31D described below in accordance with the first energy amount and is registered in the vehicle cabin management information 33R.

The following describes a data structure of the lending management information 33S.

FIG. 33B is a diagram of an example of the data structure of the lending management information 33S.

The lending management information 33S is a database for managing the use state of the vehicle cabin 17. The lending management information 33S is a database associating the reservation ID, the vehicle cabin ID, the user ID, the reservation time, and the use history information with each other, for example.

The definitions of the reservation ID, the vehicle cabin ID, the user ID, and the reservation time are the same as those of the first embodiment.

The use history information is information indicating the history of the actual use state of the vehicle cabin 17 as in the first embodiment or the second embodiment. In the present embodiment, the use history information includes the detection result received from the vehicle 16, the use condition information, and use energy information.

The detection result is the detection result of the use state of the vehicle 16 as described in the first embodiment. In the present embodiment, it is assumed that the detection result includes at least the remaining energy amount of the vehicle 16 and the current use energy amount per unit time of the vehicle 16. The use energy amount per unit time corresponds to a consumption energy amount per unit time in the vehicle 16.

The use condition information included in the use history information of the lending management information 33S is information on the condition when using the vehicle cabin 17 and is information including the fixture and the purpose, for example, as in the second embodiment. Information indicating at least either the fixture or the purpose used when the user 22 uses the vehicle cabin 17 is registered in the lending management information 33S.

The use energy information is information on the energy amount of the vehicle 16 in the use period during which the user 22 uses the vehicle 16. The use energy information includes the remaining energy amount of the vehicle 16, a second scheduled use energy amount, a second energy amount, and a second remaining energy amount.

The remaining energy amount of the vehicle 16 included in the use energy information is the actual remaining energy amount of the vehicle 16 in the use period during which the user 22 uses the vehicle 16. The second scheduled use energy amount is an energy amount scheduled to be used by the user 22 during the use period. The second energy amount is an integrated value of an energy amount used by the user 22 in the use period. The second remaining energy amount is a remaining energy amount that the user 22 can use during the use period. The second remaining energy amount corresponds to a value after subtracting the second energy amount from the second scheduled use energy amount.

The use history information in the lending management information 33S is updated by the processing of the controller 31D.

Referring back to FIG. 32, the description is continued. The controller 31D includes the receiver 30A, the registration unit 31P, a calculation unit 31X, a search unit 31Y, a first output controller 31E, the selection unit 30E, a second output controller 30F4, the generation unit 30G, the transmitter 30H, the update unit 30I, the lending ending processing unit 30J, a setting unit 31R, and an execution unit 31Z.

The receiver 30A, the registration unit 31P, the calculation unit 31X, the search unit 31Y, the first output controller 31E, the selection unit 30E, the second output controller 30F4, the generation unit 30G, the transmitter 30H, the update unit 30I, the lending ending processing unit 30J, the setting unit 31R, and the execution unit 31Z are implemented by one or more processors, for example. Each of the above units may be implemented by causing a processor such as a CPU to execute a computer program, that is, software, for example. Each of the above units may be implemented by a processor such as a dedicated IC, that is, hardware. Each of the above units may be implemented using software and hardware in combination. When the processors are used, each of the processors may implement one of the units or implement two or more of the units.

The receiver 30A, the selection unit 30E, the second output controller 30F4, the generation unit 30G, the transmitter 30H, the update unit 30I, and the lending ending processing unit 30J are the same as those of the first embodiment.

The registration unit 31P is the same as that of the second embodiment. That is to say, in the present embodiment, the registration unit 31P executes registration processing such as registration of the lender information in the lender information 32A, registration of the user information in the user information 32B, and registration of the vehicle cabin lending information in the vehicle cabin management information 33R in the same manner as the registration unit 30B of the first embodiment. In addition, as described in the second embodiment, the registration unit 31P registers the use condition information permitted to be used by the lender 20 in the vehicle cabin management information 33R. These pieces of registration processing are described in the first embodiment and the second embodiment, and detailed descriptions thereof are omitted.

The setting unit 31R sets the first energy amount. The setting unit 31R sets the first energy amount using calculation source information input through an operation instruction by the lender 20. Specifically, the setting unit 31R sets the first energy amount using the calculation source information received by the receiver 30A from the lender terminal 12 of the lender 20.

The calculation source information is information for use in calculation or identification of the first energy amount. The calculation source information is at least one of a specified value ID, the value of the first energy amount, information on a scheduled travel route of the vehicle 16 by the lender 20, and a request to acquire a use tendency input screen, for example.

The specified value ID is identification information to identify the value of the first energy amount registered in advance.

The information on the scheduled travel route of the vehicle 16 by the lender 20 is source information for use in calculation of the scheduled travel route or information indicating the scheduled travel route.

The source information for use in calculation of the scheduled travel route includes the position information of the vehicle 16 at the time of return and destination information, for example. The position information of the vehicle 16 at the time of return is information on a travel starting position when the vehicle 16 is caused to travel by driving by the lender 20 after the vehicle 16 is returned from the user 22. The destination information is information indicating a location to be destined when the vehicle 16 is caused to travel by driving by the lender 20 after the vehicle 16 is returned from the user 22. The present embodiment describes a form in which the information on the scheduled travel route of the vehicle 16 by the lender 20 includes the position information of the vehicle 16 at the time of return and the destination information as an example.

The request to acquire the use tendency input screen is a signal requesting that the use tendency input screen be transmitted to the lender terminal 12. The use tendency input screen is a screen displayed on the lender terminal 12 when receiving input of the first energy amount corresponding to the use tendency of the lender 20. The use tendency of the lender 20 is the energy consumption tendency of the vehicle 16 when the vehicle 16 is caused to travel by driving by the lender 20.

The lender 20 operates the lender terminal 12 to select any of the specified value ID, the value of the first energy amount, the information on the scheduled travel route of the vehicle 16 by the lender 20, and the request to acquire the use tendency input screen as the calculation source information.

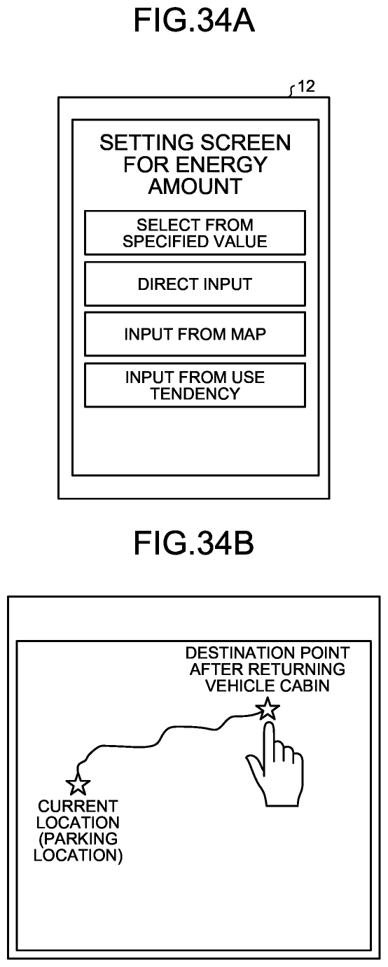

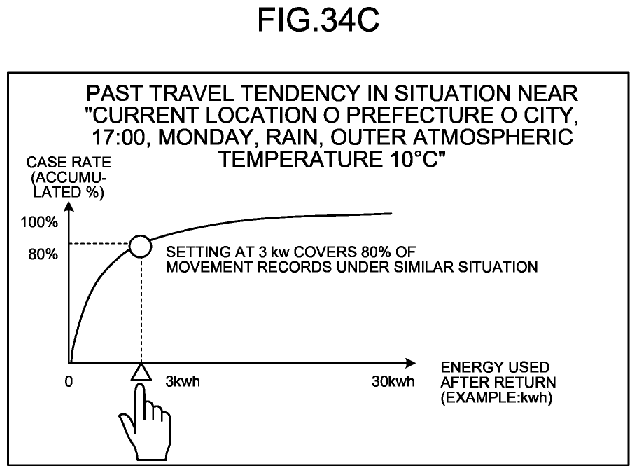

FIG. 34A to FIG. 34C are schematic diagrams of examples of the display screen displayed on the lender terminal 12.

The lender terminal 12 displays the display screen illustrated in FIG. 34A, for example. Assumed is a case in which the lender 20 refers to the display screen and has indicated the display area of the “SELECT FROM SPECIFIED VALUE” button. In this case, the lender terminal 12 displays a list of the first energy amount stored in the storage unit 33D. Upon selection of any one first energy amount through an operation instruction by the lender 20, the lender terminal 12 transmits the specified value ID of the selected first energy amount to the information processing apparatus 10D.

Also assumed is a case in which the lender 20 has indicated the display area of “DIRECT INPUT” of the display screen illustrated in FIG. 34A. In this case, the lender terminal 12 transmits the first energy amount input through an operation instruction by the lender 20 to the information processing apparatus 10D.

Also assumed is a case in which the lender 20 has indicated the display area of “INPUT FROM MAP” of the display screen illustrated in FIG. 34A. In this case, the lender terminal 12 displays a display screen for receiving input of the position information of the vehicle 16 at the time of return and the destination information as illustrated in FIG. 34B, for example. The display screen is a screen containing a map image, for example. The lender 20 instruction-inputs the position of the vehicle 16 at the time of return and a destination while referring to the display screen to input the position information at the time of return and the destination information. The lender terminal 12 transmits the position information of the vehicle 16 at the time of return and the destination information having been input to the information processing apparatus 10D.

Assumed is a case in which the lender 20 has indicated the display area of “INPUT FROM USE TENDENCY” of the display screen illustrated in FIG. 34A. In this case, the lender terminal 12 transmits the request to acquire the use tendency input screen to the information processing apparatus 10D.

Referring back to FIG. 32, the description is continued. The setting unit 31R of the information processing apparatus 10D sets the first energy amount using the calculation source information received by the receiver 30A from the lender terminal 12 of the lender 20.

Assumed is a case in which the calculation source information received from the lender terminal 12 is the specified value ID. In this case, the setting unit 31R reads the first energy amount corresponding to the specified value ID from the storage unit 33C to identify the first energy amount. Then the setting unit 31R sets the identified first energy amount. Setting the first energy amount means that the first energy amount is registered in the vehicle cabin management information 33R in association with the vehicle cabin ID of the vehicle 16.

Assumed is a case in which the calculation source information received from the lender terminal 12 is the value of the first energy amount. In this case, the setting unit 31R identifies the first energy amount. Then the setting unit 31R sets the identified first energy amount.

Assumed is a case in which the calculation source information received from the lender terminal 12 is the position information of the vehicle 16 at the time of return and the destination information. In this case, the setting unit 31R calculates a recommended route from a position on the real space identified by the position information to a position on the real space identified by the destination information. For calculation of the recommended route, any known method may be used.

Then the setting unit 31R identifies an energy amount consumed by the vehicle 16 when traveling along the recommended route as the first energy amount. The recommended route and the energy amount are registered in the storage unit 33C in association with each other in advance, for example. The setting unit 31R may identify the first energy amount by reading the energy amount corresponding to the calculated recommended route from the storage unit 33C. The lender 20 may input adjustment information indicating a rate by which the first energy amount to be calculated is added or subtracted at the time of inputting the destination information. In this case, the setting unit 31R may identify a value obtained by adding or subtracting the rate indicated in the adjustment information to or from the energy amount read from the storage unit 33C as the first energy amount.

Assumed is a case in which the calculation source information received from the lender terminal 12 indicates the request to acquire the use tendency input screen. In this case, the setting unit 31R generates an input screen for the use tendency information.

The setting unit 31R calculates the distribution of the past use tendency of the lender 20, for example. For calculation of the distribution of the past use tendency of the lender 20, information indicating the past energy use history of the lender 20 may be used. The information indicating the past energy use history of the lender 20 is information associating environmental information such as a use location, a use time, weather, and a travel distance and the past use energy amount per unit time of the lender 20 with each other, for example. The information indicating the past energy use history of the lender 20 may be stored in the storage unit 33C in advance, for example.

The setting unit 31R also calculates the distribution of the past use tendency of other users other than the lender 20. For calculation of the distribution of the past use tendency of the other users, information indicating the past energy use history of each of another or other users may be used. The information indicating the past energy use history of each of the other user(s) is information associating environmental information such as a use location, a use time, weather, and a travel distance and the past use energy amount per unit time of the other users with each other, for example. The information indicating the past energy use history of each of the other users may be stored in the storage unit 33C in advance, for example. The information indicating the past energy use history of each of the other users may be received from another server apparatus or the like via the network 18.

Then the setting unit 31R generates the use tendency input screen indicating correspondence between the environmental information and the first energy amount using at least either the distribution of the past use tendency of the lender 20 or the distribution of the past use tendency of the other users other than the lender 20. Then the setting unit 31R transmits the use tendency input screen to the lender terminal 12. The lender terminal 12 displays the received use tendency input screen.

FIG. 34C is a schematic diagram of an example of the use tendency input screen. The lender 20 operates the use tendency input screen displayed on the lender terminal 12 to input any first energy amount scheduled to be used. The lender terminal 12 transmits the received first energy amount to the information processing apparatus 10D. The setting unit 31R of the information processing apparatus 10D identifies and sets the first energy amount received from the lender terminal 12.

The setting unit 31R may set the identified first energy amount when the identified first energy amount is less than the remaining energy amount of the vehicle 16. On the other hand, when the identified first energy amount is not less than the remaining energy amount of the vehicle 16, the setting unit 31R transmits error information to the lender terminal 12.

The following describes the calculation unit 31X. The calculation unit 31X calculates the first remaining energy amount and the vehicle cabin available time for the user 22.

The calculation unit 31X acquires from the vehicle 16 for which the first energy amount has been set by the setting unit 31R the remaining energy amount of the vehicle 16. The calculation unit 31X acquires the remaining energy amount of the vehicle 16 by reading the remaining energy amount of the vehicle 16 included in the detection result received from the vehicle 16, for example.

Then the calculation unit 31X calculates the first remaining energy amount by subtracting the first energy amount set by the setting unit 31R from the acquired remaining energy amount of the vehicle 16. Then the calculation unit 31X registers the acquired remaining energy amount of the vehicle 16 and the calculated first remaining energy amount in the vehicle cabin management information 33R in association with the vehicle ID of the vehicle 16.

In this process, the calculation unit 31X may calculate the first remaining energy amount in accordance with an energy consumption amount such as natural discharge occurring in the lending period or a period until the reservation time when the vehicle cabin 17 of the vehicle 16 is used. The calculation unit 31X may calculate the first remaining energy amount by subtracting an energy amount obtained by adding the energy consumption amount such as natural discharge to the first energy amount set by the setting unit 31R from the acquired remaining energy amount of the vehicle 16, for example.

Then the calculation unit 31X calculates the vehicle cabin available time for the user 22. Specifically, the calculation unit 31X identifies the use condition information permitted to be used by the lender 20 from the vehicle cabin lending information corresponding to the first energy amount set by the setting unit 31R in the vehicle cabin management information 33R. The calculation unit 31X calculates the vehicle cabin available time for the user 22 using a consumption energy amount per unit time corresponding to each of the identified use condition information and the calculated first remaining energy amount. The storage unit 33D stores therein a consumption energy amount per unit time corresponding to each of the purposes and the fixtures in advance. The calculation unit 31X may read the consumption energy amount corresponding to the identified use condition information such as a purpose and a fixture from the storage unit 33D. Then the vehicle cabin available time for the lender 20 may be calculated.

Thus, the calculation unit 31X can calculate the vehicle cabin available time for the lender 20 corresponding to the use condition permitted by the user 22.

Then the calculation unit 31X registers the calculated vehicle cabin available time for the user in the vehicle cabin management information 33R as the vehicle cabin available time for the user 22 corresponding to the first energy amount set by the setting unit 31R.

Thus, the lending energy information, which is information on the energy amount of the vehicle 16 at timing before the vehicle cabin 17 of the vehicle 16 is lent out to the user 22, is registered in the vehicle cabin management information 33R.

The following describes the search unit 31Y. The search unit 31Y receives the use reservation information and the use condition information from the user terminal 14 via the receiver 30A in the same manner as the first embodiment and the second embodiment.

The search unit 31Y calculates the second scheduled use energy amount using the use reservation information and the use condition information having been received.

As described in the first embodiment, the use reservation information is search conditions for the vehicle cabin 17 desired to be used by the user 22 and is information including one or more search words. The use reservation information includes at least one search word of a date, a use starting time, a use time, and a use location on which the vehicle cabin 17 is scheduled to be used, for example. As described in the second embodiment, the use condition information is information on the condition when using the vehicle cabin 17 and is information including fixtures such as an air conditioner, audio, and Wi-Fi and purposes such as meal and work, for example.

The search unit 31Y calculates the second scheduled use energy amount based on a use environment such as atmospheric temperature and weather on the date and the use starting time on which the vehicle cabin 17 is scheduled to be used, a consumption energy amount per unit time corresponding to the use environment and the use condition information, and the like, for example.

Specifically, the storage unit 33D stores a learning model for deriving the consumption energy of the vehicle 16 per unit time from the use environment and the use condition information in advance. The controller 31D generates in advance a first learning model learned by a known method using the correspondence between the use environment and the use condition information and the consumption energy of the vehicle 16 when each of a plurality of users including the lender 20 and the user 22 uses the vehicle 16 as teacher data, for example. In addition, the controller 31D stores therein in advance a second learning model learned by a known method using the correspondence between the use environment and the use condition information and the consumption energy of the vehicle 16 for each of a plurality of vehicles 16 as teacher data. Then the controller 31D generates in advance a single learning model integrating the first learning model and the second learning model with each other and stores the single learning model in the storage unit 33D in advance.

The generation of the learning model may be performed by an external apparatus. In this case, the information processing apparatus 10D may acquire the learning model from the external apparatus via the network 18 and store it in the storage unit 33D in advance.

Then the search unit 31Y inputs the use environment and the use condition information received from the user terminal 14 into the learning model to derive consumption energy per unit time corresponding to the use environment and the use condition information. The search unit 31Y may calculate the second scheduled use energy amount by multiplying the derived consumption energy per unit time by the use time included in the use reservation information.

Then the search unit 31Y searches the vehicle cabin management information 33R for the vehicle cabin lending information satisfying the use reservation information and the use condition information received from the user terminal 14 and the calculated second scheduled use energy amount. Specifically, the search unit 31Y searches the vehicle cabin management information 33R for the vehicle cabin lending information matching or similar to the search word(s) included in the use reservation information, satisfying the use condition information, and the calculated second scheduled use energy amount of which is less than the first remaining energy amount.

The first output controller 31E transmits the list information 32X, which is the list of the vehicle cabin lending information searched for by the search unit 31Y, to the user terminal 14 in the same manner as the first output controller 30D1 of the first embodiment and the first output controller 30D2 of the second embodiment. In this process, in the present embodiment, the first output controller 31E transmits the list information 32X, which is a list of the vehicle cabin lending information searched for and at least either the vehicle cabin available time for the user 22 or the first remaining energy amount corresponding to the vehicle cabin lending information, to the user terminal 14. Thus, the user 22 can view a list of the vehicle cabin lending information of the vehicle cabin 17 satisfying the use reservation information and the use condition of the user 22 by referring to the list information 32X displayed on the user terminal 14. In addition, the user 22 can check at least either the vehicle cabin available time for the user 22 or the first remaining energy amount by referring to the list information 32X displayed on the user terminal 14.

The calculation of the second scheduled use energy amount may be performed on the user terminal 14. In this case, the user terminal 14 may be provided with a function of calculating the second scheduled use energy amount in the search unit 31Y.

The following describes the execution unit 31Z. The execution unit 31Z executes use restriction processing for the vehicle 16 based on the second energy amount used by the vehicle 16 during the lending period of the vehicle cabin 17 and the first energy amount.

The lending period is a period during which the vehicle cabin 17 of the vehicle 16 is lent out to the user 22. The lending period specifically corresponds to the reservation time and the use period by the user 22.

The execution unit 31Z executes the use restriction processing for the vehicle 16 when the second remaining energy amount of the vehicle 16 of the vehicle cabin 17 is less than a threshold. This threshold may be set in advance.

The use restriction processing is processing to restrict the use of the vehicle cabin 17 of the vehicle 16 by the user 22. The use restriction processing is at least one of output processing to output error information, additional charging processing to the user 22, reduction processing for supply energy per unit time, and display processing for an input screen for receiving input of negotiation details with the lender 20, for example.

The output processing to output error information is processing to output information indicating that the second remaining energy amount has become less than the threshold to at least either the user terminal 14 of the user 22 or the vehicle 16. In other words, the output processing to output error information is processing to notify user 22 who is using the vehicle cabin 17 of the vehicle 16 of the fact that the second remaining energy amount has become less than the threshold.

The execution unit 31Z executes the output processing to output error information by generating the error information and transmitting it to at least either the vehicle 16 or the user terminal 14.

The additional charging processing to the user 22 is processing to perform additional charging on the user 22. The execution unit 31Z calculates an additionally charged fee from a charged fee per unit time set in advance in accordance with an elapsed time from the determination that the second remaining energy amount of the vehicle 16 is less than the threshold, for example. In this case, the lending ending processing unit 30J may calculate a fee obtained by adding the additionally charged fee to the fee calculated in accordance with the time from the start of use to the end of use at the time of the fee calculation processing in the same manner as the first embodiment.

The reduction processing for supply energy per unit time is processing to reduce an energy amount per unit time to be supplied to each of the equipment such as an air conditioner and audio installed in the vehicle 16. The execution unit 31Z increases a reduction rate of the energy amount per unit time to be supplied for a longer elapsed time in accordance with the elapsed time from the determination that the second remaining energy amount of the vehicle 16 is less than the threshold, for example. The execution unit 31Z may increase the number of pieces of equipment for which the energy amount per unit time is reduced as this elapsed time becomes longer. In this process, the execution unit 31Z preferably selects the equipment in an ascending order of influence on safe driving as an object for which the energy amount per unit time is reduced and executes the reduction processing for supply energy per unit time.

The display processing for an input screen for receiving input of negotiation details with the lender 20 is processing to display an input screen for use in requesting the lender 20 to increase the second remaining energy amount on the user terminal 14 of the user 22 and the vehicle 16 being used by the user 22.

The execution unit 31Z generates an input screen for negotiation details and displays it on the user terminal 14 or the vehicle 16, for example. Then assumed is a case in which negotiation details information has been input through an operation instruction by the user 22 via the input screen or the like. In this case, the execution unit 31Z transmits the negotiation details information to the lender terminal 12 of the lender 20, who is the owner of the vehicle 16.

The lender 20 operates the lender terminal 12 to input information indicating that the first energy amount is to be reduced or information indicating non-negotiability, for example. When receiving the information indicating that the first energy amount is to be reduced, the execution unit 31Z may output the reduced first energy amount to the setting unit 31R. Then the setting unit 31R and calculation unit 31X may execute the same processing as the above using the received first energy amount.

On the other hand, when receiving the information indicating non-negotiability, the execution unit 31Z may transmit the information to the user terminal 14 or the vehicle 16.

The following describes a procedure of registration processing for the lending energy information executed by the information processing system 1D.

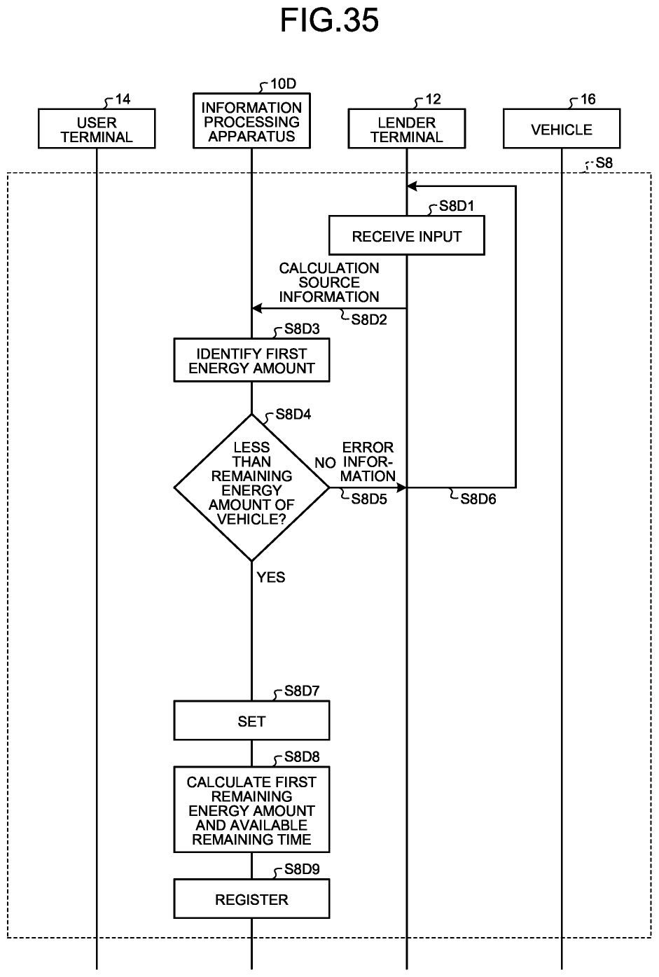

FIG. 35 is a sequence diagram of an example of the procedure of the registration processing for the lending energy information (Step S8) executed by the information processing system 1D. The registration processing for the lending energy information is executed after the registration processing for the vehicle cabin lending information described in the second embodiment (refer to FIG. 15).

The lender terminal 12 receives input of the calculation source information by the lender 20 (Step S8D1). The lender terminal 12 transmits the received calculation source information to the information processing apparatus 10D (Step S8D2).

The setting unit 31R of the information processing apparatus 10D identifies the first energy amount using the calculation source information received from the lender terminal 12 (Step S8D3).

The setting unit 31R of the information processing apparatus 10D determines whether the identified first energy amount is less than the remaining energy amount of the vehicle 16 (Step S8D4). If determining that the identified first energy amount is not less than the remaining energy amount of the vehicle 16 (No at Step S8D4), error information is transmitted to the lender terminal 12 (Step S8D5), and the process returns to Step S8D1 (Step S8D6).

On the other hand, if determining that the identified first energy amount is less than the remaining energy amount of the vehicle 16 (Yes at Step S8D4), the setting unit 31R of the information processing apparatus 10D sets the first energy amount identified at Step S8D3 (Step S8D7). In this process, the setting unit 31R of the information processing apparatus 10D registers the first energy amount in the vehicle cabin management information 33R in association with the vehicle ID of the vehicle 16 of the lender terminal 12, which is the transmission source of the calculation source information received at Step S8D2.

Next, the calculation unit 31X of the information processing apparatus 10D calculates the first remaining energy amount of the vehicle 16 and the vehicle cabin available time for the user 22 (Step S8D8). The calculation unit 31X acquires the remaining energy amount of the vehicle 16 by reading the remaining energy amount of the vehicle 16 included in the detection result received from the vehicle 16. Then the calculation unit 31X calculates the first remaining energy amount by subtracting the first energy amount set at Step S8D7 from the acquired remaining energy amount of the vehicle 16. The calculation unit 31X calculates the vehicle cabin available time for the user 22 in accordance with the first remaining energy amount of the vehicle 16 and the use condition information permitted to be used by the lender 20.

The calculation unit 31X of the information processing apparatus 10D registers the calculated first remaining energy amount and the vehicle cabin available time for the user 22 in the vehicle cabin management information 33R in association with the vehicle ID of the vehicle 16 (Step S8D9).

The following describes a procedure of the use starting processing from when the use reservation information is input from the user terminal 14 to when the use of the vehicle cabin 17 is started.

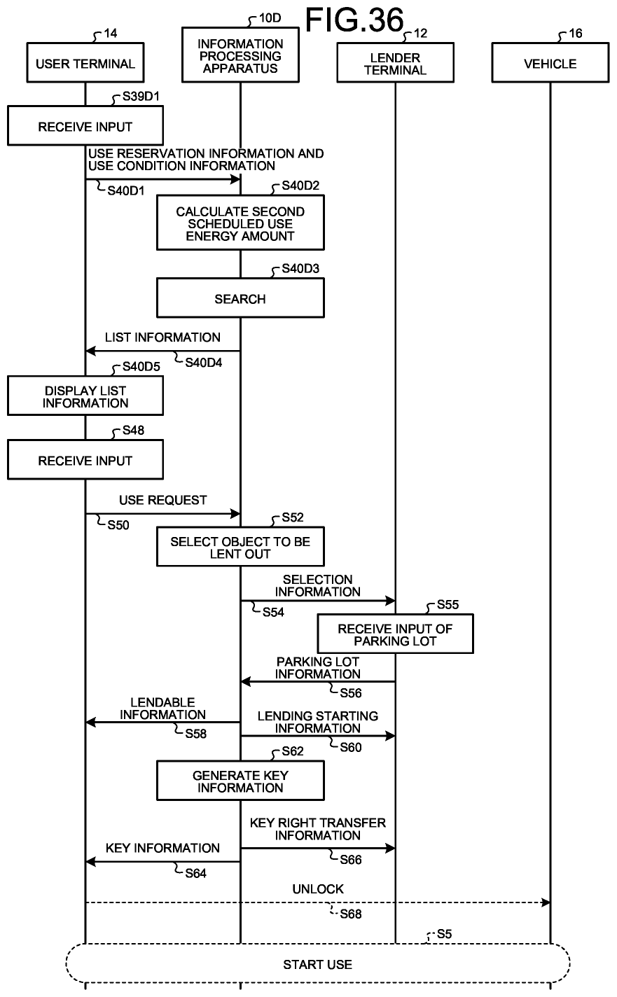

FIG. 36 is a sequence diagram of an example of the procedure of the use starting processing executed by the information processing system 1D.

The user terminal 14 receives input of the use reservation information and the use condition information (Step S39D1).

The user 22 operates the user terminal 14 to input the use reservation information, which is search conditions for the vehicle cabin 17 that the user 22 desires to use and is information including one or more search words. The user 22 also inputs the use condition information of the vehicle cabin 17 desired to be used by the user 22. The display screen displayed on the user terminal 14 at the time of inputting the use reservation information and the use condition information is the same as FIG. 18A to FIG. 18D described in the second embodiment.

The user terminal 14 transmits the use reservation information and the use condition information having been received to the information processing apparatus 10D (Step S40D1).

The search unit 31Y of the information processing apparatus 10D calculates the second scheduled use energy amount using the use reservation information and the use condition information having been received (Step S40D2).

Then the search unit 31Y of the information processing apparatus 10D searches the vehicle cabin management information 33R for the vehicle cabin lending information satisfying the use reservation information and the use condition information received from the user terminal 14 and the calculated second scheduled use energy amount (Step S40D3).

The first output controller 31E of the information processing apparatus 10D transmits the list information 32X, which is the list of the vehicle cabin lending information searched for by the search unit 31Y and at least either the vehicle cabin available time for the user 22 or the first remaining energy amount corresponding to the vehicle cabin lending information, to the user terminal 14 (Step S40D4).

The user terminal 14 displays the received list information 32X (Step S40D5). The user 22 operates the user terminal 14 while referring to the list information 32X displayed on the user terminal 14 to select one piece of vehicle cabin lending information that the user 22 desires to use. In this process, the user 22 can select the vehicle cabin lending information of one vehicle cabin 17 that the user 22 desires to use while checking the first remaining energy amount and the vehicle cabin available time for the user.

Then the information processing system 1D executes the processing at Step S48 to Step S68 and Step S5. These pieces of processing are the same as those of Step S48 to Step S68 and Step S5 described with reference to FIG. 10 in the first embodiment. Thus, detailed descriptions thereof are omitted here.

The following describes a procedure of processing executed when the vehicle cabin 17 is used by the user 22.

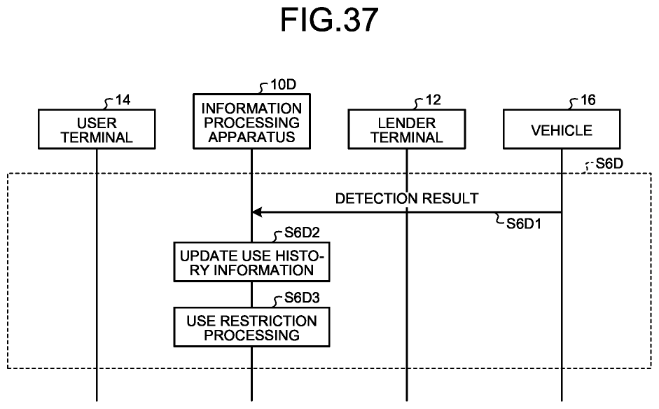

FIG. 37 is a sequence diagram of an example of the procedure of the processing (Step S6D) executed when the vehicle cabin 17 is used by the user 22.

When the use of the vehicle cabin 17 by the user 22 is started, the controller 24A of the vehicle 16 acquires the detection result including the position information of the vehicle 16 detected by the sensor 24C of the vehicle 16, the operating state of each of the various kinds of electronic devices installed in the vehicle 16, the remaining energy amount of the vehicle 16, and the current use energy amount per unit time of the vehicle 16. The controller 24A of the vehicle 16 may acquire the detection result for each certain time or each time the situation changes. Then the controller 24A of the vehicle 16 transmits the detection result to the information processing apparatus 10D (Step S6D1).

The update unit 30I of the information processing apparatus 10D registers the detection result received at Step S6D1 in the lending management information 33S as the use history information in association with the vehicle cabin ID of the vehicle cabin 17 of the vehicle 16, which is the transmission source of the detection result (Step S6D2) (refer to FIG. 33B). In this process, the update unit 30I registers the remaining energy amount of the vehicle 16 included in the detection result in the lending management information 33S as one piece of information included in the use energy information. The update unit 30I also updates the second energy amount corresponding to the vehicle cabin ID of the vehicle cabin 17 of the vehicle 16, which is the transmission source of the detection result, registered in the lending management information 33S. Specifically, the update unit 30I adds an energy amount derived from the current use energy amount per unit time included in the detection result and an elapsed time from the previous integration timing to the second energy amount. Then the update unit 30I updates the second energy amount to the value after the addition.

Next, the execution unit 31Z of the information processing apparatus 10D executes the use restriction processing (Step S6D3). The execution unit 31Z of the information processing apparatus 10D identifies the second scheduled use energy amount and the second energy amount corresponding to the vehicle cabin ID of the vehicle cabin 17 of the vehicle 16, which is the transmission source of the detection result at Step S6D1. The execution unit 31Z of the information processing apparatus 10D then calculates the second remaining energy amount by subtracting the second energy amount from the identified second scheduled use energy amount and registers it in the lending management information 33S. The execution unit 31Z of the information processing apparatus 10D executes the use restriction processing when this second remaining energy amount is less than the threshold.

Each time the detection result is received from the vehicle 16, the information processing system 1D executes the processing at Step S6D1 to Step S6D3. Thus, the lending management information 33S is updated during the use period by the user 22. During the use period by the user 22, the use restriction processing is executed in accordance with the second remaining energy amount.

The following describes an example of a procedure of information processing executed by the information processing apparatus 10D.

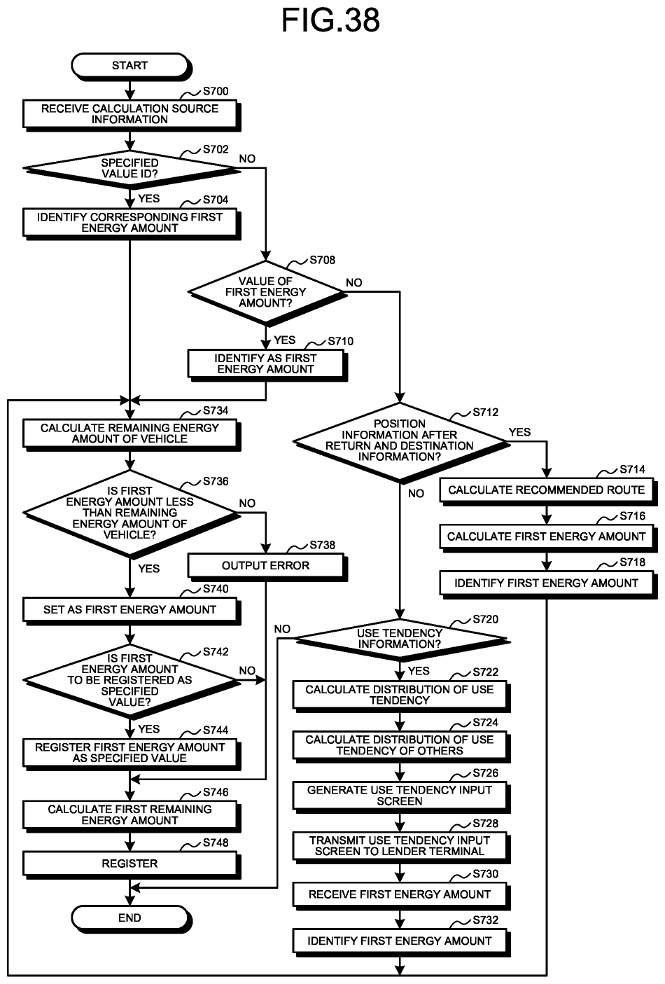

FIG. 38 is a flowchart of an example of the procedure of the registration processing for the lending energy information executed by the information processing apparatus 10D.

The setting unit 31R receives the calculation source information from the lender terminal 12 via the receiver 30A (Step S700).

The setting unit 31R determines whether the calculation source information received at Step S700 is the specified value ID (Step S702). If determining that the calculation source information is the specified value ID (Yes at Step S702), the setting unit 31R identifies the first energy amount by reading the first energy amount corresponding to the specified value ID from the storage unit 33C (Step S704). Then the process advances to Step S734 described below.

On the other hand, if a negative determination is made at Step S702 (No at Step S702), the process advances to Step S708. The setting unit 31R determines whether the calculation source information received at Step S700 is the value of the first energy amount (Step S708). If determining that the calculation source information is the value of the first energy amount (Yes at Step S708), the setting unit 31R identifies the first energy amount (Step S710), and the process advances to Step S734 described below.

On the other hand, if a negative determination is made at Step S708 (No at Step S708), the process advances to Step S712. At Step S712, the setting unit 31R determines whether the calculation source information received at Step S700 is the position information of the vehicle 16 at the time of return and the destination information (Step S712). If an affirmative determination is made at Step S712 (Yes at Step S712), the setting unit 31R calculates the recommended route from the position on the real space identified by the position information to the position on the real space identified by the destination information (Step S714). Then the setting unit 31R calculates the energy amount consumed by the vehicle 16 when the vehicle 16 travels along the calculated recommended route (Step S716). The setting unit 31R identifies the calculated energy amount as the first energy amount (Step S718). Then the process advances to Step S734 described below.

On the other hand, if a negative determination is made at Step S712 (No at Step S712), the process advances to Step S720. At Step S720, the setting unit 31R determines whether the calculation source information received at step S700 is the request to input the use tendency information (Step S720). If a negative determination is made at step S720, the present routine ends. On the other hand, if an affirmative determination is made at Step S720 (Yes at Step S720), the process advances to Step S722.

At Step S722, the setting unit 31R calculates the distribution of the past use tendency of the lender 20 of the lender terminal 12, which is the transmission source of the calculation source information received at Step S700 (Step S722). Next, the setting unit 31R calculates the distribution of the past use tendency of the other users other than the lender 20 (Step S724). The setting unit 31R then generates the use tendency input screen indicating the correspondence between the environmental information and the first energy amount using at least either the distribution of the past use tendency of the lender 20 or the distribution of the past use tendency of the other users other than the lender 20 calculated at Step S722 or Step S724 (Step S726).

The setting unit 31R transmits the use tendency input screen generated at Step S726 to the lender terminal 12, which is the transmission source of the calculation source information received at Step S700 (Step S728). Then the setting unit 31R receives the first energy amount from the lender terminal 12 via the receiver 30A (Step S730) and identifies the first energy amount (Step S732). Then the process advances to Step S734.

At Step S734, the setting unit 31R determines whether the identified first energy amount is less than the remaining energy amount of the vehicle 16 (Step S736). If a negative determination is made at Step S736 (No at Step S736), the setting unit 31R outputs the error information prompting resetting to the lender terminal 12 (Step S738), and the present routine ends.

On the other hand, if an affirmative determination is made at Step S736 (Yes at Step S736), the process advances to Step S740. At Step S740, the setting unit 31R sets the identified first energy amount in the vehicle cabin management information 33R.

Next, the setting unit 31R determines whether the set first energy amount is registered as a specified value (Step S742). The setting unit 31R determines whether a request signal requesting that the first energy value be registered as the specified value has been received from the lender terminal 12 to perform the determination at Step S742, for example. If a negative determination is made at Step S742 (No at Step S742), the process advances to Step S746 described below. If an affirmative determination is made at Step S742 (Yes at Step S742), the setting unit 31R registers the set first energy amount and a newly given specified value ID in the storage unit 33D in association with each other (Step S744).

Next, the calculation unit 31X calculates the first remaining energy amount (Step S746). The calculation unit 31X acquires from the vehicle 16 for which the first energy amount has been set at Step S740 the remaining energy amount of the vehicle 16. The calculation unit 31X acquires the remaining energy amount of the vehicle 16 by reading the remaining energy amount of the vehicle 16 included in the detection result received from the vehicle 16, for example. Then the calculation unit 31X calculates the first remaining energy amount by subtracting the first energy amount set by the setting unit 31R from the acquired remaining energy amount of the vehicle 16.

Then the calculation unit 31X registers the acquired remaining energy amount of the vehicle 16 and the calculated first remaining energy amount in the vehicle cabin management information 33R in association with the vehicle ID of the vehicle 16 (Step S748). Then the present routine ends.

The following describes a procedure of information processing executed by the information processing apparatus 10D when the vehicle cabin 17 is used by the user 22.

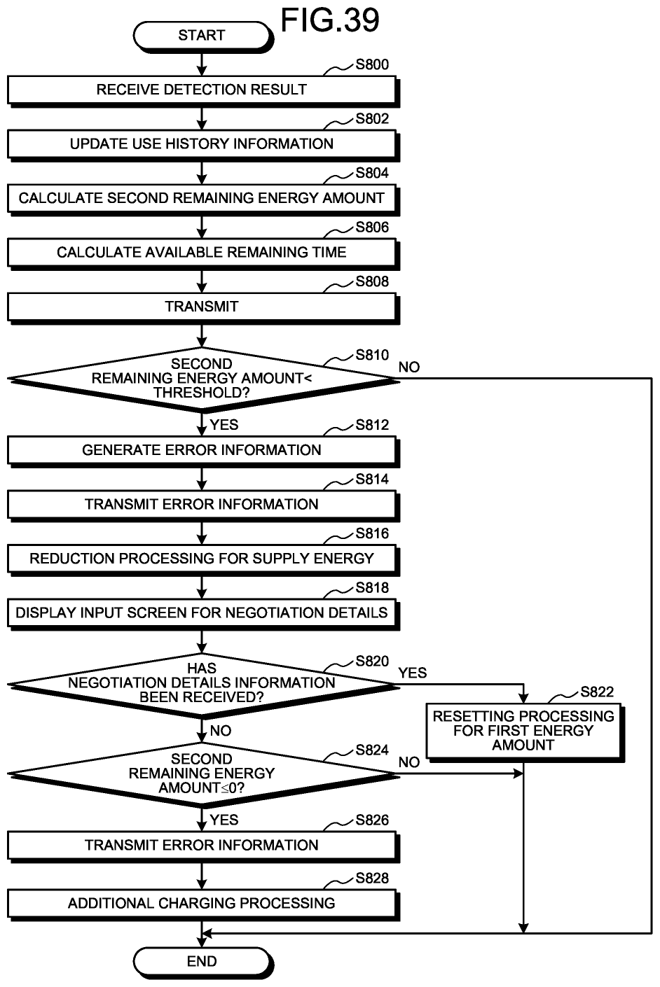

FIG. 39 is a flowchart of an example of the procedure of the information processing executed by the information processing apparatus 10D when the vehicle cabin 17 is used by the user 22.

The update unit 30I of the information processing apparatus 10D receives the detection result from the vehicle 16 (Step S800).

The update unit 30I registers the received detection result in the lending management information 33S as the use history information in association with the vehicle cabin ID of the vehicle cabin 17 of the vehicle 16, which is the transmission source of the detection result (Step S802).

Next, the execution unit 31Z calculates the second remaining energy amount (Step S804). The execution unit 31Z identifies the second scheduled use energy amount and the second energy amount corresponding to the vehicle cabin ID of the vehicle cabin 17 of the vehicle 16, which is the transmission source of the detection result received at Step S800. Then the execution unit 31Z of the information processing apparatus 10D calculates the second remaining energy amount by subtracting the second energy amount from the identified second scheduled use energy amount. Then the execution unit 31Z registers the calculated second remaining energy amount in the lending management information 33S.

Next, the execution unit 31Z calculates a remaining time during which the user 22 who is using the vehicle cabin 17 can use the vehicle cabin 17 (Step S806). The execution unit 31Z identifies the use condition information corresponding to the user ID of the user 22 in the lending management information 33S, for example. The execution unit 31Z calculates the remaining time during which the user 22 who is using the vehicle cabin 17 can use the vehicle cabin 17 using the consumption energy amount per unit time corresponding to each of the identified use condition information and the second remaining energy amount calculated at Step S804.

The execution unit 31Z transmits at least either the second remaining energy amount calculated at Step S804 or the remaining time during which the user 22 who is using the vehicle cabin 17 can use the vehicle cabin 17 calculated at Step S806 to the user terminal 14 of the user 22 and the vehicle 16 being used by the user 22. (Step S808).

Next, the execution unit 31Z executes the use restriction processing (Step S810 to Step S828).

Specifically, the execution unit 31Z determines whether the second remaining energy amount of the vehicle 16 of the vehicle cabin 17 is less than the threshold (Step S810). If a negative determination is made at Step S810 (No at Step S810), the present routine ends. If an affirmative determination is made at Step S810 (Yes at Step S810), the process advances to Step S812.

At Step S812, the execution unit 31Z generates the error information indicating that the second remaining energy amount has become less than the threshold (Step S812) and transmits the error information to at least either the user terminal 14 of the user 22 or the vehicle 16 (Step S814).

Next, the execution unit 31Z starts the reduction processing for supply energy per unit time (Step S816).

Next, the execution unit 31Z displays the input screen for receiving input of negotiation details between the user 22 and the lender 20 on at least either the user terminal 14 or the vehicle 16 (Step S818). Then the execution unit 31Z determines whether the negotiation details information has been received from the user terminal 14 within a certain time from the display processing at Step S818 (Step S820). If an affirmative determination is made at Step S820 (Yes at Step S820), the process advances to Step S822. At Step S822, the execution unit 31Z executes resetting processing for the first energy amount (Step S822). The processing at step S822 includes processing such as transmission of the negotiation details information received at Step S820 to the lender terminal 12, reception of the information from the lender terminal 12 indicating non-negotiability or that the first energy amount is to be reduced, and output of the reduced first energy amount to the setting unit 31R. The setting unit 31R and the calculation unit 31X having received the reduced first energy amount may perform the same processing as the above using the received first energy amount.

On the other hand, if a negative determination is made at Step S820 (No at Step S820), the process advances to Step S824. At Step S824, it is determined whether the second remaining energy amount is zero “0” or less (Step S824). At Step S824, in place of zero “0,” a value larger than zero and less than the threshold used for the determination at Step S810 may be used for the determination.

If a negative determination is made at Step S824 (No at Step S824), the present routine ends. On the other hand, if an affirmative determination is made at Step S824 (Yes at Step S824), the process advances to Step S826. At Step S826, the execution unit 31Z transmits the error information indicating that the second remaining energy amount is insufficient to at least either the user terminal 14 or the vehicle 16 (Step S826).

Next, the execution unit 31Z executes the additional charging processing (Step S828). The execution unit 31Z calculates the additionally charged fee from the charged fee per unit time set in advance in accordance with the elapsed time from the affirmative determination at Step S810, for example. The lending ending processing unit 30J may calculate the fee obtained by adding the additionally charged fee to the fee calculated in accordance with the time from the start of use to the end of use at the time of the fee calculation processing in the same manner as the first embodiment. The execution unit 31Z may further execute the reduction processing for supply energy per unit time executed at Step S816 at the timing of Step S828. That is to say, the execution unit 31Z may execute the reduction processing for supply energy per unit time at the timing of step S828 in place of the timing of step S816. Then the present routine ends.

As described above, the information processing apparatus 10D of the present embodiment is the information processing apparatus 10D in the system lending out the vehicle cabin 17 of the vehicle 16. The information processing apparatus 10D includes the setting unit 31R and the execution unit 31Z. The setting unit 31R sets the first energy amount, which is the energy amount scheduled to be used by the lender 20 after the vehicle 16 of the vehicle cabin 17 lent out to the user 22 is returned to the lender 20, who is the owner of the vehicle 16. The execution unit 31Z executes the use restriction processing for the vehicle 16 based on the second energy amount, which is the energy amount used by the vehicle 16 during the lending period of the vehicle cabin 17, and the first energy amount.

Thus, the information processing apparatus 10D of the present embodiment makes the vehicle cabin 17 of the vehicle 16 the object to be lent out. Thus, the vehicle cabin 17 to be lent out can be managed regardless of whether the vehicle 16 moves or does not move while being lent out.

Consequently, the information processing apparatus 10D of the present embodiment can achieve effective sharing of the mobile object not in a moving state.

The information processing apparatus 10D of the present embodiment sets the first energy amount scheduled to be used by the lender 20 after the vehicle 16 is returned to the lender 20, who is the owner of the vehicle 16. Then the information processing apparatus 10D executes the use restriction processing restricting the use of the vehicle 16 based on the second energy amount, which is the energy amount used by the vehicle 16 during the lending period of the vehicle cabin 17, and the first energy amount.

Thus, in addition to the above effects, the information processing apparatus 10D of the present embodiment can inhibit the use of the vehicle cabin 17 of the vehicle 16 after being returned by the lender 20 from being restricted.

The computer program for executing the processing in the embodiments described above has a modular configuration including each of the functional units; in terms of actual hardware, a CPU (a processor circuit) reads an information processing program from a ROM or a hard disk drive (HDD) and executes it, whereby each of the functional units described above is loaded onto a RAM (a main memory), and each of the functional units described above is generated on the RAM (the main memory), for example. Part or the whole of each of the functional units described above can be implemented using dedicated hardware such as an application specific integrated circuit (ASIC) or a field-programmable gate array (FPGA).

The above has described the embodiments; the above embodiments are presented by way of example and do not intend to limit the scope of the present disclosure. The novel embodiments can be performed in various other forms, and various omissions, replacements, and modifications can be made without departing from the gist of the invention. The embodiments are included in the scope or gist of the present disclosure and are included in the inventions described in the claims and their equivalents.

The configuration of the first embodiment and the configuration of the second embodiment may be performed in a combined manner, for example, and thus, two embodiments among the first to fourth embodiments described above may be performed in a combined manner. Three embodiments among the first to fourth embodiments may be performed in a combined manner. All the first to fourth embodiments may be performed in a combined manner. That is to say, the configurations according to different embodiments may be performed in a combined manner.

About the above embodiments, the following A-1 to A-10, B-1 to B-12, C-1 to C-8, and D-1 to D-8 are disclosed.

(A-1)

An information processing apparatus in a system lending out vehicle cabins of mobile objects, the information processing apparatus including:

a first output controller outputting first information indicating information on the vehicle cabins of the mobile objects in which at least a partial period of a standing period of the mobile objects is capable of being set as a lending period;

a reception unit receiving an instruction by a user; and

a second output controller outputting second information indicating that the vehicle cabin to be lent out to the user among the vehicle cabins included in the first information is lendable based on the instruction by the user received by the reception unit.

(A-2)

The information processing apparatus according to A-1, in which

the first output controller outputs the first information to a user terminal used by the user, and

the second output controller outputs the second information to the user terminal.

(A-3)

The information processing apparatus according to A-1 or A-2, in which the first output controller outputs the first information of the vehicle cabins of the mobile objects at least a partial period of a standing period of which is capable of being set as the lending period, the vehicle cabins of the mobile objects the traveling of which during the lending period being capable of being set to be permissible.

(A-4)

The information processing apparatus according to any one of A-1 to A-3, further including a registration unit registering user information of the user having used the vehicle cabins, lender information of a lender having lent out the vehicle cabins, and evaluation information of at least either the user or the lender in association with each other.

(A-5)

The information processing apparatus according to any one of A-1 to A-4, in which the second information includes parking lot information, which is area information for one of the mobile objects having the vehicle cabin having been selected.

(A-6)

The information processing apparatus according to any one of A-1 to A-5, in which the mobile objects are passenger cars.

(A-7)

The information processing apparatus according to any one of A-1 to A-6, in which the second information is information including third information indicating lending with the mobile objects standing and a use fee for a state indicated by the third information.

(A-8)

The information processing apparatus according to A-7, in which the use fee is capable of differing between lending with the mobile objects standing and lending with the mobile objects permitted to travel.

(A-9)

A method of information processing executed in a system lending out vehicle cabins of mobile objects, the method including:

a step of outputting first information indicating information on the vehicle cabins of the mobile objects in which at least a partial period of a standing period of the mobile objects is capable of being set as a lending period;

a step of receiving an instruction by a user; and

a step of outputting second information indicating that the vehicle cabin to be lent out to the user among the vehicle cabins included in the first information is lendable based on the received instruction by the user.

(A-10)

An information processing system lending out vehicle cabins of mobile objects, the information processing system including an information processing apparatus, a user terminal communicating with the information processing apparatus, and a lender terminal communicating with the information processing apparatus,

the information processing apparatus including:
a first output controller outputting first information indicating information on the vehicle cabins of the mobile objects in which at least a partial period of a standing period of the mobile objects is capable of being set as a lending period;
a reception unit receiving an instruction by a user; and
a second output controller outputting second information indicating that the vehicle cabin to be lent out to the user among the vehicle cabins included in the first information is lendable based on the instruction by the user received by the reception unit.

(B-1)

An information processing apparatus in a system lending out vehicle cabins of mobile objects, the information processing apparatus including:

a generation unit generating key information to make equipment of the vehicle cabins corresponding to first information indicating one or more use conditions indicating permission of use set by a lender of the vehicle cabins an unlocked state; and

a transmitter transmitting the key information to a user terminal of a user for whom the use of the vehicle cabins is permitted.

(B-2)

The information processing apparatus according to B-1, further including:

a first output controller outputting second information indicating information on the vehicle cabins of the mobile objects in which at least a partial period of a standing period of the mobile objects is capable of being set as a lending period; and

a second output controller outputting third information indicating that the vehicle cabin to be lent out to the user among the vehicle cabins included in the information is lendable based on an instruction by the user.

(B-3)

The information processing apparatus according to B-1 or B-2, in which the first information includes use purpose information of the vehicle cabins.

(B-4)

The information processing apparatus according to B-3, in which the use purpose information is at least either use purpose information of the vehicle cabins of the mobile objects in a moving state or use purpose information of the vehicle cabins of the mobile objects in a stopping state.

(B-5)

The information processing apparatus according to any one of B-1 to B-4, further including an identification unit identifying the first information desired by the user for whom the use of the vehicle cabins is permitted among one or more pieces of the first information permitted to be used set in advance by the lender, in which the generation unit generates the key information to make the equipment of the vehicle cabins corresponding to the identified first information the unlocked state.

(B-6)

The information processing apparatus according to any one of B-1 to B-5, further including an identification unit identifying the first information permitted to be used by the lender of the vehicle cabins among the first information desired to be used by the user for whom the use of the vehicle cabins is permitted, in which the generation unit generates the key information to make the equipment of the vehicle cabins corresponding to the identified first information the unlocked state.

(B-7)

The information processing apparatus according to B-6, further including a transmitter, when the key information is generated, transmitting fourth information indicating that a right of the key information has been transferred to the user to a lender terminal of the lender.

(B-8)

The information processing apparatus according to any one of B-1 to B-7, further including an update unit updating use history information of the equipment in a use period of the vehicle cabins by the user.

(B-9)

The information processing apparatus according to any one of B-1 to B-8, further including a registration unit registering user information of the user having used the vehicle cabins, lender information of the lender having lent out the vehicle cabins, and evaluation information of at least either the user or the lender in association with each other.

(B-10)

The information processing apparatus according to any one of B-1 to B-9, in which the mobile objects are passenger cars.

(B-11)

A method of information processing executed by an information processing apparatus in a system lending out vehicle cabins of mobile objects, the method including:

a step of generating key information to make equipment of the vehicle cabins corresponding to first information indicating one or more use conditions indicating permission of use set by a lender of the vehicle cabins an unlocked state; and

a step of transmitting the key information to a user terminal of a user for whom the use of the vehicle cabins is permitted.

(B-12)

An information processing system including an information processing apparatus lending out vehicle cabins of mobile objects, a user terminal communicating with the information processing apparatus, and a lender terminal communicating with the information processing apparatus,

the information processing apparatus including:
a generation unit generating key information to make equipment of the vehicle cabins corresponding to first information indicating one or more use conditions indicating permission of use set by a lender of the vehicle cabins an unlocked state; and
a transmitter transmitting the key information to a user terminal of a user for whom the use of the vehicle cabins is permitted.

(C-1)

An information processing apparatus in a system lending out vehicle cabins of mobile objects, the information processing apparatus including:

a detector detecting the completion of standing of the mobile object driven by a lender, who is an owner of the mobile object;

a first registration unit registering first information indicating information on the vehicle cabin of the mobile object and second information indicating that the vehicle cabin is lendable in first management information in association with each other when the completion of standing of the mobile object is detected; and

an output controller outputting the first information corresponding to the second information registered in the first management information.

(C-2)

The information processing apparatus according to C-1, in which the first registration unit, when the completion of standing is detected, and third information indicating a scheduled time at which the standing of the mobile object for which the completion of standing has been detected is ended is received, registers the first information including the third information and the second information in the first management information in association with each other.

(C-3)

The information processing apparatus according to C-2, in which the first registration unit registers the first information and fourth information indicating that the mobile object is standing in the first management information in association with each other when the completion of standing is detected, and the third information of the mobile object for which the completion of standing has been detected has not been received for a certain time or more.

(C-4)

The information processing apparatus according to C-3, further including:

a first receiver receiving fifth information, which is information indicating a search condition for the vehicle cabin desired to be used by a user, from a user terminal;

a second registration unit, when the fifth information is received, when the first information with which the second information is associated has not been registered in the first management information, registering the fifth information in second management information; and

a second receiver receiving permission information indicating the fifth information of an object permitted to be lent out by the lender among the fifth information registered in the second management information from a lender terminal used by the lender,

the output controller, when the permission information is received, outputting the first information of the vehicle cabin of the mobile object owned by the lender operating the lender terminal, which is a transmission source of the permission information.

(C-5)

The information processing apparatus according to any one of C-1 to C-4, in which the output controller outputs the first information to a user terminal used by a user.

(C-6)

The information processing apparatus according to any one of C-1 to C-5, in which the mobile objects are passenger cars.

(C-7)

A method of information processing executed in a system lending out vehicle cabins of mobile objects, the method including:

a step of detecting the completion of standing of the mobile object driven by a lender, who is an owner of the mobile object;

a step of registering first information indicating information on the vehicle cabin of the mobile object and second information indicating that the vehicle cabin is lendable in first management information in association with each other when the completion of standing of the mobile object is detected; and

a step of outputting the first information corresponding to the second information registered in the first management information.

(C-8)

An information processing system lending out vehicle cabins of mobile objects, the information processing system including an information processing apparatus, a user terminal communicating with the information processing apparatus, and a lender terminal communicating with the information processing apparatus,

the information processing apparatus including:

a detector detecting the completion of standing of the mobile object driven by a lender, who is an owner of the mobile object;

a first registration unit registering first information indicating information on the vehicle cabin of the mobile object and second information indicating that the vehicle cabin is lendable in first management information in association with each other when the completion of standing of the mobile object is detected; and

an output controller outputting the first information corresponding to the second information registered in the first management information.

(D-1)

An information processing apparatus in a system lending out vehicle cabins of mobile objects, the information processing apparatus including:

a setting unit setting a first energy amount, which is an energy amount, after the mobile object lent out to a user is returned to a lender, who is an owner of the mobile object, scheduled to be used by the lender; and

an execution unit executing use restriction processing restricting the use of the mobile object based on a second energy amount, which is an energy amount used by the mobile object during a lending period of the vehicle cabin, and the first energy amount.

(D-2)

The information processing apparatus according to D-1, in which the use restriction processing is at least one of output processing to output error information indicating that a second remaining energy amount, which is a remaining energy amount that a user of the vehicle cabin can use during a use period, has become less than a threshold, additional charging processing to the user, reduction processing for supply energy per unit time, and display processing for an input screen for receiving input of negotiation details with the lender.

(D-3)

The information processing apparatus according to D-1 or D-2, in which the setting unit sets the first energy amount input by the lender.

(D-4)

The information processing apparatus according to D-1 or D-2, in which the setting unit sets the first energy amount based on at least either information on a scheduled travel route of the mobile object by the lender or use tendency information of the mobile object.

(D-5)

The information processing apparatus according to D-2, further including an output controller outputting at least either the second remaining energy amount or a remaining time that the user can use to an output unit.

(D-6)

The information processing apparatus according to any one of D-1 to D-5, in which the mobile objects are passenger cars.

(D-7)

A method of information processing executed in a system lending out vehicle cabins of mobile objects, the method including:

a step of setting a first energy amount, which is an energy amount, after the mobile object lent out to a user is returned to a lender, who is an owner of the mobile object, scheduled to be used by the lender; and

a step of executing use restriction processing restricting the use of the mobile object based on a second energy amount, which is an energy amount used by the mobile object during a lending period of the vehicle cabin, and the first energy amount.

(D-8)

An information processing system lending out vehicle cabins of mobile objects, the information processing system including an information processing apparatus, a user terminal communicating with the information processing apparatus, and a lender terminal communicating with the information processing apparatus,

the information processing apparatus including:

a setting unit setting a first energy amount, which is an energy amount, after the mobile object lent out to a user is returned to a lender, who is an owner of the mobile object, scheduled to be used by the lender; and

an execution unit executing use restriction processing restricting the use of the mobile object based on a second energy amount, which is an energy amount used by the mobile object during a lending period of the vehicle cabin, and the first energy amount.

What is claimed is:

1. An information processing apparatus in a system lending out vehicle cabins of mobile objects, the information processing apparatus comprising:
a hardware processor connected to a memory and configured to function as:
a first output controller serving to output first information indicating information on the vehicle cabins of the mobile objects in which at least a partial period of a standing period of the mobile objects is capable of being set as a lending period;
a reception unit serving to receive an instruction by a user; and
a second output controller serving to output, on the basis of the instruction by the user, second information indicating that the vehicle cabin to be lent out to the user out of the vehicle cabins included in the first information is lendable.

2. The information processing apparatus according to claim 1, wherein
the first output controller serves to output the first information to a user terminal used by the user, and
the second output controller serves to output the second information to the user terminal.

3. The information processing apparatus according to claim 1, wherein the first output controller serves to output the first information of the vehicle cabins of the mobile objects at least a partial period of a standing period of which is capable of being set as the lending period, the vehicle cabins of the mobile objects the traveling of which during the lending period being capable of being set to be permissible.

4. The information processing apparatus according to claim 1, wherein the hardware processor is configured to further function as a registration unit serving to register user information of the user having used the vehicle cabins, lender information of a lender having lent out the vehicle cabins, and evaluation information of at least either the user or the lender in association with each other.

5. The information processing apparatus according to claim 1, wherein the second information includes parking lot information, which is area information for one of the mobile objects having the vehicle cabin having been selected.

6. The information processing apparatus according to claim 1, wherein the mobile objects are passenger cars.

7. The information processing apparatus according to claim 1, wherein the second information is information including third information indicating lending with the mobile objects standing and a use fee for a state indicated by the third information.

8. The information processing apparatus according to claim 7, wherein the use fee is capable of differing between a case of lending with the mobile objects standing and a case of lending with the mobile objects permitted to travel.

9. The information processing apparatus according to claim 1, wherein the hardware processor is configured to further function as:
a generation unit serving to generate key information to make equipment of the vehicle cabins corresponding to fourth information indicating one or more use conditions indicating permission of use set by a lender of the vehicle cabins an unlocked state; and
a transmitter serving to transmit the key information to a user terminal of a user for whom the use of the vehicle cabins is permitted.

10. The information processing apparatus according to claim 9, wherein the fourth information includes use purpose information of the vehicle cabins.

11. The information processing apparatus according to claim 10, wherein the use purpose information is at least either use purpose information of the vehicle cabins of the mobile objects in a moving state or use purpose information of the vehicle cabins of the mobile objects in a stopping state.

12. The information processing apparatus according to claim 9, wherein the hardware processor is configured to further function as an identification unit serving to identify the fourth information desired by the user for whom the use of the vehicle cabins is permitted among one or more pieces of the fourth information permitted to be used set in advance by the lender,
wherein the generation unit serves to generate the key information to make the equipment of the vehicle cabins corresponding to the identified fourth information the unlocked state.

13. The information processing apparatus according to claim 9, wherein the hardware processor is configured to further function as an identification unit serving to identify the fourth information permitted to be used by the lender of the vehicle cabins among the fourth information desired to be used by the user for whom the use of the vehicle cabins is permitted,
wherein the generation unit serves to generate the key information to make the equipment of the vehicle cabins corresponding to the identified fourth information the unlocked state.

14. The information processing apparatus according to claim 13, wherein the hardware processor is configured to further function as a transmitter serving to, when the key information is generated, transmit fifth information indicating that a right of the key information has been transferred to the user to a lender terminal of the lender.

15. The information processing apparatus according to claim 9, wherein the hardware processor is configured to further function as an update unit serving to update use history information of the equipment in a use period of the vehicle cabins by the user.

16. A method of information processing executed in a system lending out vehicle cabins of mobile objects, the method comprising:
outputting first information indicating information on the vehicle cabins of the mobile objects in which at least a partial period of a standing period of the mobile objects is capable of being set as a lending period;
receiving an instruction by a user; and
outputting, on the basis of the received instruction by the user, second information indicating that the vehicle cabin to be lent out to the user among the vehicle cabins included in the first information is lendable.

17. The method of information processing according to claim 16, further comprising:
generating key information to make equipment of the vehicle cabins corresponding to third information indicating one or more use conditions indicating permission of use set by a lender of the vehicle cabins an unlocked state; and
transmitting the key information to a user terminal of a user for whom the use of the vehicle cabins is permitted.

18. An information processing system lending out vehicle cabins of mobile objects, the information processing system comprising:
an information processing apparatus;
a user terminal configured to communicate with the information processing apparatus; and
a lender terminal configured to communicate with the information processing apparatus,
wherein the information processing apparatus comprises a hardware processor connected to a memory and configured to function as:
a first output controller serving to output first information indicating information on the vehicle cabins of the mobile objects in which at least a partial period of a standing period of the mobile objects is capable of being set as a lending period;
a reception unit serving to receive an instruction by a user; and
a second output controller serving to output, on the basis of the instruction by the user, second information indicating that the vehicle cabin to be lent out to the user out of the vehicle cabins included in the first information is lendable.

19. The information processing system according to claim 18, wherein the hardware processor of the information processing apparatus is configured to further function as:
a generation unit serving to generate key information to make equipment of the vehicle cabins corresponding to fourth information indicating one or more use conditions indicating permission of use set by a lender of the vehicle cabins an unlocked state; and
a transmitter serving to transmit the key information to a user terminal of a user for whom the use of the vehicle cabins is permitted.
